(19) United States
(12) Patent Application Publication
(10) Pub. No.: US 2008/0170840 A1
(43) Pub. Date: Jul. 17, 2008

(54) INFORMATION STORAGE MEDIUM, INFORMATION PLAYBACK APPARATUS, AND INFORMATION PLAYBACK METHOD

(76) Inventors: Yuki Kaneko, Yokohama-shi (JP); Yasufumi Tsumagari, Kawasaki-shi (JP); Hideki Mimura, Yokohama-shi (JP); Yoichiro Yamagata, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/968,456

(22) Filed: Jan. 2, 2008

(30) Foreign Application Priority Data
Jan. 12, 2007 (JP) 2007-004907

(51) Int. Cl. H04N 7/26

(52) U.S. Cl. 386/124

(57) ABSTRACT

According to one embodiment, an information storage medium includes a first area which stores playback control information used to control playback of contents, and a second area which stores a region flag indicating whether to enable or disable playback control based on a region code held in a player.

### CROSS-REFERENCE TO RELATED APPLICATIONS

This application is based upon and claims the benefit of priority from Japanese Patent Application No. 2007-004907, filed Jan. 12, 2007, the entire contents of which are incorporated herein by reference.

### BACKGROUND

1. Field

One embodiment of the invention relates to an information storage medium such as an optical disc or the like, an information playback apparatus for playing back such information storage medium, and an information playback method for playing back such information storage medium.

2. Description of the Related Art

As disclosed in JP-A 11-110914 (KOKAI), the DVD (Digital Versatile Disc) standard specifies region codes to limit reproducible regions. The DVD standard adopts a scheme in which a content and a player hold unique region codes, and the content cannot be played back unless the two codes match. For example, it can be implemented that a DVD (region code: C1) purchased in U.S.A. cannot be played back by a player (region code: C2) purchased in Japan. The player has only one region code, but the content can have two or more region codes. If one of the plurality of region codes held in the content matches one region code held in the player, the content can be played back. That is, when the content has all region codes (defined in eight patterns in the DVD standard), it can be played back irrespective of the region codes.

The playback control based on the region codes so far is merely simple control to decide whether or not to play back.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a view showing an overview of an HD DVD according to an embodiment of the invention;

FIG. 2 is a flowchart showing determination processing of a standard content or advanced content according to the embodiment;

FIG. 3 is a view showing an example of the data configuration of an HD DVD advanced content according to the embodiment;

FIG. 4 is a view showing an example of the directory and file configurations of an HD DVD advanced contents according to the embodiment;

FIG. 5 is a flowchart showing an example of the advanced content playback startup processing according to the embodiment;

FIG. 6 is a schematic block diagram showing the arrangement of an HD DVD advanced content player according to the embodiment;

FIG. 7 is a view showing an example of the data structure of DISCID.DAT according to the embodiment;

FIG. 8 is a view showing an example of a playlist according to the embodiment;

FIG. 9 is a view showing an example of a playlist according to the embodiment;

FIGS. 10A and 10B are views showing an example of a playlist according to the embodiment;

FIGS. 11A and 11B are views showing an example of a playlist according to the embodiment;

FIGS. 12A to 12C are views showing an example of a playlist according to the embodiment;

FIGS. 13A and 13B are views showing an example of a playlist according to the embodiment;

FIGS. 14A to 14C are views showing an example of a playlist according to the embodiment;

FIGS. 15A and 15B are views showing an example of a playlist according to the embodiment;

FIG. 16 is a view showing an example of a manifest according to the embodiment;

FIGS. 17A and 17B are views showing an example of a markup according to the embodiment;

FIG. 18 is a view showing an example of a script according to the embodiment;

FIG. 19 is a view showing an example of a script according to the embodiment;

FIG. 20 is a view showing an overview of region control according to the embodiment;

FIG. 21 is a view showing an example of the operations of an HD DVD player for a nonstandard content according to the embodiment;

FIG. 22 is a view for explaining holding of a region code by an HD DVD advanced content player according to the embodiment;

FIG. 23 is a view showing an example of introduction of a region flag in the DISCID.DAT according to the embodiment;

FIG. 24 is a view for explaining an example of introduction of information used to branch an initial playlist based on a region code according to the embodiment;

FIG. 25 is a branch flowchart of an initial playlist based on a region code according to the embodiment;

FIG. 26 is a branch flowchart of an initial playlist based on a region code according to the embodiment;

FIG. 27 is a branch flowchart of an initial playlist based on a region code according to the embodiment;

FIG. 28 is a view showing an example of introduction of region block information in the data structure of an XML file according to the embodiment;

FIG. 29 is a loading flowchart of XML data including region block information according to the embodiment;

FIG. 30 is a view showing an example of introduction of region block information and an example of loading processing according to the embodiment;

FIG. 31 is a view showing an example of introduction of a region property in an API of a script according to the embodiment;

FIG. 32 is a view showing an example of playback control using a region property according to the embodiment;

FIG. 33 is a view showing an example of playback control using a region property according to the embodiment;

FIG. 34 is a view showing an example of introduction of an element (region control element) which becomes loadable or unloadable according to the region code of a player to an XML file (playlist, manifest, markup) according to the embodiment;

FIG. 35 is a loading flowchart of a region control element according to the embodiment;

FIG. 36 is a view showing an example of introduction of a region application segment element to a playlist according to the embodiment;

FIG. 37 is a view showing an example of introduction of a region application segment element to a playlist according to the embodiment;

FIG. 38 is a view showing an example of introduction of a region playlist application element to a playlist according to the embodiment;

FIG. 39 is a view showing an example of introduction of a region playlist application element to a playlist according to the embodiment;

FIG. 40 is a view showing an example of introduction of a region playlist application element to a playlist according to the embodiment;

FIG. 41 is a view showing an example of introduction of a region playlist application element to a playlist according to the embodiment;

FIG. 42 is a view showing an example of a region button element (<Regionbutton>) according to the embodiment;

FIG. 43 is a view showing an example of a region cue element (<Regioncue>) according to the embodiment;

FIG. 44 is a view showing an example of playback control using the region button element and region cue element according to the embodiment;

FIG. 45 is a view showing an example of introduction of a region code attribute to elements of an XML file (playlist, manifest, markup) according to the embodiment;

FIG. 46 is a loading flowchart of elements set with the region code element according to the embodiment;

FIG. 47 is a view showing an example of introduction of a region code attribute to a secondary audio video clip element of a playlist according to the embodiment;

FIG. 48 is a view showing an example of introduction of a region code attribute to a markup element of a manifest according to the embodiment;

FIG. 49 is a view showing an example of introduction of a region code attribute to an object element of a markup according to the embodiment;

FIG. 50 is a view showing an example of an initial playlist branch function based on a region file according to the embodiment;

FIG. 51 is a view showing an example of playback control based on a region property of an API according to the embodiment;

FIG. 52 is a view showing an example of introduction of a <RegionApplicationSegment> element to a playlist according to the embodiment;

FIG. 53 is a view showing an example of introduction of a <RegionApplicationSegment> element to a playlist according to the embodiment;

FIG. 54 is a view showing an example of introduction of <RegionScript> to a manifest according to the embodiment;

FIG. 55 is a view showing an example of introduction of <Regionbutton> and <Regioncue> to a markup according to the embodiment;

FIG. 56 is a view showing an example of introduction of a regionCode attribute to <SecondaryAudioVideoClip> of a playlist according to the embodiment;

FIG. 57 is a view showing an example of introduction of a regionCode attribute to a <Markup> element of a manifest according to the embodiment; and

FIG. 58 is a view showing an example of setting a regionCode=“1 2 3” in an <object> element of a markup.

### DETAILED DESCRIPTION

Various embodiments according to the invention will be described hereinafter with reference to the accompanying drawings. In general, according to one embodiment of the invention, an information storage medium comprises a first area which stores playback control information used to control playback of contents, and a second area which stores a region flag indicating whether to enable or disable playback control based on a region code held in a player.

Embodiments according to the invention will be described hereinafter with reference to the accompanying drawings.

The points of this embodiment will be sorted out first.

By expanding and introducing a region code which is used to limit a reproducible region in a DVD into an HD DVD, playback control suited to each region (or along with the intentions of the contents producer, copyright holder, government, and the like) can be implemented.

(Point 1)

A flag which indicates whether to enable or disable playback control (region control) based on a region code is introduced into a reserve area of a setting file called DISCID.DAT in an information storage medium.

(Point 2)

A file (region file) used to branch a playlist (one of playback control files) loaded first according to a region code held in a player as an information playback apparatus is introduced.

(Point 3)

A property indicating a region code of a player is introduced into an API (a set of properties and functions which can be used in programming) for an HD DVD of a script (one of playback control files) included in playback control information.

In this way, a region control support player can execute playback control using that property, and a region control non-support player does not suffer any problem since a value “undefined” is merely set.

(Point 4)

An element which can be loaded by only a player having a specific region code is introduced into an XML (Extensible Markup Language) file (playlist, manifest, markup) included in the playback control information.

In this way, a region control support player can load that element, and a region control non-support player ignores that element.

(Point 5)

A region code attribute is introduced into respective elements of a playlist, manifest, and markup, and a player having a specific region code cannot load those elements.

The playback control information will be briefly complemented below. The playback control information includes a playlist, manifest, markup, script, and the like. The playlist is playback control information which controls whole playback, and can control to paste an application from a given time to another time, and so forth. The manifest is a list table of data used in that application. The markup is used to allocate elements on a window in the forms of buttons and the like. The script is playback control information which has various APIs such as a fastforward function, title jump function, and the like, and is used to execute processes using these APIs. For example, the script can pause playback at the 30th second using a timer.

With the above information, playback based on a region code on the information storage medium side (contents side) can be freely controlled. The DVD standard permits to play back a content only when a region code of a player matches that of the content, and inhibits playback when the two region codes do not match. By contrast, this embodiment allows advanced playback control according to a region code of a player. This advanced playback control not only permits or inhibits playback of a content in correspondence with a match or mismatch between region codes, but also displays a button background image X upon playback using a player with a region code n and a button background image Y upon playback using a player with a region code m.

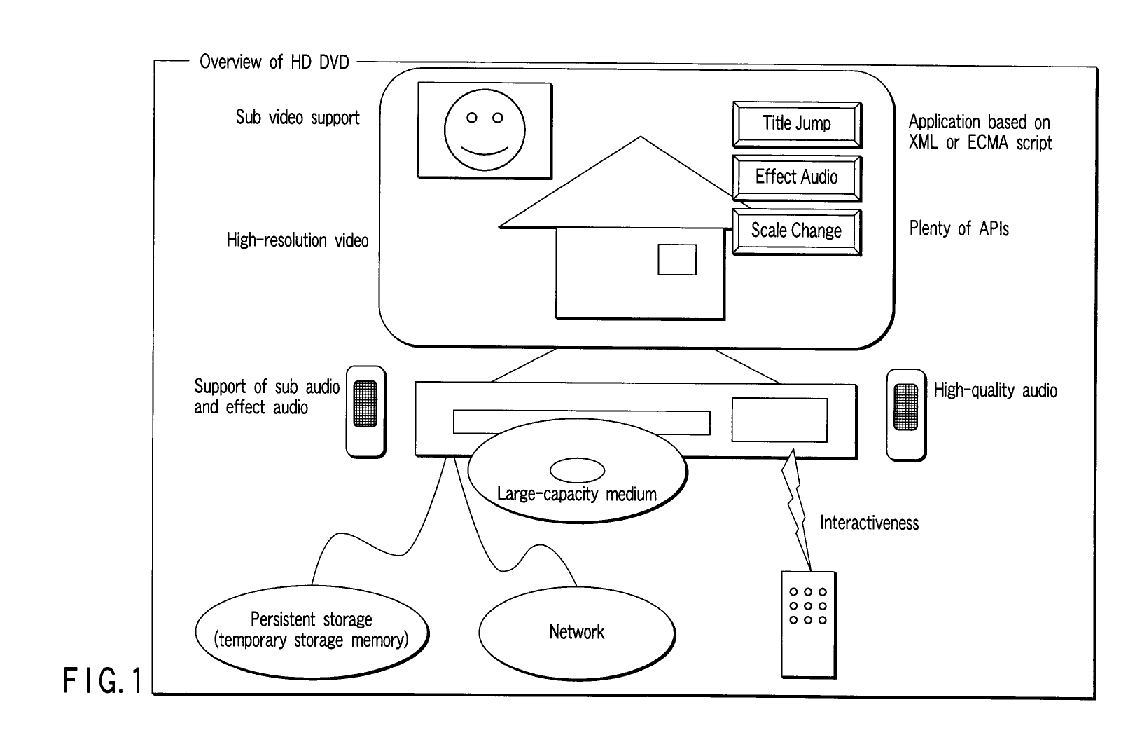

FIG. 1 shows an overview of an HD DVD.

The HD DVD is the next generation standard of a DVD, and is characterized by high-quality video and audio supports, improved interactiveness, network supports, and the like. Since a plenty of video and audio codecs (compression schemes) are supported, and fulfilling APIs (sets of properties and functions specified by the standard) are available, the contents producer can realize more attractive diversified contents. Due to these advances, transition from the existing DVD to the HD DVD is rapidly made.

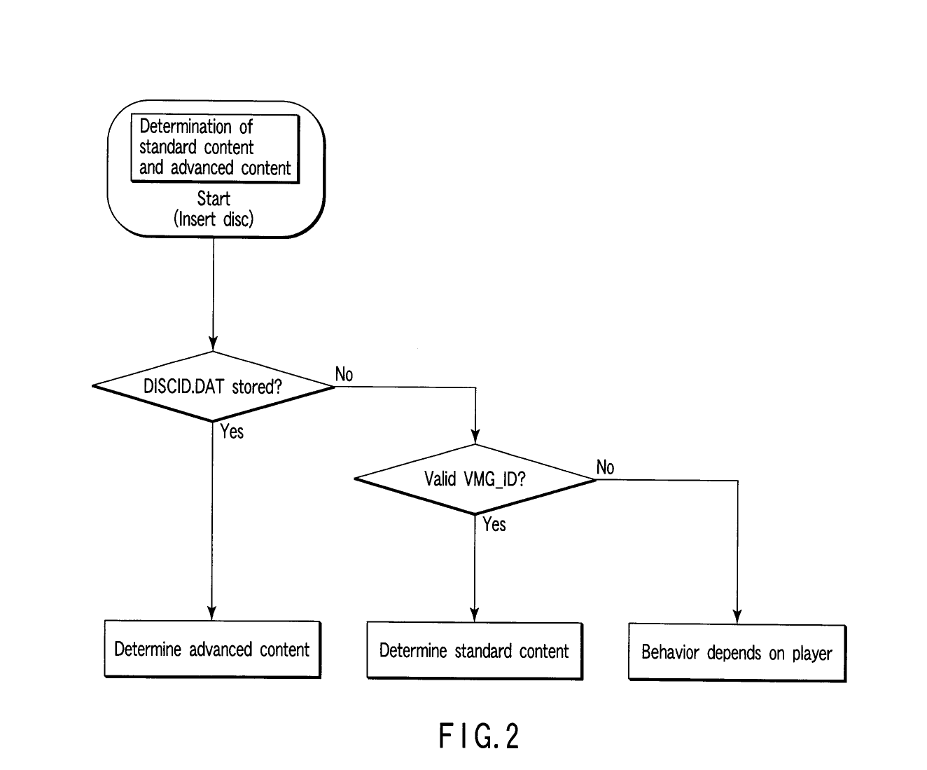

FIG. 2 is a view showing an example of determination of a standard content and advanced content.

The HD DVD standard specifies two different types of contents called a standard content and advanced content. The standard content is ranked as an expanded version of the existing DVD standard, has a data configuration close to the existing DVD, and readily gains the acceptance of a conventional DVD production studio and the like. The standard content has characteristic features of high-quality video and audio supports, expanded navigation commands (command group used in title jump, menus, and the like) that can be used, and the like. On the other hand, the advanced content is quite different from that of the existing DVD. The advanced content has a scheme for expressing playback control information using a programming language such as an XML (Extensible Markup Language) or ECMA (European Computer Manufacturer Association) script like home pages on the Internet in addition to the high-image quality video and audio supports of the standard content. Conventionally, all data required to play back a content need be loaded from a disc. However, the HD DVD advanced content can load data from a persistent storage (temporarily storage memory), and can download data from a network and can use them in playback in addition to a disc.

As described above, the HD DVD standard specifies the two different types of contents, which have different data structures and the like. This embodiment will explain the advanced content of these two different types of contents.

Since the HD DVD standard specifies two different types of contents, i.e., a standard content and advanced content, an HD DVD player executes, as start processing, a sequence for determining whether the content to be played back is a standard or advanced content, upon playback of the content. When the user inserts a disc, the player confirms if the content includes a file DISCID.DAT which describes an ID of an advanced content and the like. If the content includes this file, the player identifies that the content to be played back is an advanced content. If the content does not include any DISCID.DAT, the player confirms if ID information VMG_ID of a standard content is valid. If the ID information is valid, the player determines a standard content; otherwise, it determines an unknown content (neither an advanced content nor a standard content of the HD DVD). Since the invention targets at an advanced content of the HD DVD, the following description will be made under an assumption that the inserted disc is an advanced content.

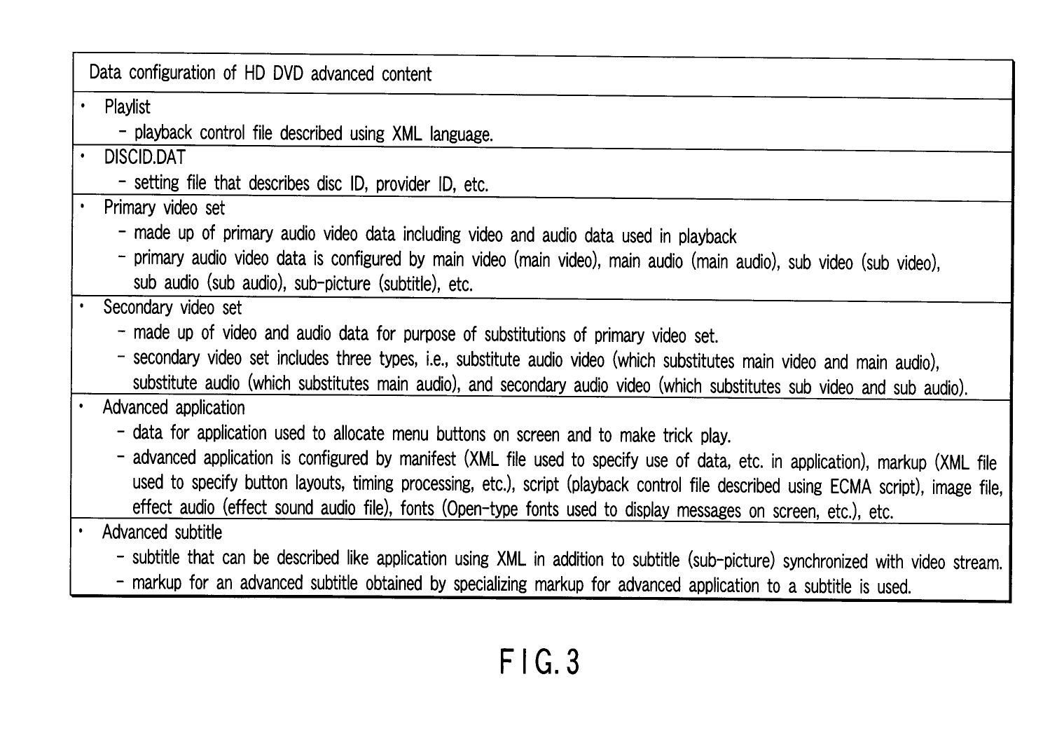

FIG. 3 is a view showing an example of the data configuration of an HD DVD advanced content.

Playlist: a playback control file described using an XML language.

DISCID.DAT: a setting file that describes a disc ID, provider ID, and the like.

Primary video set: made up of primary audio video data including video and audio data used in playback. The primary audio video data is configured by a main video (main video), main audio (main audio), sub video (sub video), sub audio (sub audio), sub-picture (subtitle), and the like.

Secondary video set: made up of video and audio data for the purpose of substitutions of a primary video set. The secondary video set includes three types, i.e., a substitute audio video (which substitutes a main video and main audio), a substitute audio (which substitutes a main audio), and a secondary audio video (which substitutes a sub video and sub audio).

Advanced application: data for an application used to allocate menu buttons on a screen and to make a trick play. The advanced application is configured by a manifest (an XML file used to specify use of data and the like in the application), a markup (an XML file used to specify button layouts, timing processing, and the like), a script (a playback control file described using an ECMA script), an image file, an effect audio (an effect sound audio file), fonts (Open-type fonts used to display messages on a screen and the like), and the like.

Advanced subtitle: a subtitle that can be described like an application using an XML in addition to a subtitle (sub-picture) synchronized with a video stream. A markup for an advanced subtitle obtained by specializing the markup for the advanced application to a subtitle is used.

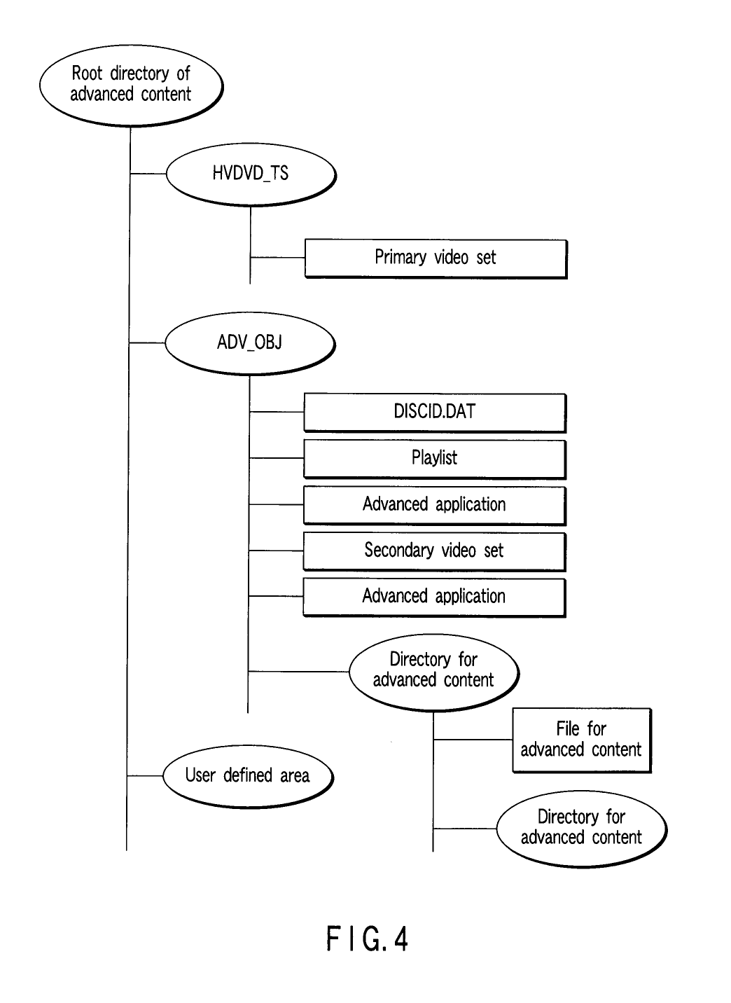

FIG. 4 is a view showing an example of the directory and file configurations of the HD DVD advanced content.

The root directory of the advanced content is classified into three areas. The first area is an HVDVD_TS directory area which stores a primary video set. The second area is an ADV_OBJ directory area which stores data such as a playlist, DISCID.DAT, advanced application, advanced subtitle, secondary video set, and the like. The third area is a user defined area for other data. As in the example of FIG. 4, under the ADV_OBJ directory, another directory for the advanced content can also be defined. The DISCID.DAT must be stored immediately under the ADV_OBJ directory. In case of a content which need load a playlist from a disc (to be described in detail later), at least one playlist file must be stored immediately under the ADV_OBJ directory.

Note that a region file to be described later is included in the HD DVD advanced content, and is stored under, e.g., the ADV_OBJ directory. Alternatively, the region file may be stored under the HVDVD_TS directory or the ADV_OBJ directory. Alternatively, the region file may be stored in the user defined area.

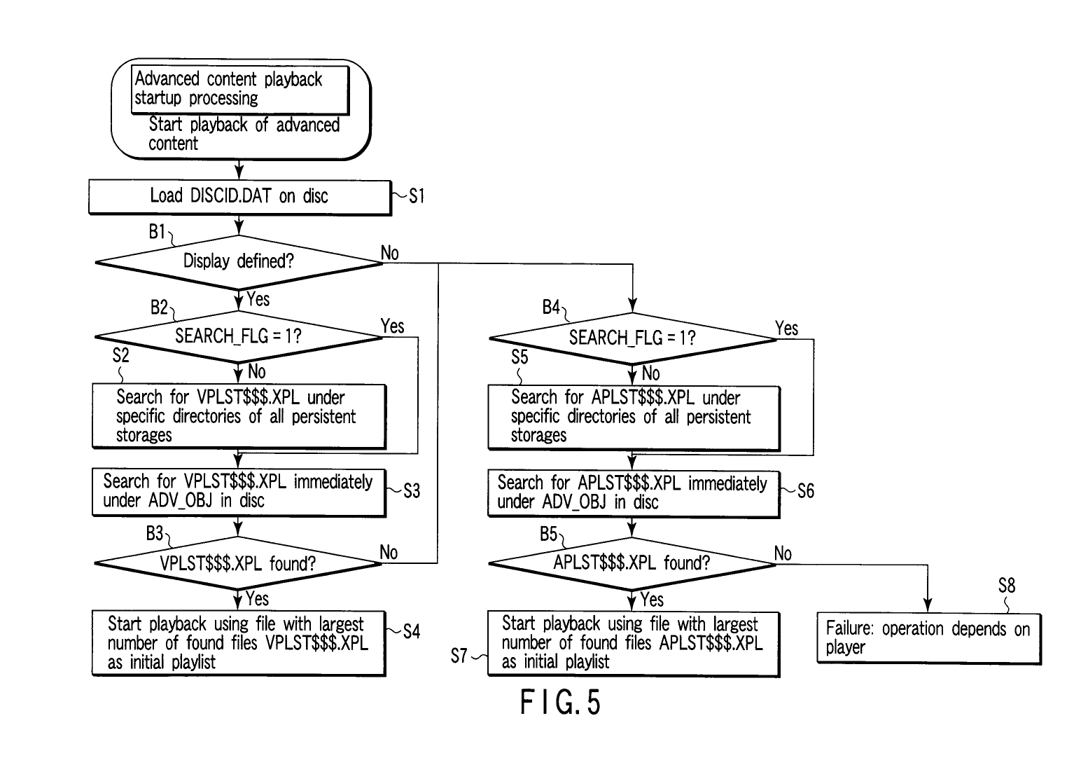

FIG. 5 shows an example of the advanced content playback startup processing. That is, FIG. 5 shows an example of the startup processing after the player determines that the content is an advanced content.

S1: The player loads a DISCID.DAT file. After loading, the process advances to B1.

B1: To branch the processes, the player checks whether or not a display is defined. If the display is defined, the process advances to branch process in B2; otherwise, the process advances to branch process in B4.

B2: To branch the processes, the player checks whether or not SEARCH.FLG (a flag indicating if persistent storages are searched for an initial playlist; details of the data structure of the DISCID.DAT will be described later) is specified in the DISCID.DAT file is 1. If SEARCH.FLG=1, the process jumps to processing in S3; if SEARCH.FLG=0, the process advances to processing in S2.

S2: The player searches for playlist files (VPLST$$$.XPL) stored under specific directories of all persistent storages. After the processing, the process advances to S3.

S3: The player searches for playlist files (VPLST$$$.XPL) stored immediately under the ADV_OBJ directory in the disc. After the processing, the process advances to B3.

B3: To branch the processes, the player checks if one or more files VPLST$$$.XPL are found. If one or more files are found, the process advances to S4; if no file is found, the process advances to B4.

S4: The player starts playback using a file with a largest number of the found files VPLST$$$.XPL as an initial playlist.

B4: To branch the processes, the player checks whether or not SEARCH.FLG (a flag indicating if persistent storages are searched for an initial playlist; details of the data structure of the DISCID.DAT will be described later) is specified in the DISCID.DAT file is 1. If SEARCH.FLG=1, the process jumps to processing in S6; if SEARCH.FLG=0, the process advances to processing in S5.

S5: The player searches for playlist files (APLST$$$.XPL) stored under specific directories of all persistent storages. After the processing, the process advances to S6.

S6: The player searches for playlist files (APLST$$$.XPL) stored immediately under the ADV_OBJ directory in the disc. After the processing, the process advances to B5.

B5: To branch the processes, the player checks if one or more files APLST$$$.XPL are found. If one or more files are found, the process advances to S7; if no file is found, the process advances to S8.

S7: The player starts playback using a file with a largest number of the found files APLST$$$.XPL as an initial playlist.

S8: The player has failed the startup processing. The subsequent operation depends on the player.

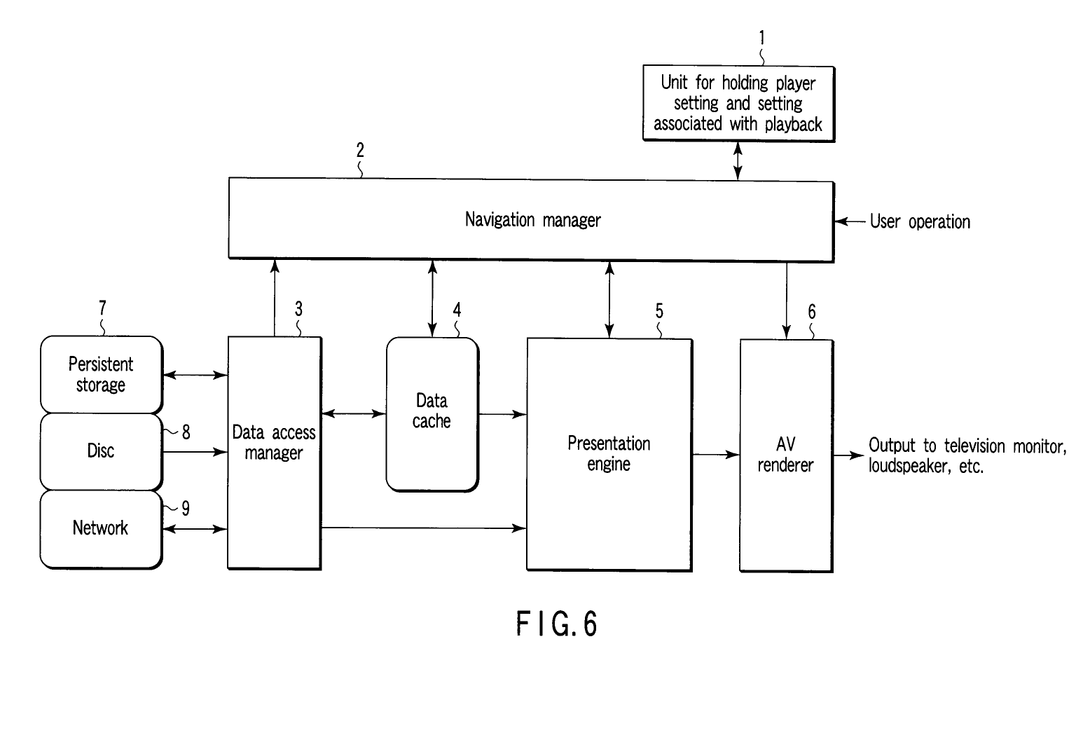

FIG. 6 is a block diagram showing an overview of an HD DVD advanced content player.

As shown in FIG. 6, the player comprises a unit for holding player settings and settings associated with playback (storage unit) 1, navigation manager 2, data access manager 3, data cache 4, presentation engine 5, and AV renderer 6. The navigation manager 2 controls playback based on a region code (details will be described later). The data access manager 3 manages accesses to a persistent storage 7, disc (information storage medium) 8, and network 9.

The advanced content allows to load data from a persistent storage (temporary storage memory) and to download data from a network in addition to data loading from a disc. Data according to the HD DVD format stored in these data sources are distributed to the navigation manager 2, data cache 4, and presentation engine 5 via the unit called the data access manager 3 which controls data accesses. The navigation manager 2 executed playback control. Playback control files described in XML and ECMA scripts and the like (playlist, manifest, markup, script, and the like) are sent from the data access manager 3 to this navigation manager 2 (not directly but after they are temporarily loaded in the data cache 4 in some cases), and their substances are interpreted. Instructions based on the interpreted playback control information are output to the presentation engine 5 and are used in playback control. Upon reception of a user operation such as a button operation of a remote controller or the like, the navigation manager 2 converts that operation into a playback control instruction, and outputs the instruction to the presentation engine 5. The data cache 4 is a memory which temporarily stores data used in playback. The presentation engine 5 determines actual video and audio outputs based on the playback control instructions and data (primary video set, secondary video set, and the like) used in playback, and converts video and audio data into information that can be used in playback. Since data for playback which are originally stored in a disc or the like are obtained by multiplexing video and audio data and the like, they cannot be used in playback intact. Hence, the presentation engine 5 executes processing (called demax processing) for selecting video and audio data and the like required for playback, and demultiplexing the multiplexed data. Since data generated by the above processing are encoded by various codecs (compression schemes), the presentation engine 5 decodes these data. The presentation engine 5 sequentially outputs playback data and the like to the AV renderer 6, which executes video superimposing processing and audio mixing processing, based on the data generated in this way and the playback control instructions from the navigation manager 2. Then, video and audio are output from a television monitor and loudspeakers in accordance with signals from the AV renderer 6.

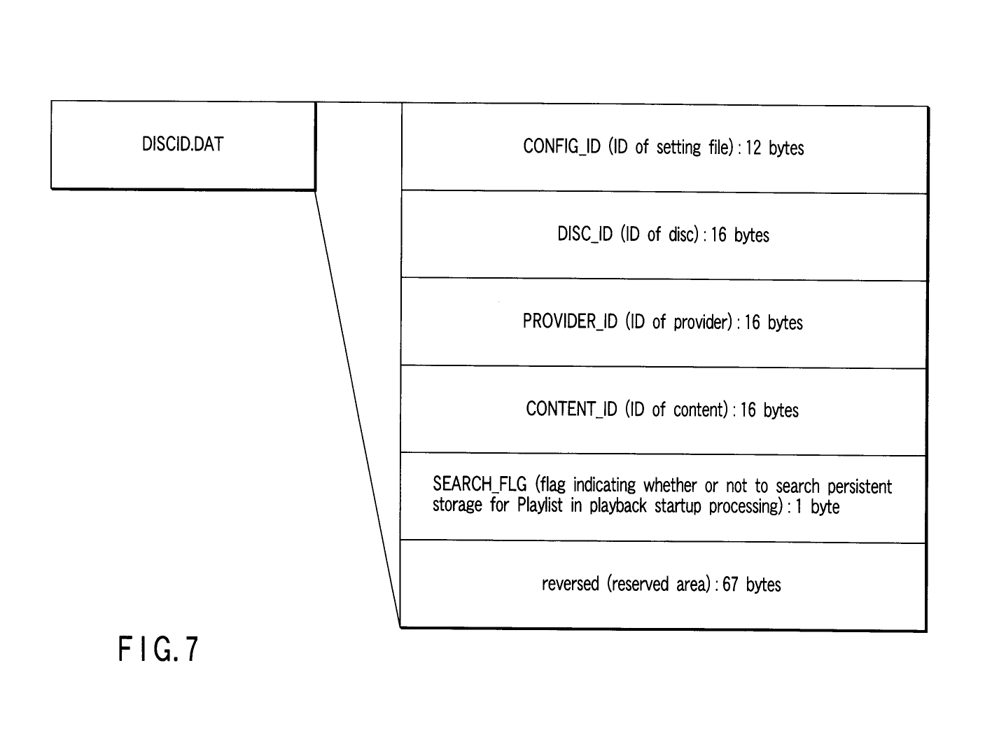

FIG. 7 shows an example of the data structure of the DISCID.DAT.

The DISCID.DAT is a setting file used to set a contents ID, the location of a source from which a playlist is to be loaded, and the like.

CONFIG_ID: an ID of the setting file (12 bytes). This ID describes “HDDVD-V_CONF” using an IS08859-1 character code.

DISC_ID: an ID of the disc described by binary expression (16 bytes). This ID is padded by “1b” if a network is not used.

PROVIDER_ID: an ID of a provider described by binary expression (16 bytes). This ID is padded by “1b” if the provider ID directory in the persistent storage is not used.

CONTENT_ID: an ID of a content described by binary expression (16 bytes). This ID is padded by “1b” if the provider ID directory in the persistent storage is not used.

SEARCH_FLG: a flag indicating whether or not to search the persistent storage upon conducting an initial playlist search in the startup processing (1 byte). This flag describes “0b” if the persistent storage is not searched, and “1b” if it is searched.

reserved: 67 bytes are left as a reserved area.

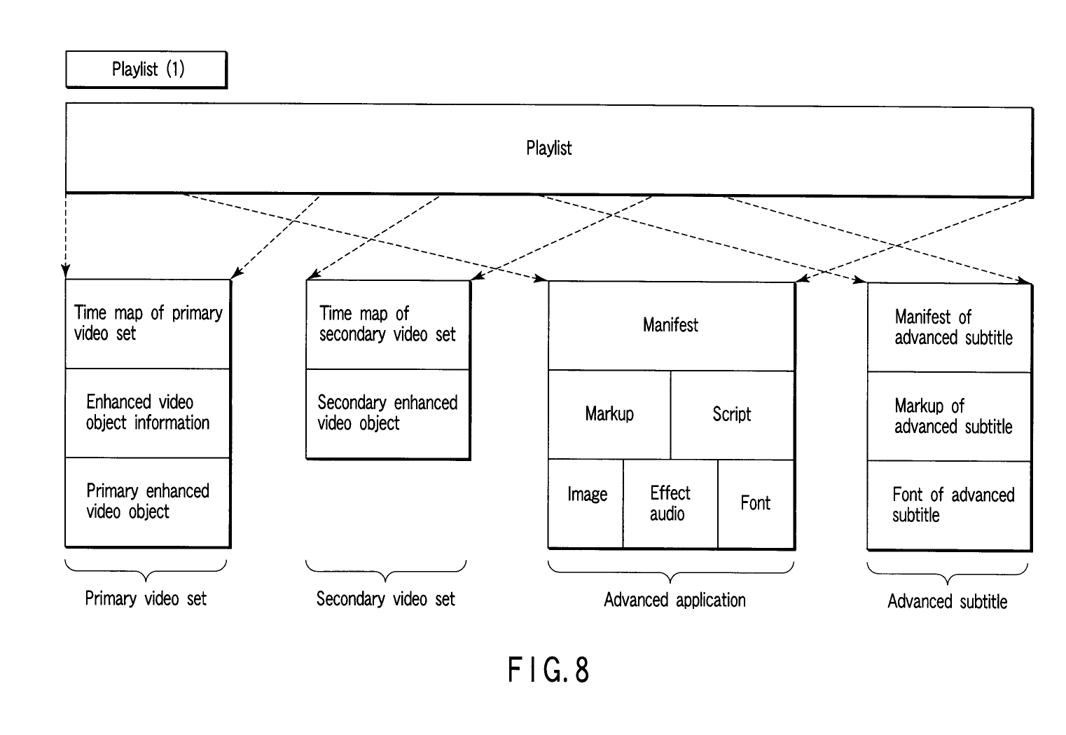

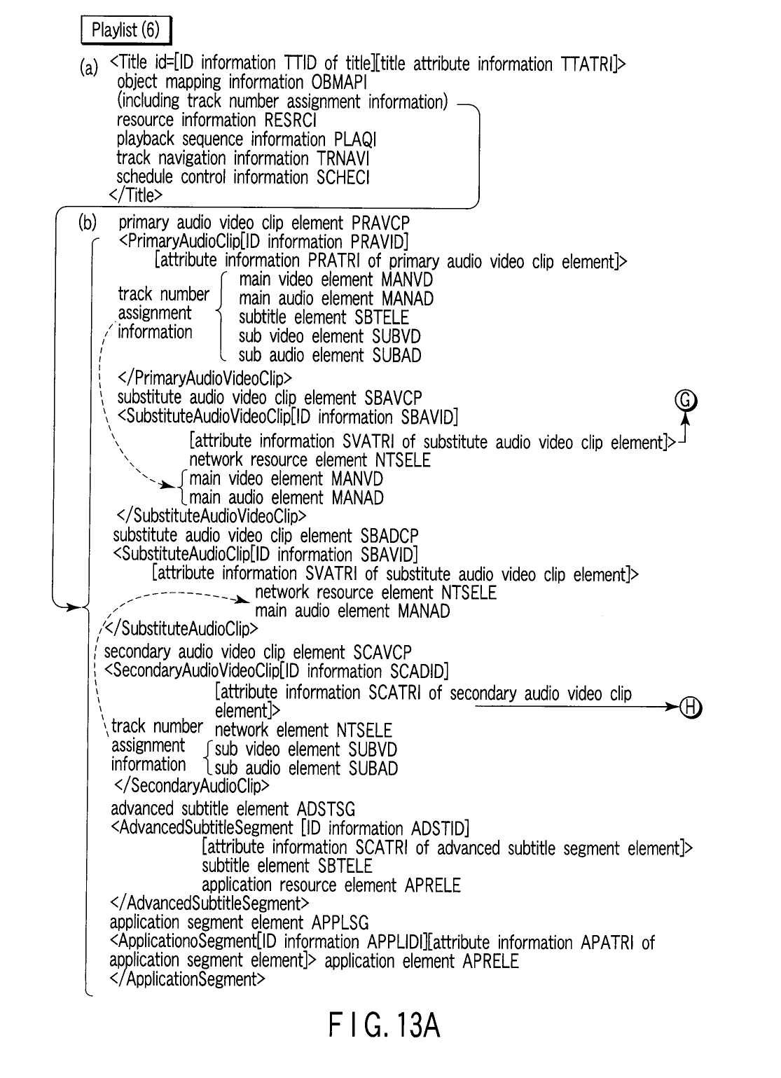

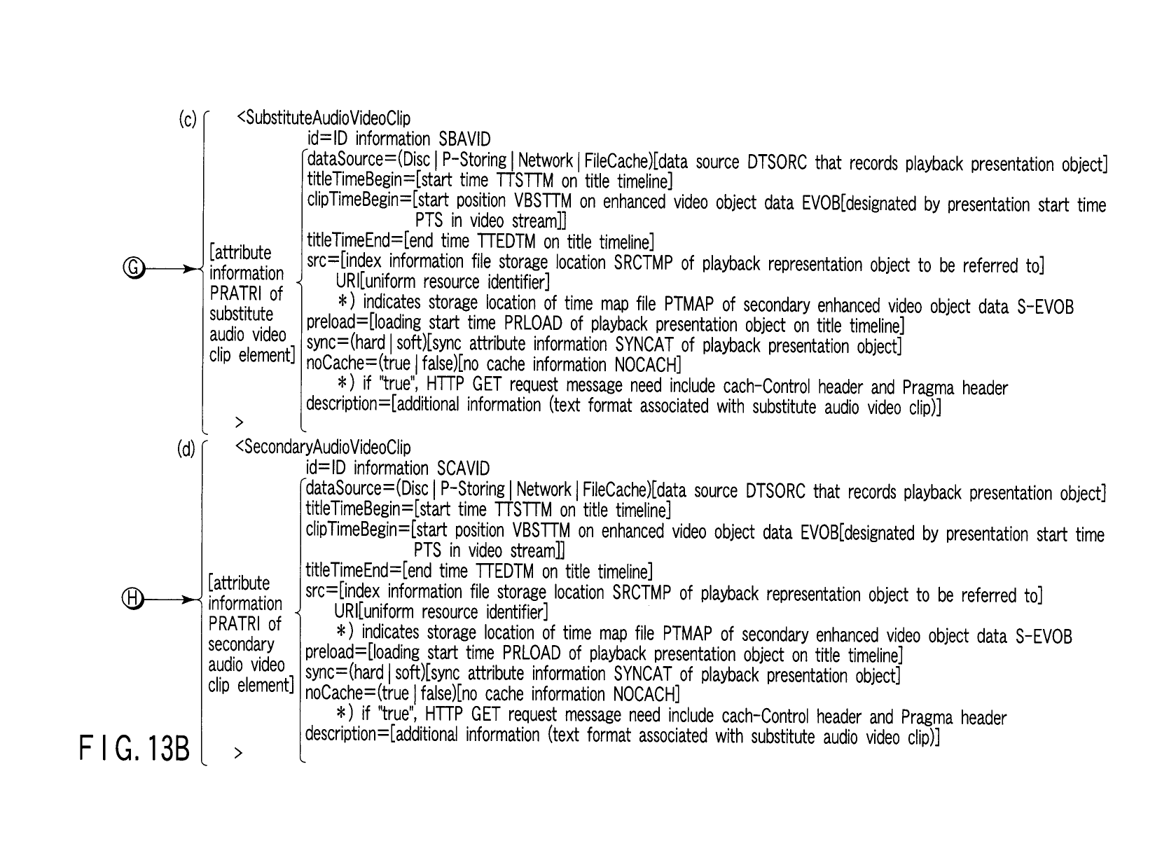

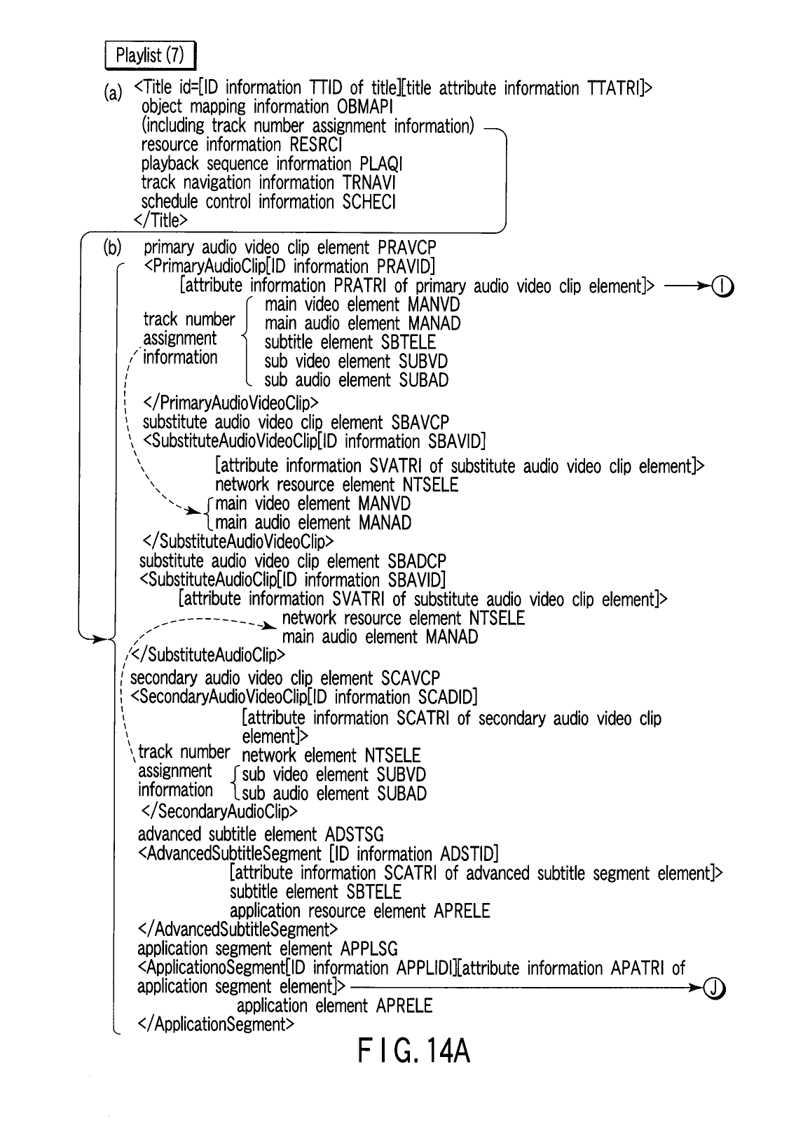

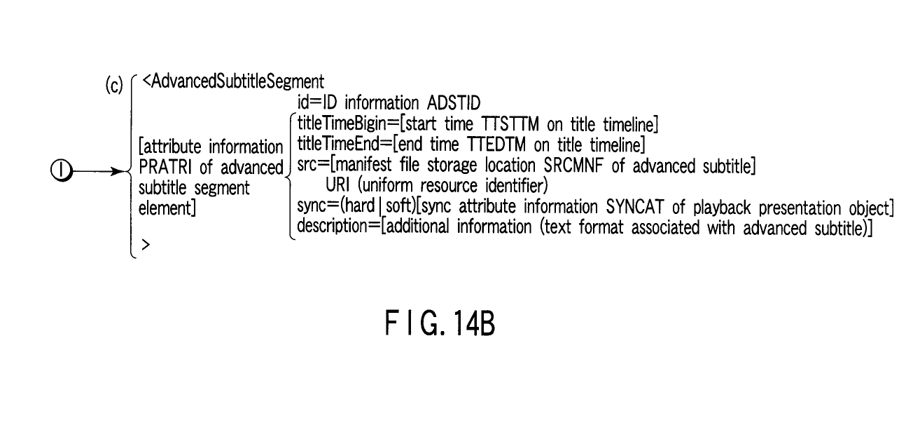

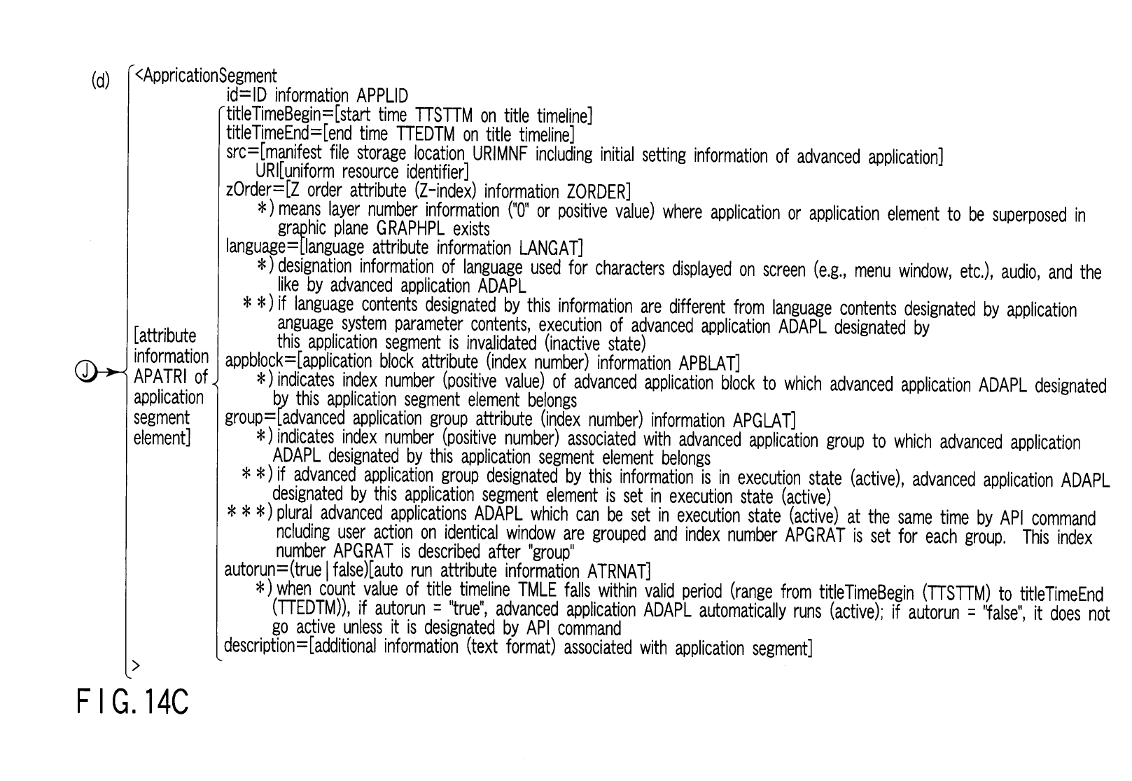

FIGS. 8 to 15B show an example of a playlist.

A playlist is a playback control file used to describe information associated with initial system settings, synchronization information among objects used in playback, and the like. The playlist is described using an XML language, and stores playback control information indicating playback timings of a primary video set, secondary video set, advanced application, advanced subtitle, and the like (FIG. 8).

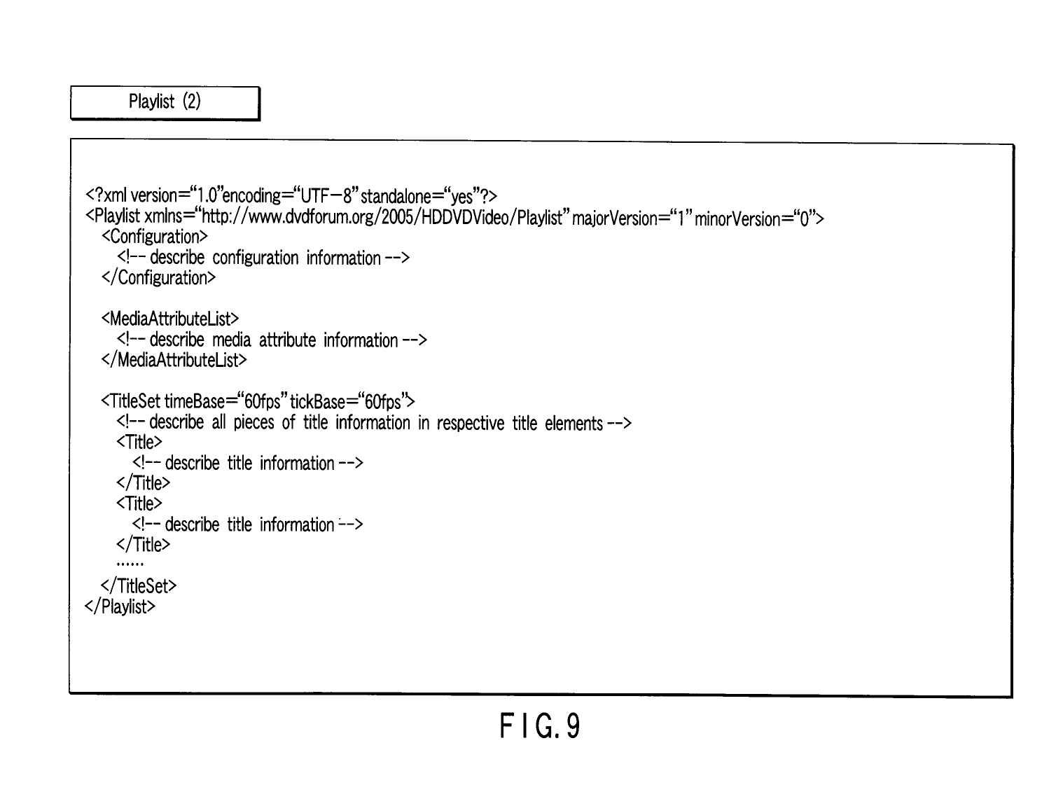

FIG. 9 shows an overview of the playlist. A sentence <?xml . . . ?> in the first line of FIG. 9 is a description called an XML statement. This statement indicates that “this document is described using an XML language”. The XML adopts a scheme for holding respective elements in a tree structure. A root element (an element at the root of the tree) of the playlist is a playlist element. The playlist element is described as a part bounded by <Playlist . . . > and </Playlist>. In this embodiment, as child elements of the playlist element, <Configuration> (configuration information), <MediaAttributeList> (media attribute information), and <TitleSet> (title information) are described. The configuration information describes information associated with system settings, and the media attribute information describes information associated with video and audio codecs (compression schemes) used in playback. The title information describes object mapping information indicating video objects and their output timings, and the like.

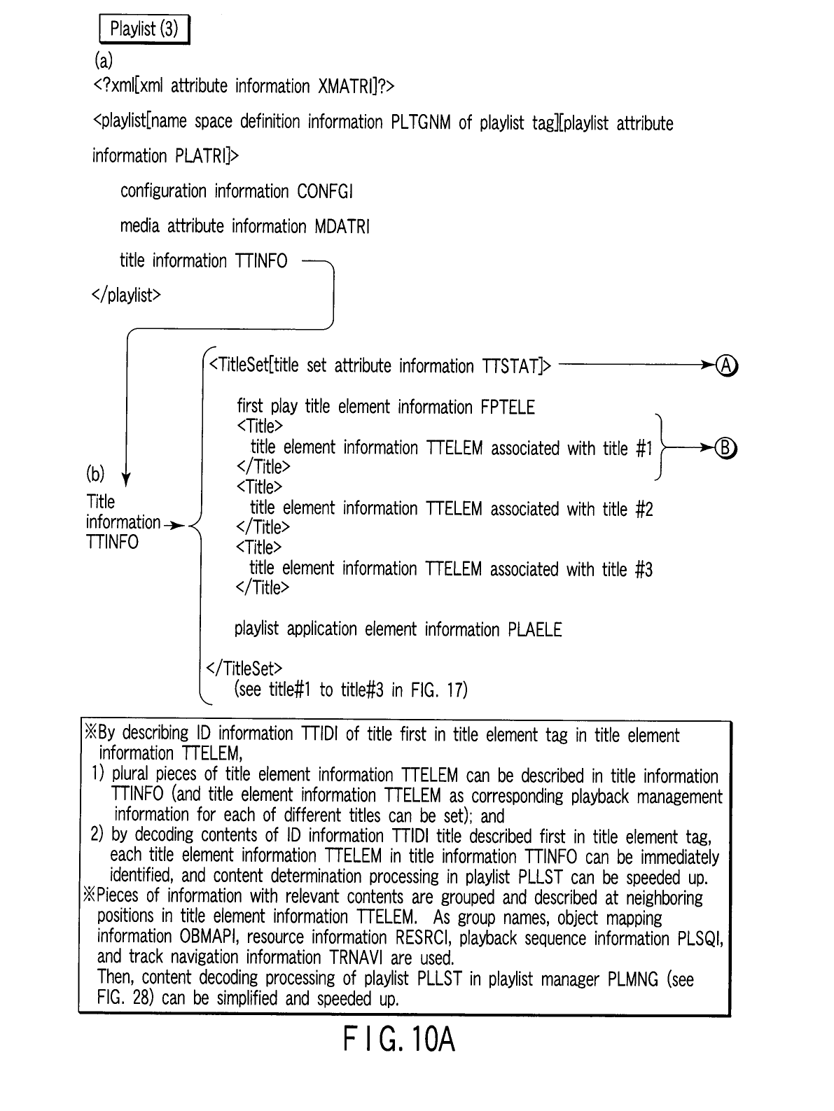

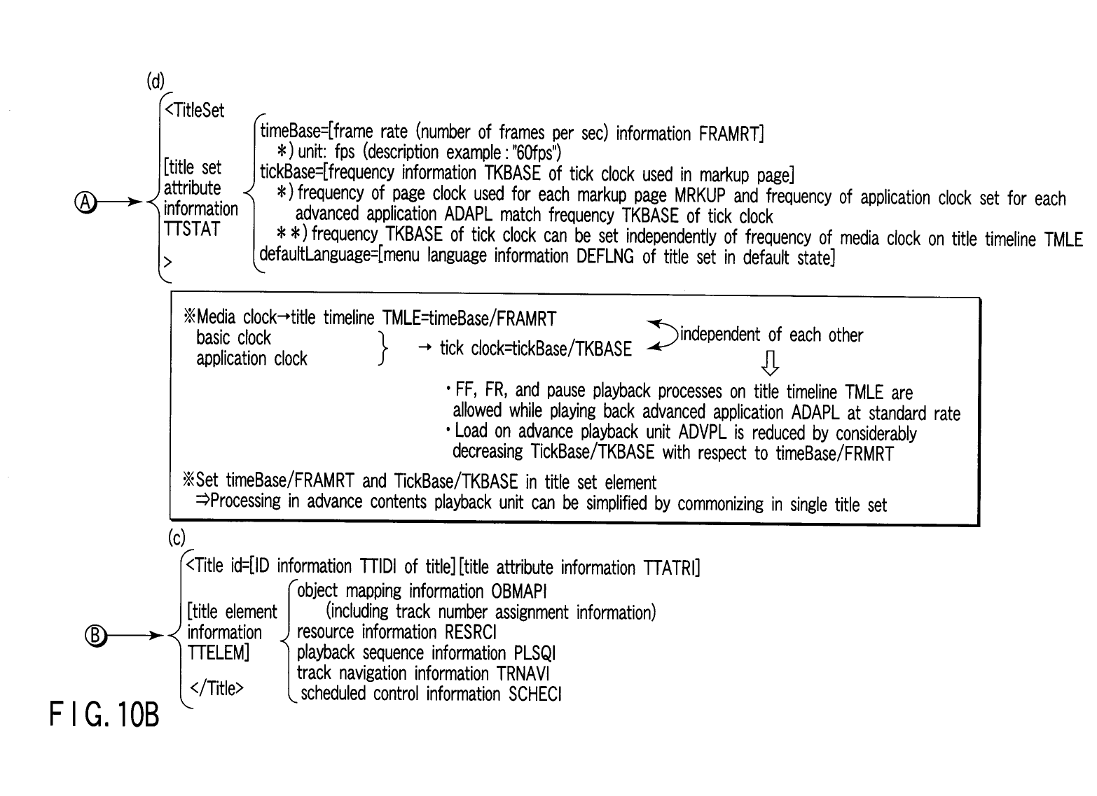

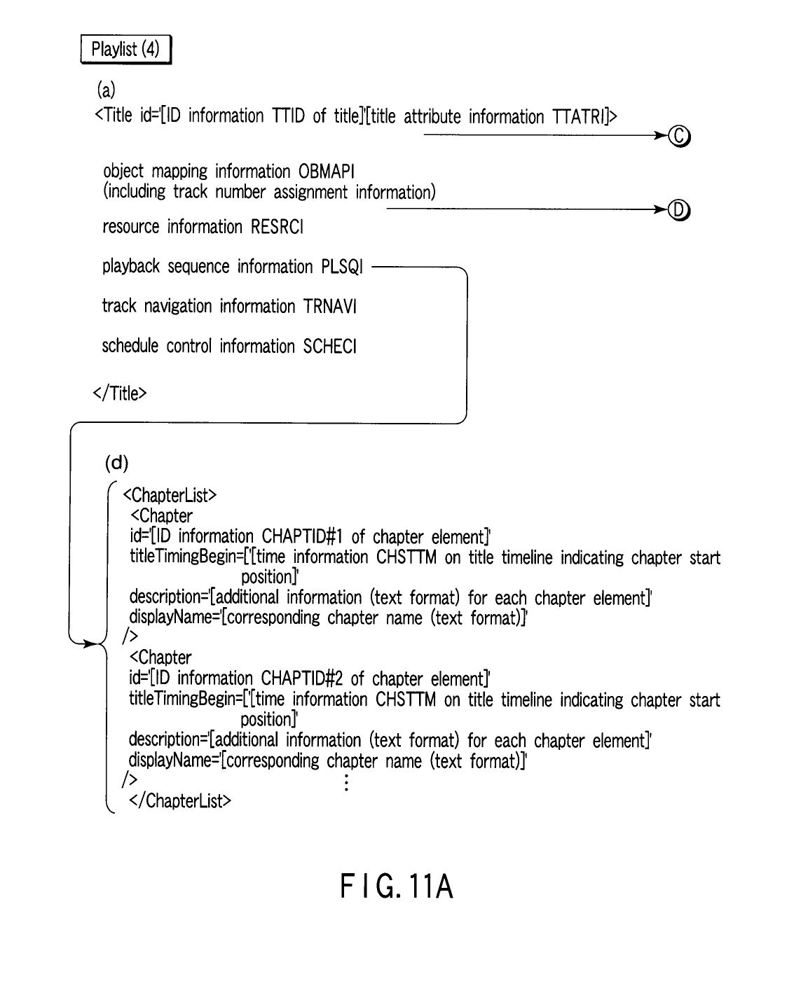

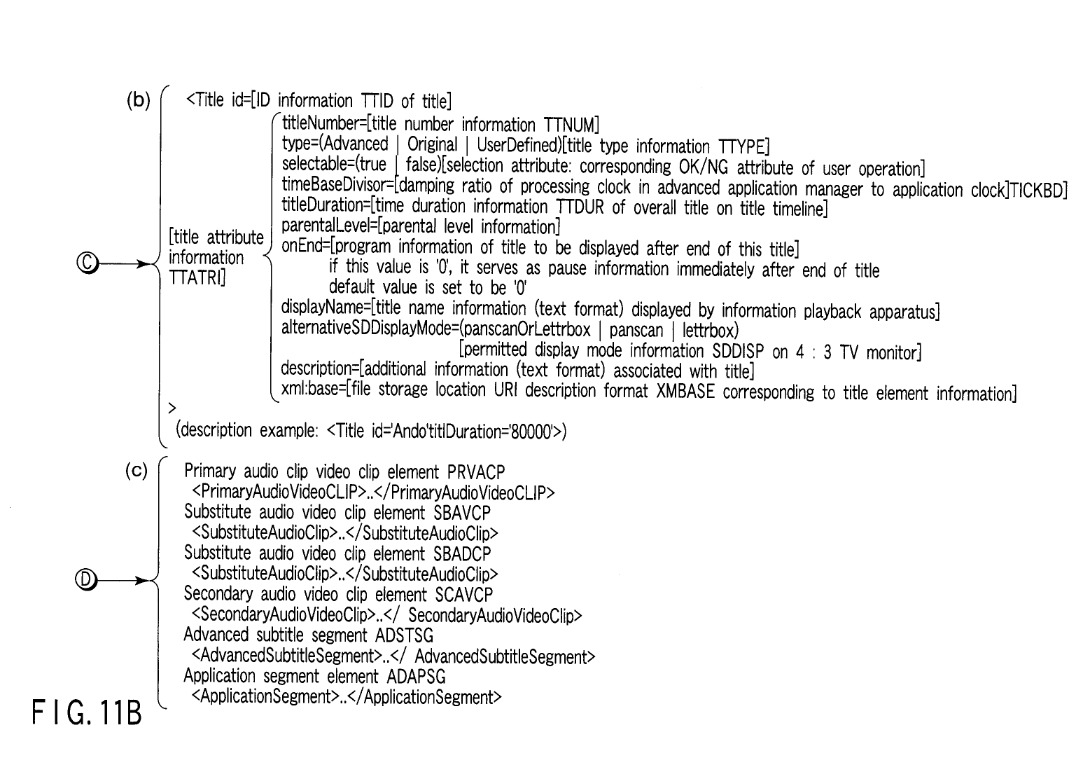

FIGS. 10A and 10B show an example of the data structure of the title information. The title information is configured by describing one or more <Title> elements as child elements of the <TitleSet> element. As the child element of the <TitleSet> element, playlist application element information can be described (details will be described later). In each <Title> element, information associated with each title (to be referred to as title element information hereinafter) is described. The title element information includes object mapping information (object assignment information in playback of a title), resource information (resource information such as images and the like used in the title), playback sequence information (information used to segment the title into units called chapters), track navigation information (information used to assign video and audio tracks), schedule control information (information used to pause playback and to produce an event at certain timings), and the like (FIGS. 11A and 11B).

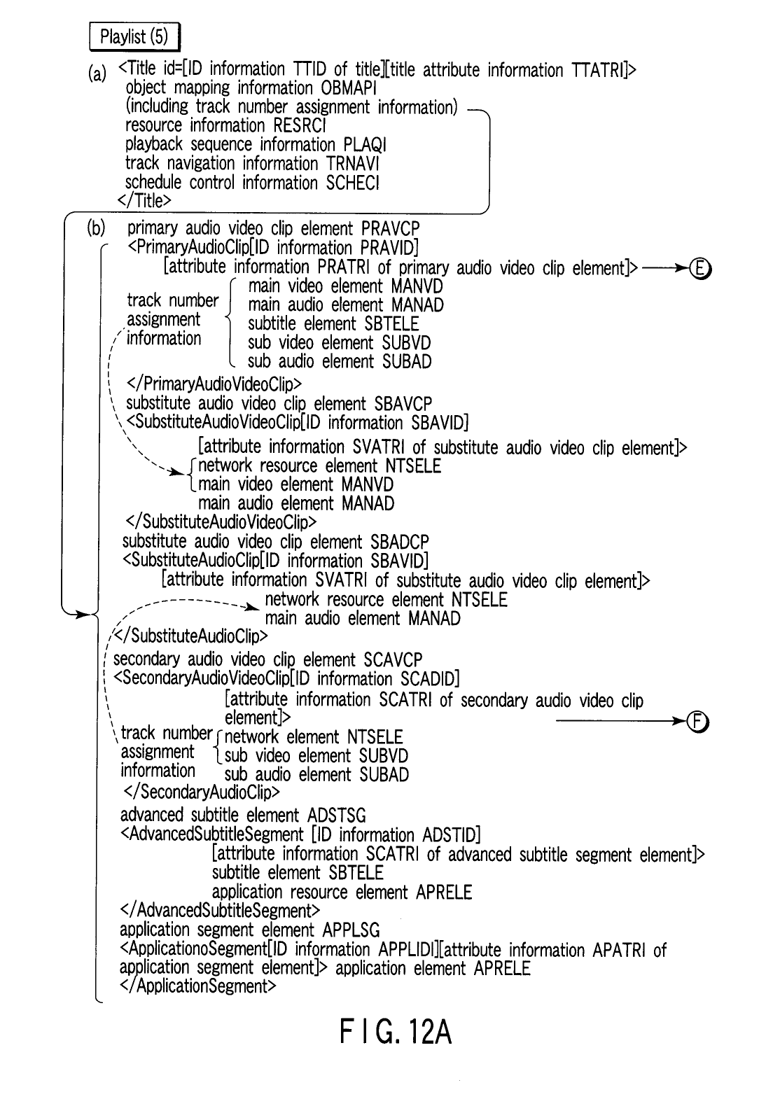

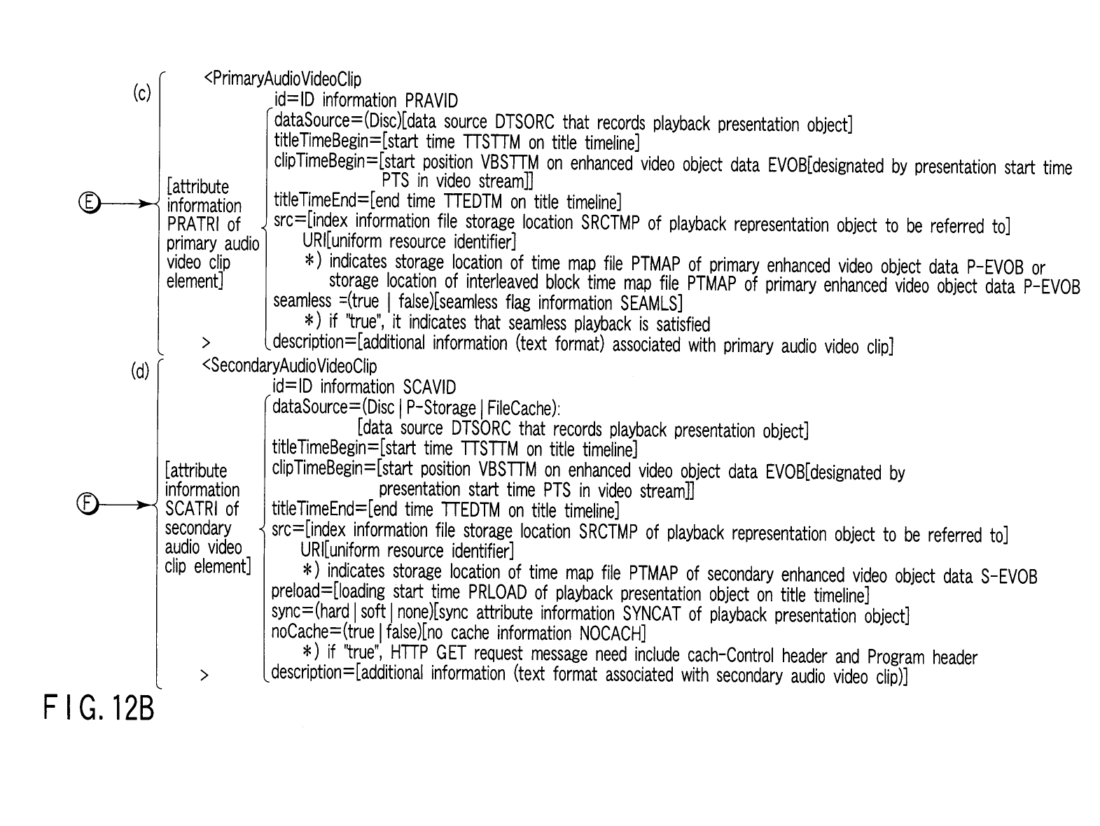

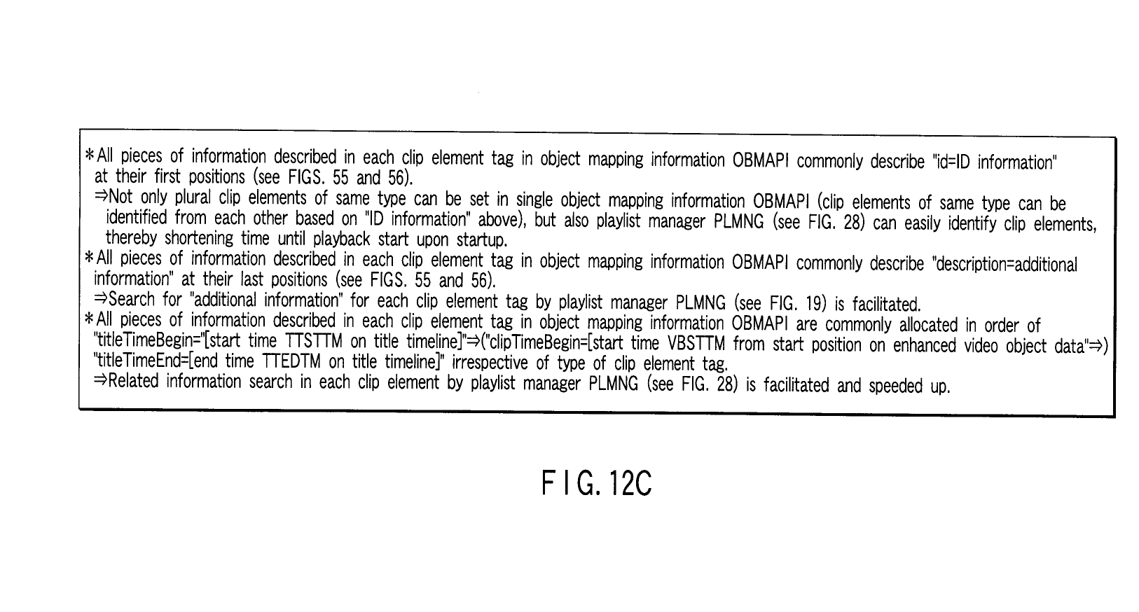

The object mapping information as one type of title element information describes information associated with the playback start and end times of objects such as video and audio objects, advanced application, advanced subtitle, and the like, information of files used in their playback, and the like (FIGS. 12A and 12B).

Elements that can be described as the object mapping information include a <PrimaryAudioVideoClip> element (which describes information of the playback start and end times of a primary audio video, the URI indicating the storage location of the object as a file, and the like), a <SubstituteAudioVideoClip> element (which describes information of the playback start and end times of a substitute audio video, the URI indicating the storage location of the object as a file, and the like), a <SubstituteAudioClip> element (which describes information of the playback start and end times of a substitute audio, the URI indicating the storage location of the object as a file, and the like), a <SecondaryAudioVideoClip> element (which describes information of the playback start and end times of a secondary audio video, the URI indicating the storage location of the object as a file, and the like), an <AdvancedSubtitleSegment> element (which describes information of the playback start and end times of an advanced subtitle, the URI indicating a manifest file of the advanced subtitle, and the like), an <ApplicationSegment> element (which describes information of the playback start and end times of an advanced application, the URI indicating a manifest file of the advanced application, and the like), and the like (FIGS. 12A and 12B, FIGS. 13A and 13B, and FIGS. 14A to 14C).

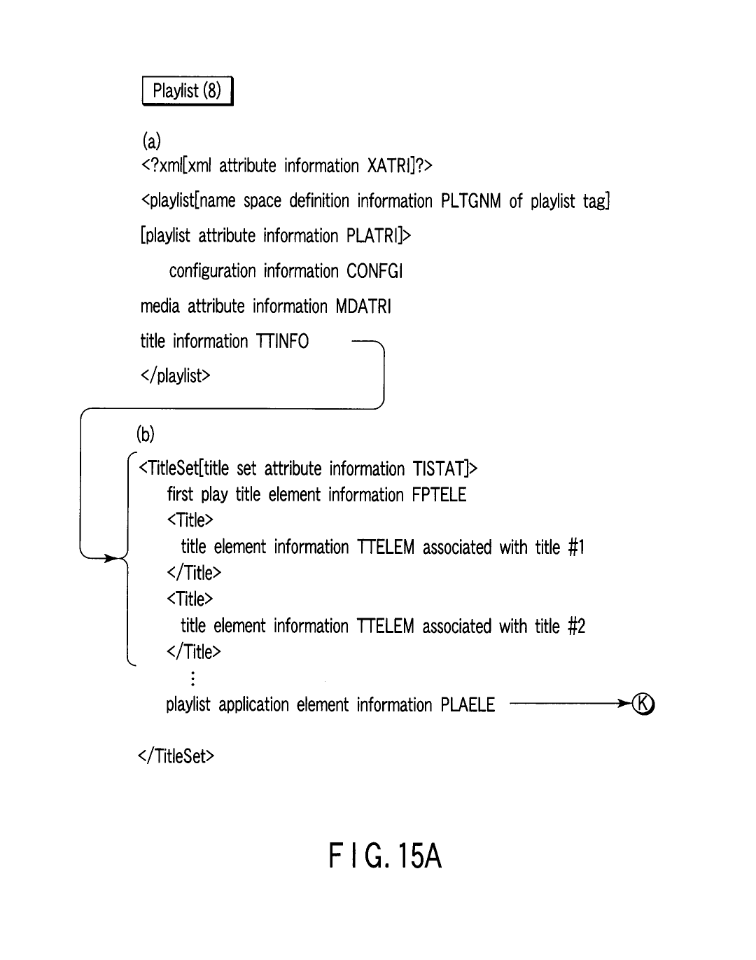

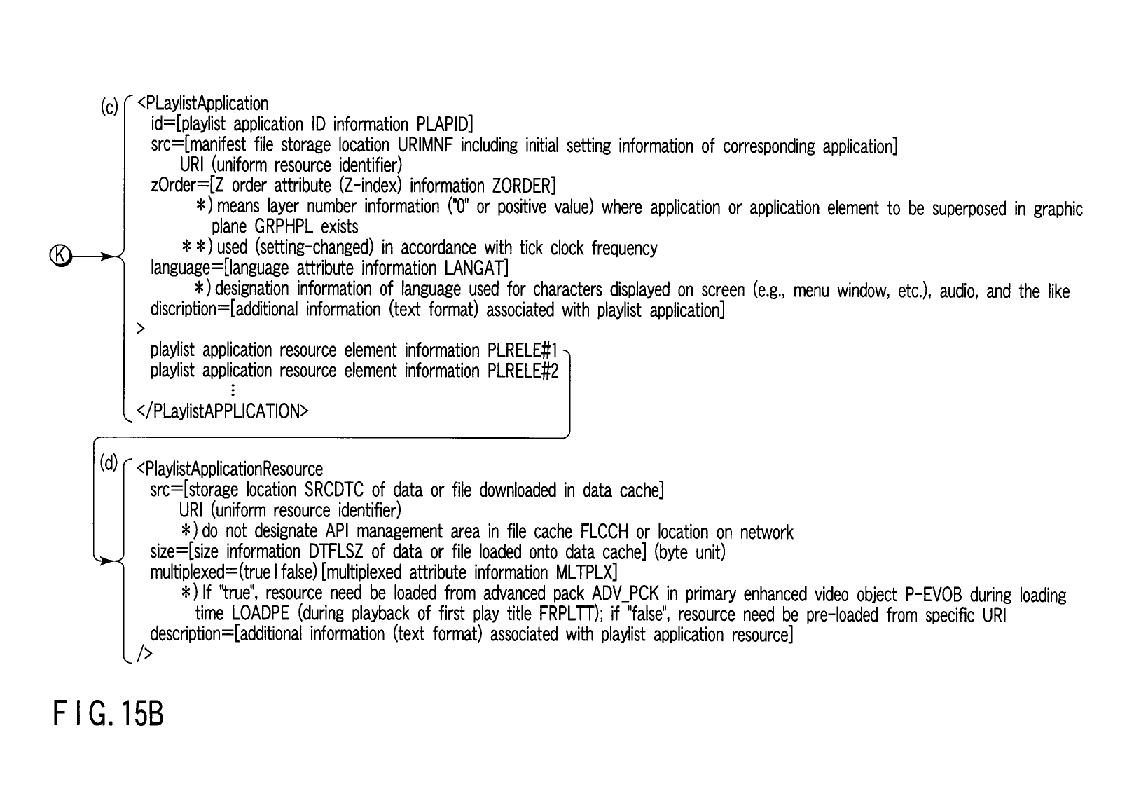

The advanced application described as the object mapping information of the title element information is called a title application. The title application is valid only during playback of the corresponding title (strictly speaking, only between the playback start and end times specified by the <ApplicationSegment> element). By contrast, an advanced application which is valid all the time during playback of the playlist is called a playlist application. Information associated with the playlist application can be described in the form of a <PlaylistApplication> element as a child element of the <TitleSet> element (FIGS. 15A and 15B).

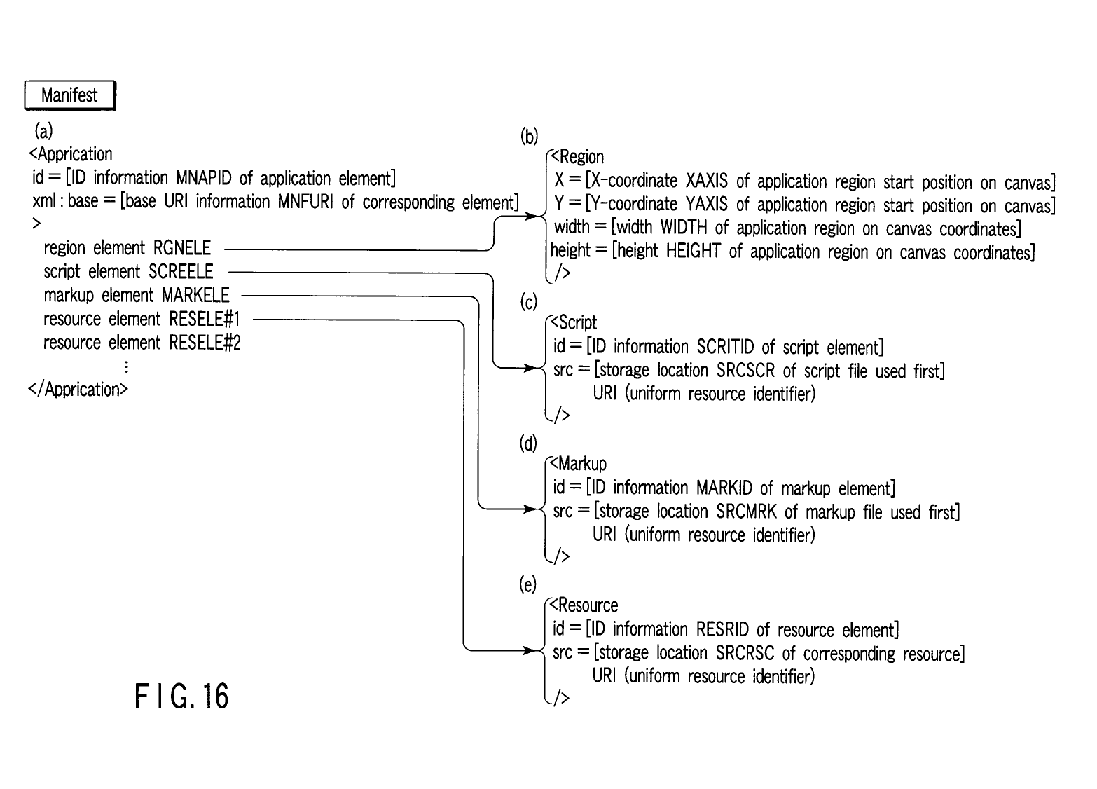

FIG. 16 shows an example of a manifest.

The <ApplicationSegment> element of the playlist designates a manifest file used in the corresponding application. The manifest is initialization information of the advanced application. The player launches the advanced application in accordance with information described in the manifest. The manifest describes information associated with a markup to be executed first, information associated with a script (plural designations allowed) executed in application start processing, and the like using an XML language.

A root element of the manifest is an <Application> element. As child elements of the <Application> element, an region element <Region>, script element <Script>, markup element <Markup>, and resource element <Resource> can be described. A plurality of <Script> and <Resource> elements can be described. One <Region> element need be inevitably described, and zero or one <Markup> element need be described.

The <Region> element specifies a region on a canvas of the application. The <Script> element designates a script file (details will be described later) used in the application. The <Markup> element designates a markup file used in the application. The <Resource> element designates all resources (including the script file and markup file in addition to image data, font data, and the like) used in the application.

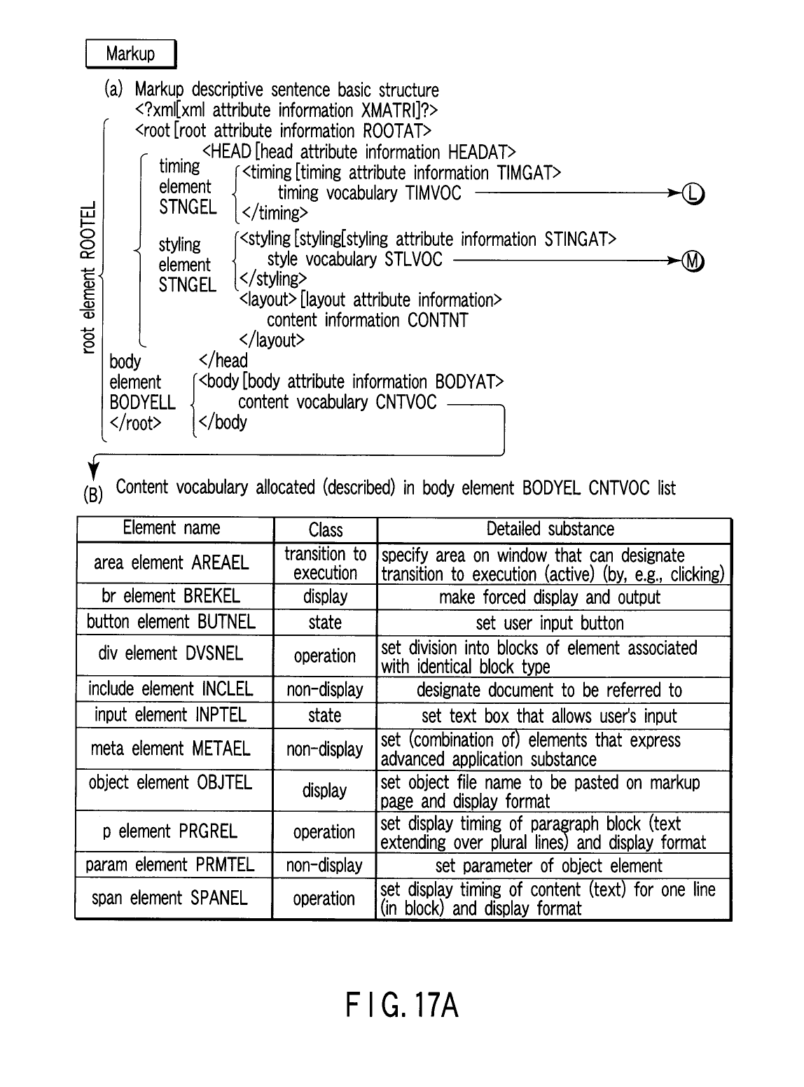

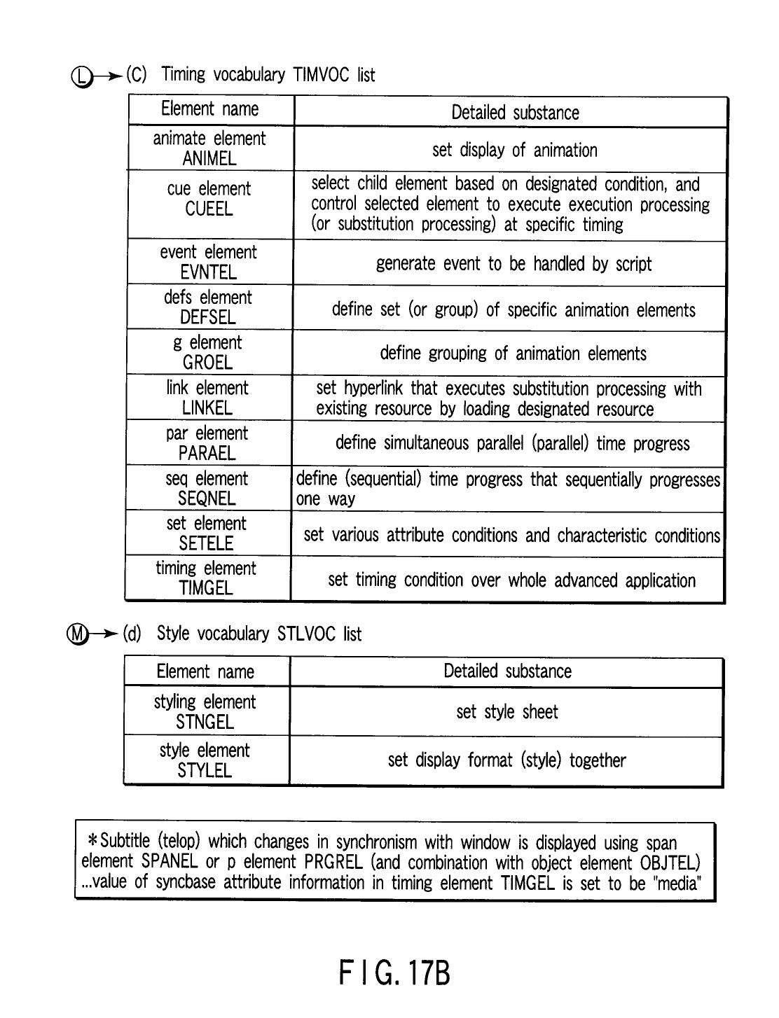

FIGS. 17A and 17B show an example of a markup.

The markup is a playback control file described using an XML language. The markup is used to allocate buttons on a window or to display a message. A plurality of markups cannot be played back at the same time for one advanced application.

A root element of the markup is <root>, and timing information, styling information, content information, and the like are described as its child elements (FIGS. 17A and 17B). The content information is information associated with buttons and objects used by the application, and includes a <button> element, <object> element, <input> element, and the like. The timing information is information associated with the behavior upon pressing of each button, and includes an <animate> element, <event> element, <set> element, and the like. The styling information is information used upon designation of button allocations, the font display size, and the like, and such designations can be implemented by setting various attributes (style: fontsize, style: backgroundColor, etc.) of the <style> element.

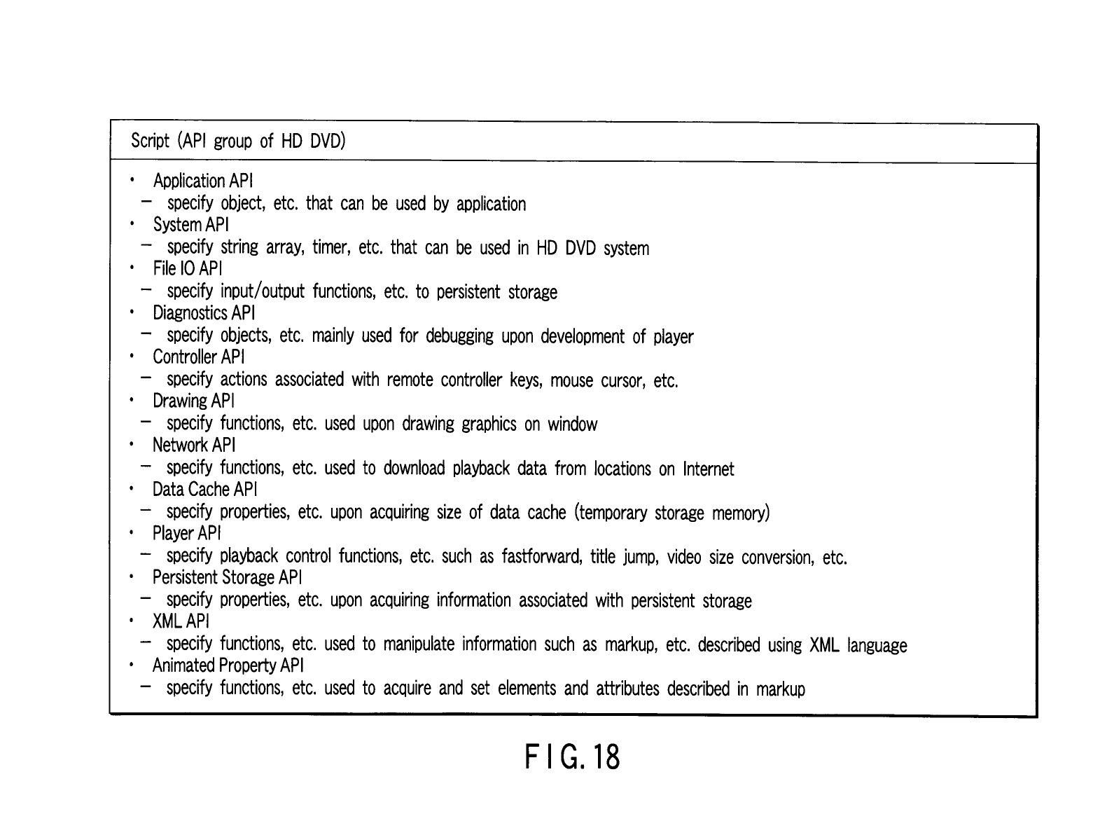

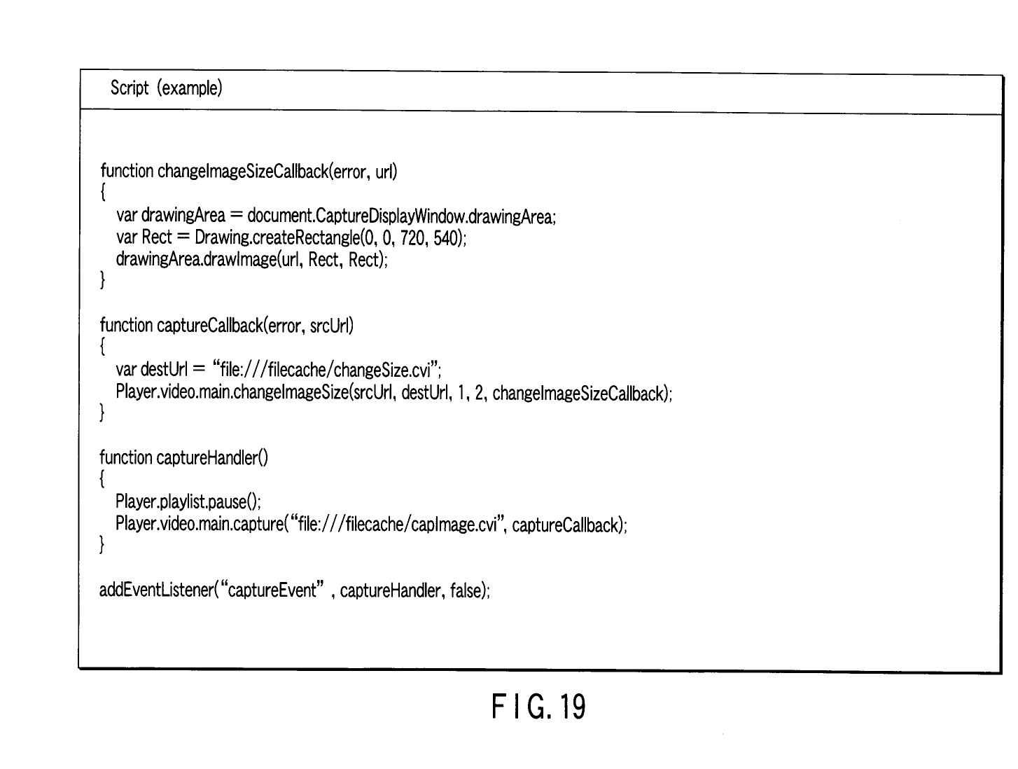

FIGS. 18 and 19 show an example of a script.

The script is a playback control file described using an ECMA script. In the HD DVD, properties and functions unique to the HD DVD can be used in addition to properties (values that can be referred to by names: for example, a Player.countryCode property stores a country code of the player) functions (processing: for example, when a Player.playlist.pause( ) function is called, playback is paused) specified by the ECMA script standard. A set of properties and functions that can be used is called an API.

As shown in FIG. 18, APIs unique to the HD DVD include the following 12 types.

Application API

specifies objects and the like that can be used by the application

System API

specifies a string array, timer, and the like that can be used in the HD DVD system

File IO API

specifies input/output functions and the like to the persistent storage

Diagnostics API

specifies objects and the like mainly used for debugging upon development of a player

Controller API

specifies actions associated with remote controller keys, a mouse cursor, and the like

Drawing API

specifies functions and the like used upon drawing graphics on a window

Network API

specifies functions and the like used to download playback data from locations on the Internet

Data Cache API

specifies properties and the like upon acquiring the size of the data cache (temporary storage memory)

Player API

specifies playback control functions and the like such as fastforward, title jump, video size conversion, and the like

Persistent Storage API

specifies properties and the like upon acquiring information associated with the persistent storage

XML API

specifies functions and the like used to manipulate information such as a markup or the like described using an XML language

Animated Property API

specifies functions and the like used to acquire and set elements and attributes described in the markup

Using these APIs, various actions such as storage of one frame of video data which is being played back in the persistent storage as a still image, drawing a picture on a window, changing message text displayed by the markup, and the like, can be implemented. FIG. 19 shows an example of a script. In this example, when an event “captureEvent” is issued (issuance of the event can be described in the playlist and can be set in the markup, so that the event can be issued upon pressing of a button), playback is paused. A video picture displayed at that time is captured as a still image, and is saved in the file cache (temporary storage memory). After that, the size of that still image is changed to ½, and that still image is displayed on (an area defined by CaptureDisplayWindow by the markup of) a window.

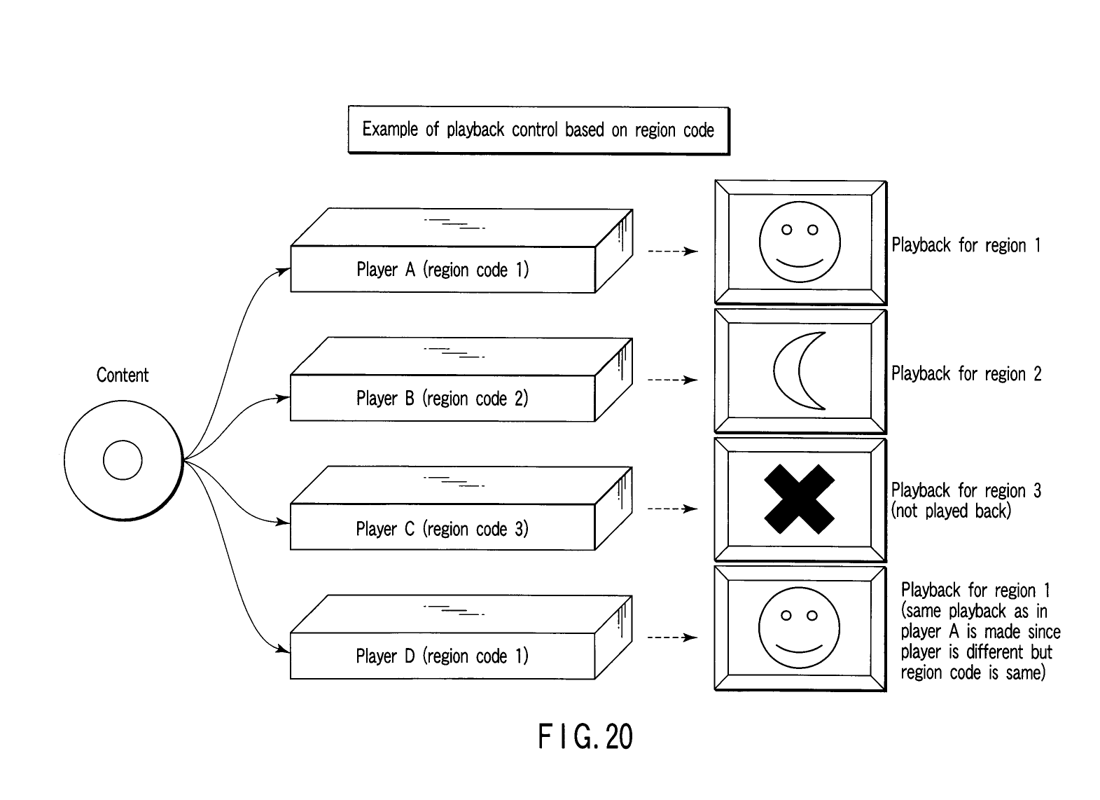

FIG. 20 shows an overview of region control.

The region control means control of playback according to a region code held in each player. This embodiment expands the region control adapted in the existing DVD standard, and introduces the expanded control to the HD DVD standard. Since there are eight region codes 1 to 8 in the existing DVD standard, the invention also will give an explanation using eight region codes 1 to 8. Of course, if number of region codes increases, the invention is applicable.

The region control in the existing DVD standard merely allows only two branches, i.e., to permit a given player to play back a content and to inhibit another player from playing back that content. As shown in FIG. 20, the invention can implement advanced playback control which allows a player of a region “1” to play back a content for the region “1” and a player of a region “2” to play back a content for the region “2”, and inhibits a player of a region “3” from playing back any content. Also, the invention can implement control for various levels like an application unit, script unit, and function unit in addition to branches based on a contents unit.

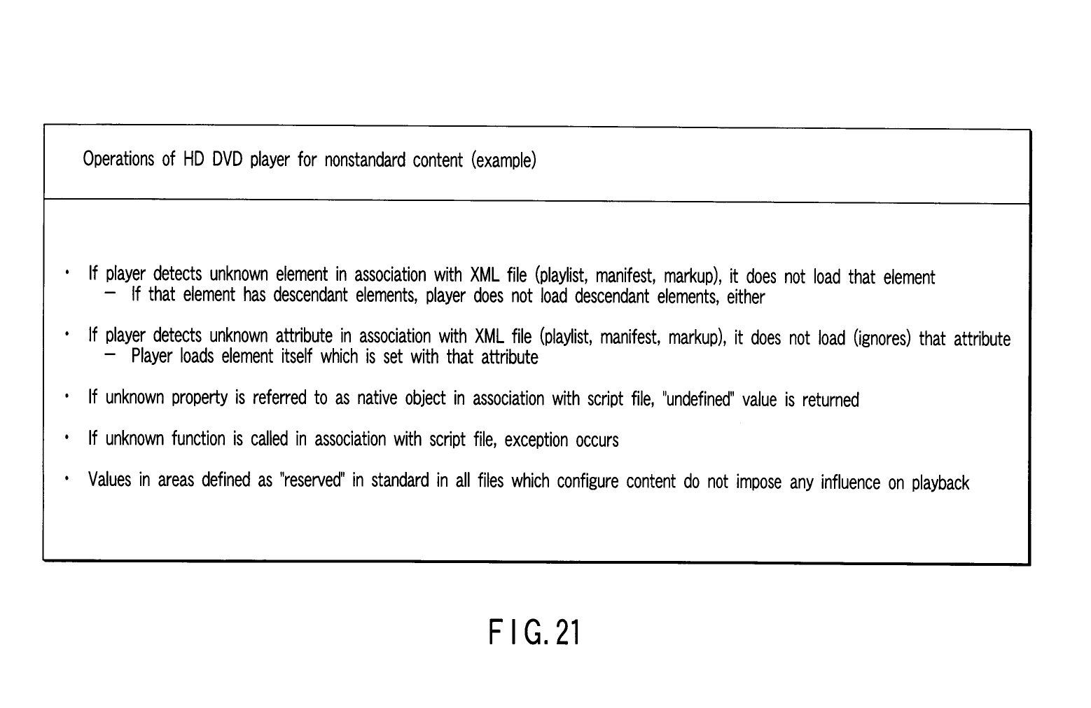

FIG. 21 shows an example of operations of the HD DVD player for a nonstandard content. In the following description, the following implementations will be assumed as an example of operations of the HD DVD player for a nonstandard content.

If the player detects an unknown element in association with an XML file (playlist, manifest, markup), it does not load that element (and does not load its descendant elements if any).

If the player detects an unknown attribute in association with an XML file (playlist, manifest, markup), it does not load that attribute (but loads an element itself which is set with that attribute).

If the player detects an unknown property in association with a script file, it returns a value “undefined” specified by the ECMA script standard.

If an unknown function is called in association with a script file, an exception (exceptional error) occurs.

Values in areas defined as “reserved” in the HD DVD standard in all files which configure a content do not impose any influence on playback.

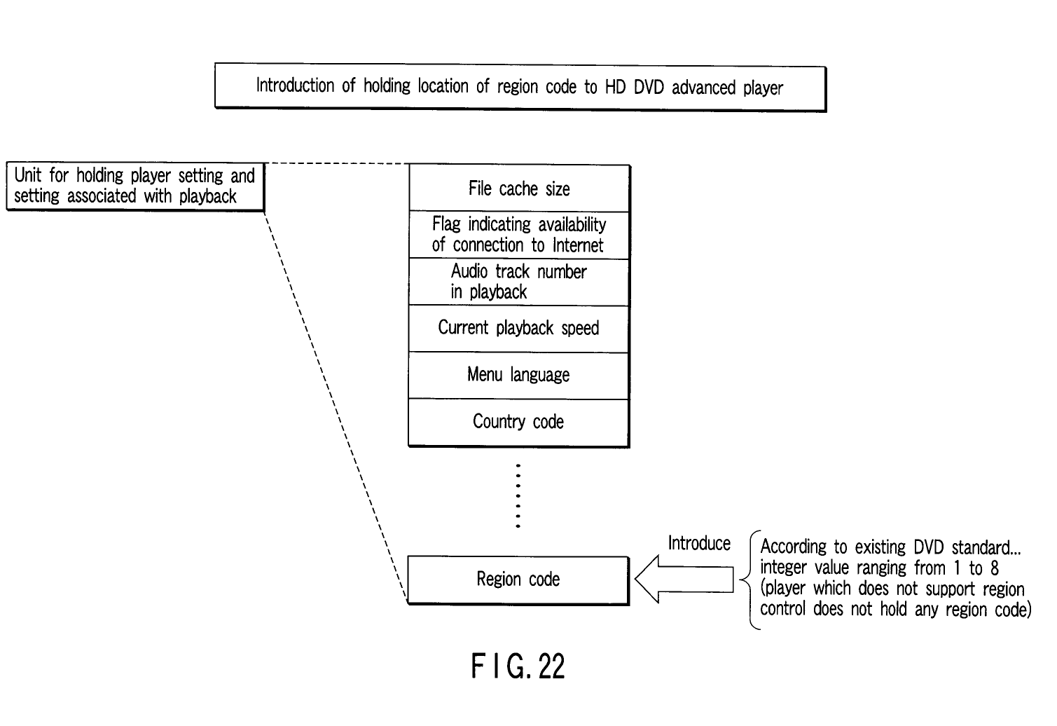

FIG. 22 is a view for explaining holding of a region code by an HD DVD advanced contents player.

In order to implement playback control based on a region code, the player holds a region code. The storage unit (unit for holding player settings and settings associated with playback) 1 shown in FIG. 6 holds various values such as settings of a country code and menu language of the player, an audio track number to be played back, and the like. In this embodiment, the storage unit 1 holds a region code in addition to these values.

The player holds only one region code. As described above, the region code assumes any one of integer values “1” to “8” according to the existing DVD standard, and a player which does not support region control does not hold any region code value (it never refers to such value since it does not support the region control). A description of the following embodiments will be given under the assumption that the region code value falls within a range from 1 to 8. However, that value range may be changed.

The way the player holds the region code does not influence playback and the invention.

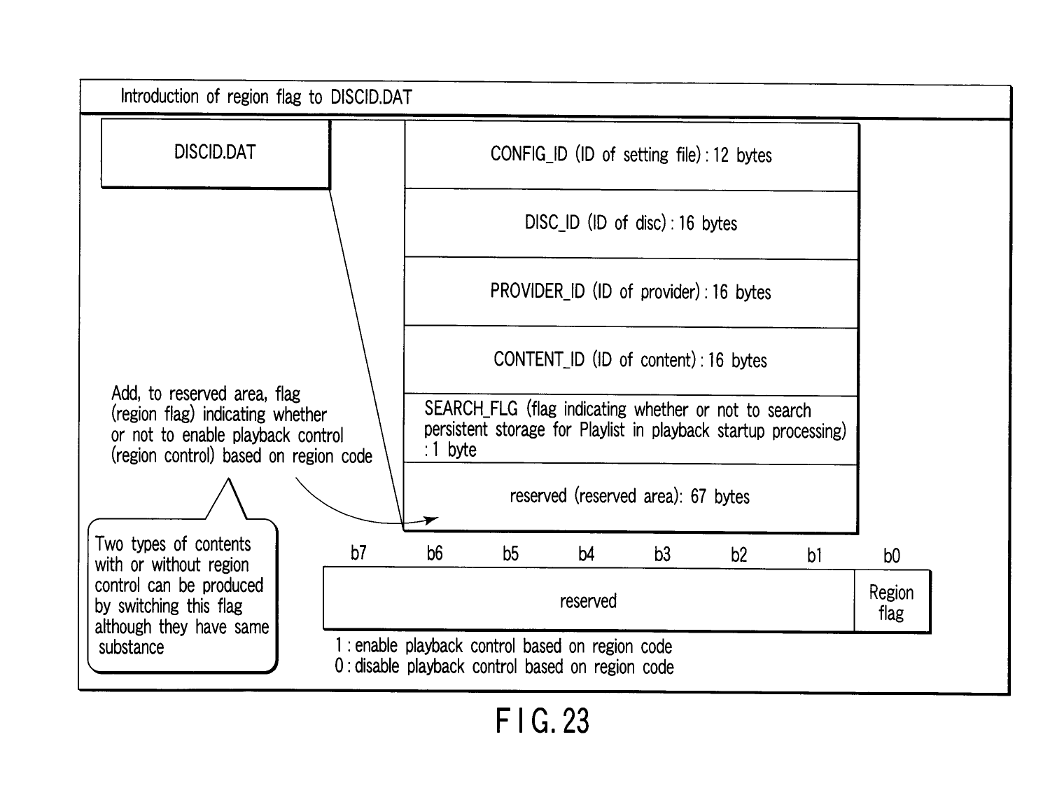

FIG. 23 shows an example of introduction of a region flag to the DISCID.DAT.

The region flag (which indicates whether to enable or disable the region control) is introduced into the DISCID.DAT as the setting file shown in FIG. 7 (FIG. 23). Since the DISCID.DAT has a 67-byte reserved area, the region flag is introduced there. If the region flag is “1”, the region control is enabled; if the region flag is “0”, the region control is disabled. By introducing the region flag to the DISCID.DAT loaded in the playback startup processing, the influence of branches as to whether to enable or disable the region control can be imposed on the whole playback processing.

Since the region flag produces effects in combination with some embodiments to be described later, a description thereof will be given later together with the description of these embodiments.

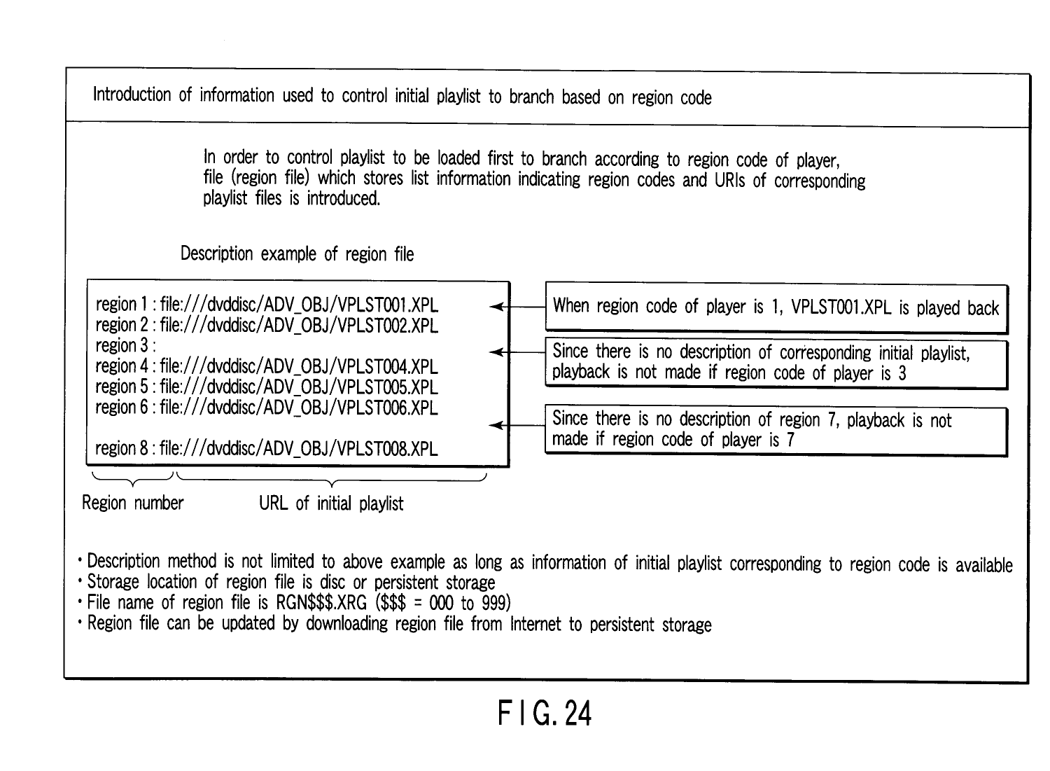

FIG. 24 shows an example of introduction of information used to control an initial playlist to branch based on the region code.

In order to control an initial playlist (a playlist to be loaded first) to branch according to the region code of the player, a file (to be referred to as a region file hereinafter) which stores list information indicating region codes of players and the URIs (file locations) of corresponding initial playlists is introduced (FIG. 24).

The file name of the region file is, for example, RGN$$$.XRG ($$$: 000 to 999). The advanced contents playback startup processing is executed, as described in the flowchart shown in FIG. 5. By introducing the region file, a playlist can be selected according to the region code of the player. The description method of the region file is not limited to the example shown in FIG. 24, as long as the region code of the player and the list information of corresponding initial playlists need only be held. The region file can be stored in the disc or persistent storage. As shown in the example of the directory and file configurations shown in FIG. 4, an advanced content is configured by various directories and files. The storage location of the region file is not particularly limited (since the same effects can be obtained irrespective of storage locations). However, the following description will be given under the assumption that if the region file is stored on the disc, it is stored immediately under the ADV_OBJ directory.

The region file can be updated by downloading it from the Internet to the persistent storage in the same manner as other files. In this case, a plurality of region files may be stored. Details such as selection of a region file to be used will be described later in “flowcharts showing the processing for controlling an initial playlist based on a region code”.

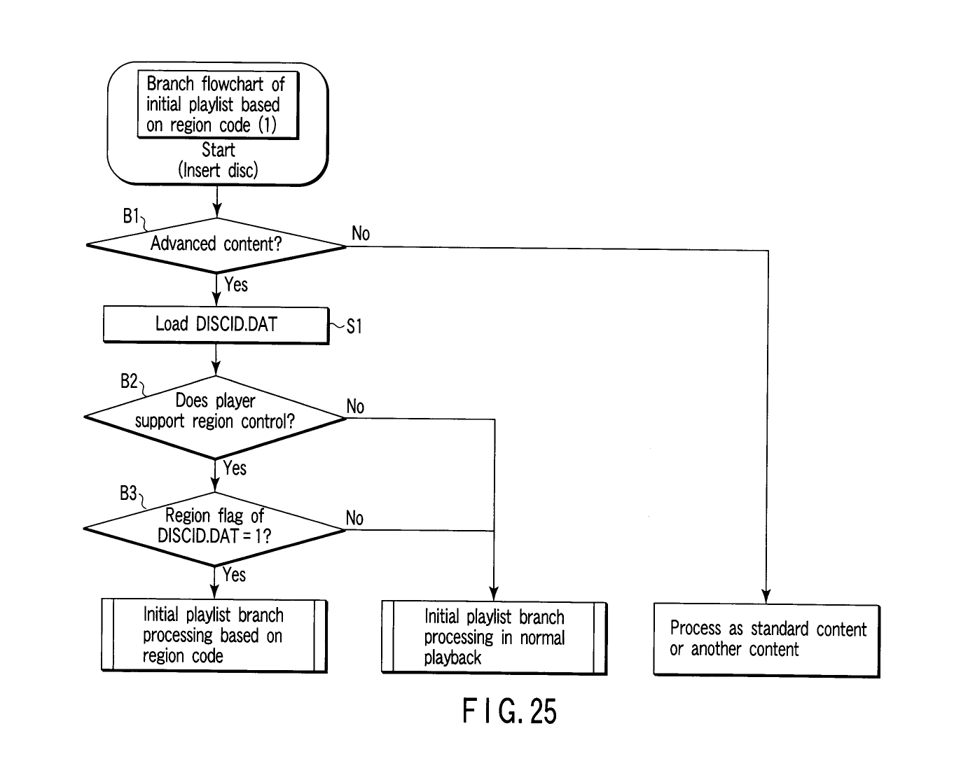

FIGS. 25 to 27 are branch flowcharts of an initial playlist based on a region code. That is,

FIGS. 25 to 27 are branch flowcharts of the initial playlist based on the region code using the region flag and region file.

B1: The player checks, using the flowchart of FIG. 2, whether or not the content to be played back is an advanced content. If the content to be played back is an advanced content, the process advances to S1; otherwise, it is determined that the content to be played back is a standard content or another content to execute processing (this embodiment targets at an advanced content).

S1: The player loads the DISCID.DAT. The process advances to B2.

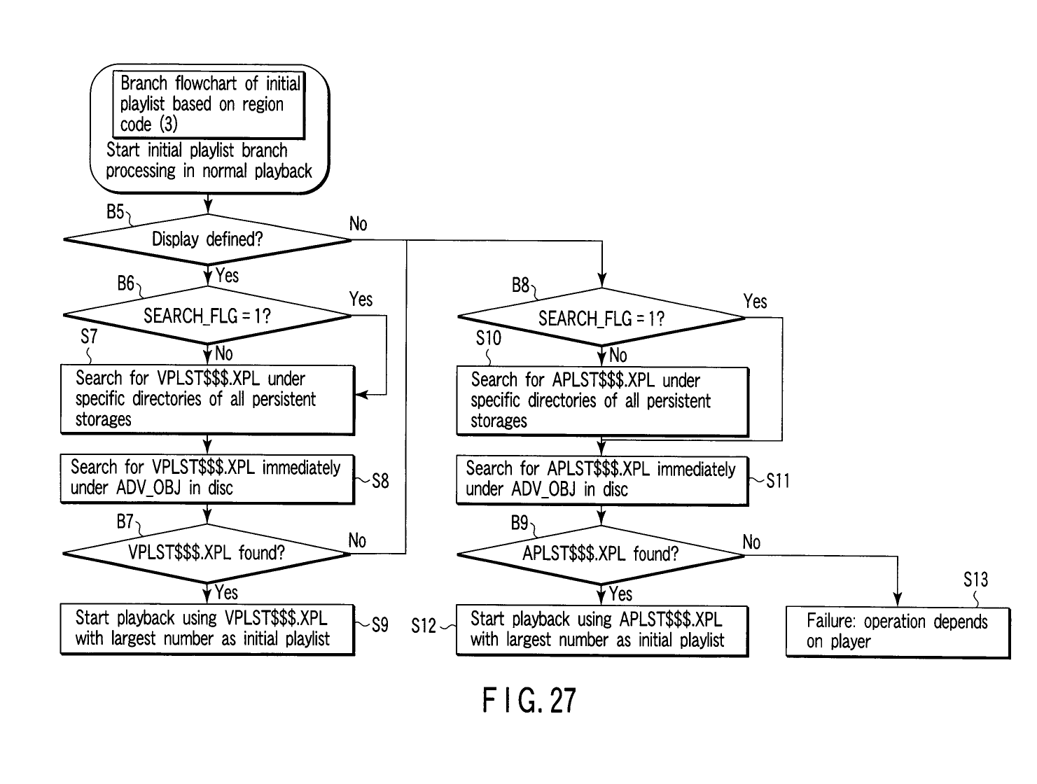

B2: If the player supports region control, the process advances to B3. If the player does not support region control, the process advances to initial playlist branch processing in normal playback (B5 in FIG. 27).

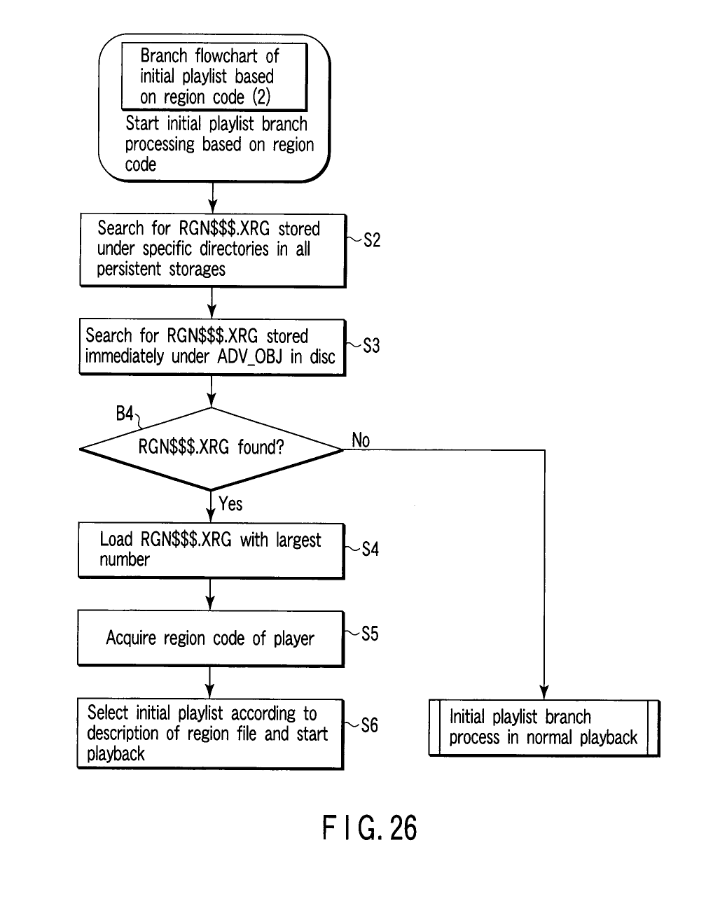

B3: If the region flag of the DISCID.DAT is “1”, the process advances to initial playlist branch processing based on a region code (S2 in FIG. 26). If the region flag is “0”, the process advances to the initial playlist branch processing in normal playback (B5 in FIG. 27).

S2: The player searches for region files RGN$$$.XRG stored under specific directories in all persistent storages, and the process then advances to S3.

S3: The player searches for a region file RGN$$$.XRG stored immediately under the ADV_OBJ directory in the disc, and the process advances to B4.

B4: If one or more region files RGN$$$.XRG are found, the process advances to S4; if no region file is found, the process advances to the initial playlist branch processing in normal playback (B5 in FIG. 27).

S4: The player loads a region file RGN$$$.XRG with a largest number of $$$ of the found region files. The process advances to S5.

S5: The player acquires its region code, and the process advances to S6.

S6: The player selects an initial playlist according to the description of the loaded region file, and starts playback.

B5: If a display is defined, the process advances to B6; otherwise, the process advances to B8.

B6: If the search flag SEARCH_FLG of the DISCID.DAT is “0”, the process advances to S7; if SEARCH_FLG=“1”, the process jumps to S8.

S7: The player searches for playlists VPLST$$$.XPL stored under specific directories of all persistent storages, and the process advances to S8.

S8: The player searches for playlists VPLST$$$.XPL stored immediately under the ADV_OBJ directory in the disc, and the process advances to B7.

B7: If one or more playlists VPLST$$$.XPL are found, the process advances to S9; if no playlist is found, the process advances to B8.

S9: The player starts playback using a playlist with a largest number of $$$ of the found files VPLST$$$.XPL as an initial playlist.

B8: If the search flag SEARCH_FLG of the DISCID.DAT is “0”, the process advances to S10; if SEARCH_FLG=“1”, the process jumps to S11.

S10: The player searches for playlists APLST$$$.XPL stored under specific directories of all persistent storages, and the process advances to S11.

S11: The player searches for playlists APLST$$$.XPL stored immediately under the ADV_OBJ directory in the disc, and the process advances to B9.

B9: If one or more playlists APLST$$$.XPL are found, the process advances to S12; if no playlist is found, the process advances to S13.

S12: The player starts playback using a playlist with a largest number of $$$ of the found playlists APLST$$$.XPL as an initial playlist.

S13: The player has failed the startup processing. The subsequent operation depends on the player.

With this processing, a player which does not support region control executes normal playback. A player which supports region control and plays back a content with a region flag “0” also executes normal playback. A player which supports region control and plays back a content with a region flag “1” executes playback according to its region code. The merit of this embodiment lies in that the playback control based on a region code can be implemented without modifying the substance of the content (without changing the data structure described so far) by introducing only the region flag and region file. Also, as another merit, since the control can branch based on the region code at the time of the playback startup processing, the effects resulting from introduction of the region code can be achieved for the entire playback processing. In addition, this embodiment can assure compatibility with a player which does not support region control.

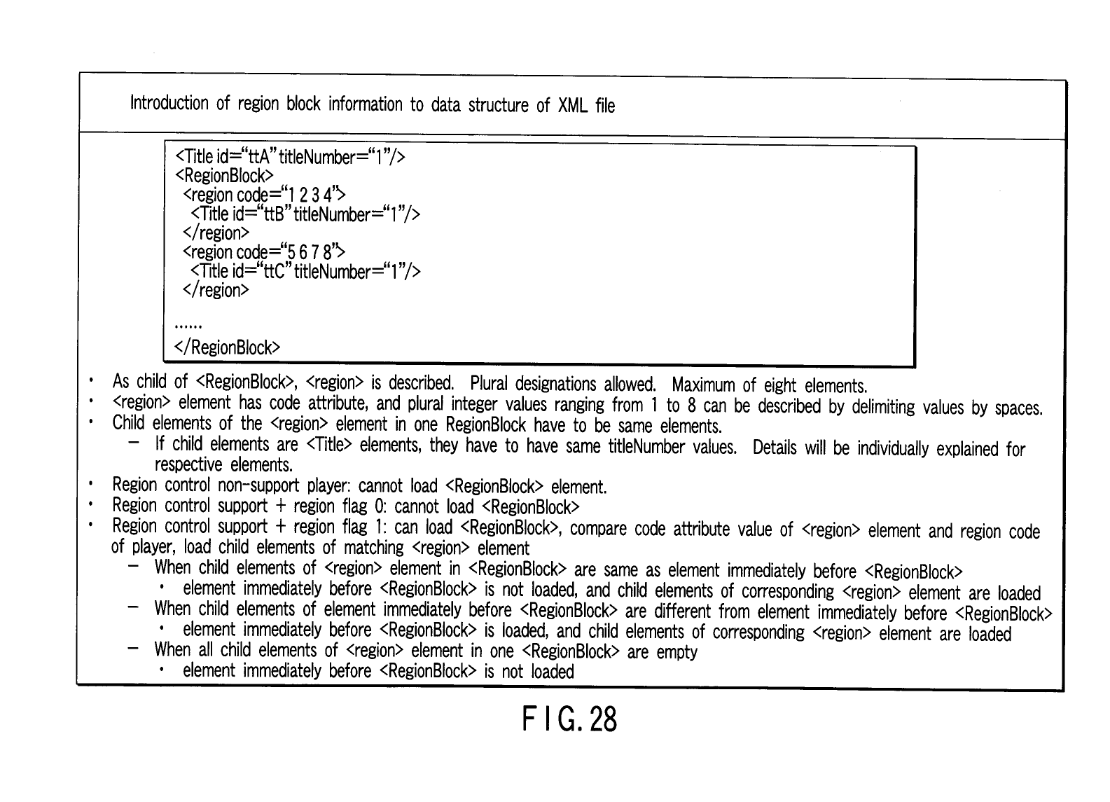

FIG. 28 shows an example of introduction of region block information to the data structure of an XML file.

Region block information <RegionBlock><region> is introduced to the data structure of each XML file (playlist, manifest, markup) shown in FIGS. 9 to 17B. A <RegionBlock> element can be described in any phase on the XML file. The <RegionBlock> element can be dealt with on the same basis as the <Playlist> element, <TitleSet> element, <Title> element, <PrimaryAudioVideoClip> element, or all other elements. However, a description that breaks the XML format is not permitted (example: <Playlist<RegionBlock/>/>, etc.)

As a child element of the <RegionBlock> element, a <region> element can be described. The <region> element can only be described as the child element of the <RegionBlock> element. As the child elements of one <RegionBlock> element, one or more <region> elements can be described up to a maximum of eight.

The <region> element can have a “code” attribute. As the value of the “code” attribute, a plurality of integer values ranging from 1 to 8 can be designated by delimiting them by spaces (example: code=“1 2 5 8”).

Child elements of the <region> element in one <RegionBlock> element have to be the same elements.

A player which does not support region control cannot load the <RegionBlock> element (and its child elements).

When a player which supports region control plays back a content with a region flag “0” of the DISCID.DAT, it cannot load the <RegionBlock> element (and its child elements).

When a player which supports region control and plays back a content with a region flag “1” of the DISCID.DAT, it can load the <RegionBlock> element (and its child elements), and compares the “code” attribute values of the <region> elements with its region code to load child elements whose “code” attribute values match the region code. Note that the <RegionBlock> and <region> elements are used to branch processes by seeing if the child elements of the <region> elements are to be loaded, and do not influence playback after the branch processing.

When child elements of each <region> element in <RegionBlock> are the same as an element immediately before <RegionBlock>, the player does not load the element immediately before <RegionBlock> but loads child elements of the <region> element which is permitted to load.

When child elements of each <region> element in <RegionBlock> are different from an element immediately before <RegionBlock>, the player loads the element immediately before <RegionBlock>, and also loads child elements of the <region> element which is permitted to load.

When child elements of each <region> element in <RegionBlock> are empty, the player does not load an element immediately before <RegionBlock>.

Since the <RegionBlock> and <region> elements themselves are not loaded (they are not added to a tree), both a player which supports region control and a player which does not support region control can progress the playback processing in the same routine after loading of XML data.

After the loading processing, each XML file has to have a description according to the rules of XML files shown in FIGS. 9 to 17B (for example, a playlist has to have one <Playlist> element as a root element, etc.).

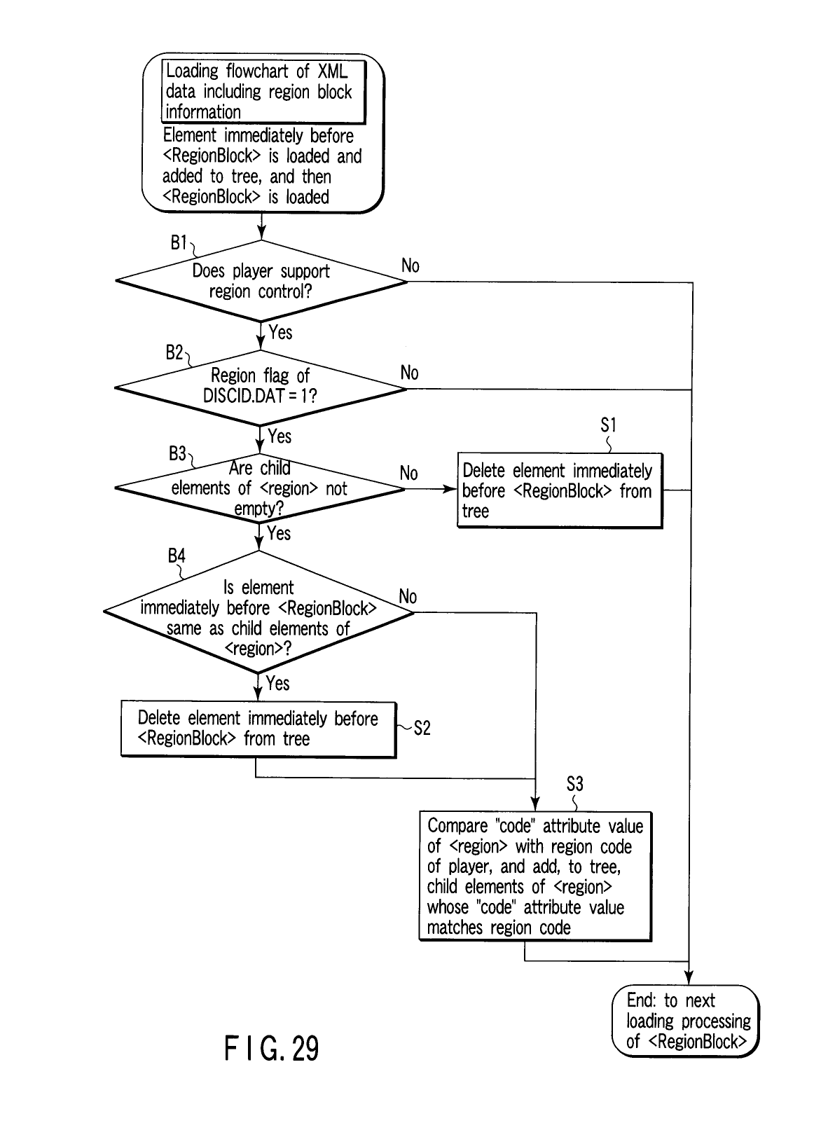

FIG. 29 is a loading flowchart of XML data including region block information. That is, FIG. 29 is a flowchart when the player loads an element immediately before <RegionBlock> adds it to a tree, and starts the loading processing of <RegionBlock>.

B1: If the player supports region control, the process advances to B2; if it does not support region control, the control skips that <RegionBlock> and starts the next loading processing.

B2: If the region flag of the DISCID.DAT is “1”, the process advances to B3; if it is “0”, the control skips that <RegionBlock> and starts the next loading processing.

B3: If child elements of <region> are not empty, the process advances to B4; if all child elements are empty, the process advances to S1.

S1: The player deletes the element immediately before <RegionBlock> from the tree, and starts the next loading processing of <RegionBlock>.

B4: If the element immediately before <RegionBlock> is the same as child elements of <region>, the process advances to S2; if they are different, the process advances to S3.

S2: The player deletes the element immediately before <RegionBlock> from the tree, and the process advances to S3.

S3: The player compares the “code” attribute values of <region> with its region code and adds child elements of <region> whose “code” attribute value matches the region code. The control then starts the next loading processing of <RegionBlock>.

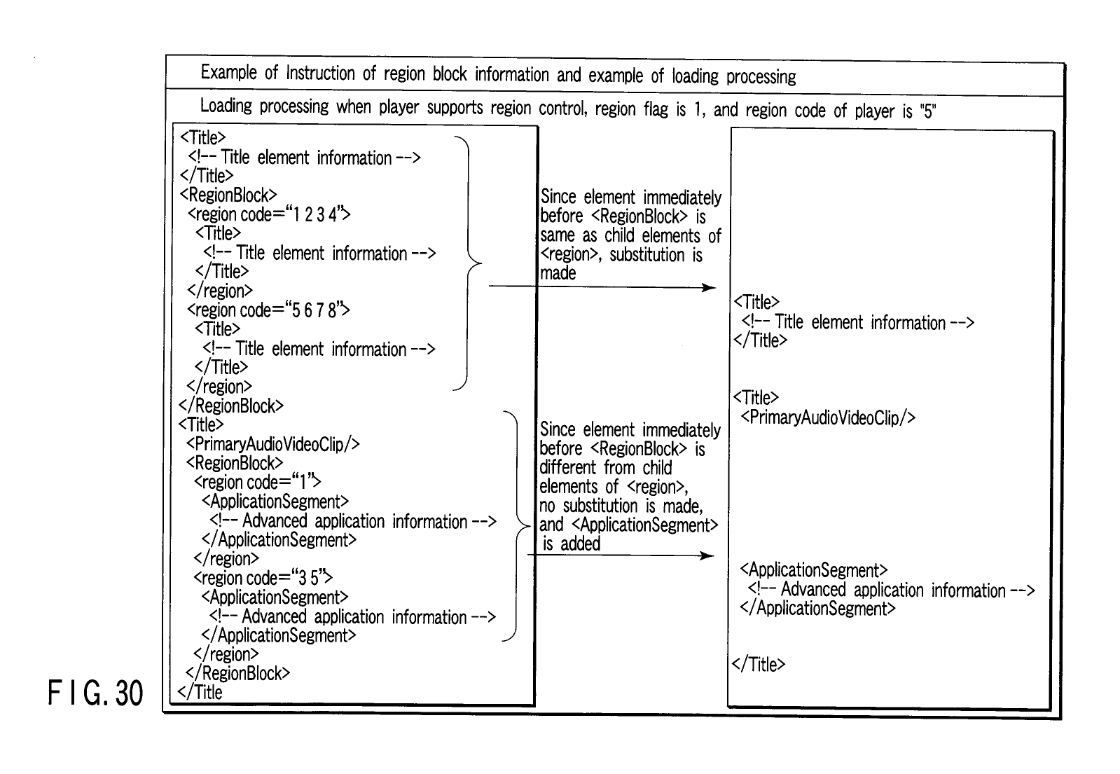

FIG. 30 shows an example of instruction of the region block information and an example of the loading processing. That is, FIG. 30 shows a partial extract example of a playlist to which <RegionBlock> elements are introduced, and an example of the loading result when a player supports region control, the region flag is “1”, and the region code of that player is “5”.

The fourth to 15th lines describe a region block. Since a child element of <region> is <Title> and matches that of an element <Title> immediately before <RegionBlock>, <Title> immediately before <RegionBlock> is deleted. Since the region code of the player is “5”, <Title> of the child element bounded by <region code=“5 6 7 8”> and </region> is loaded.

The 18th to 29th lines also describe a region block. Since a child element <ApplicationSegment> of <region> does not match an element <PrimaryAudoVideoClip> immediately before <RegionBlock>, <PrimaryAudoVideoClip> is loaded, and the child element <ApplicationSegment> bounded by <region code=“3 5”> and </region> is loaded. Then, the result of the aforementioned loading processing is as shown in the right drawing of FIG. 30. Since this result has a format that does not depend on any region blocks, the subsequent playback processing can progress in the same routine as that of a player which does not support region control.

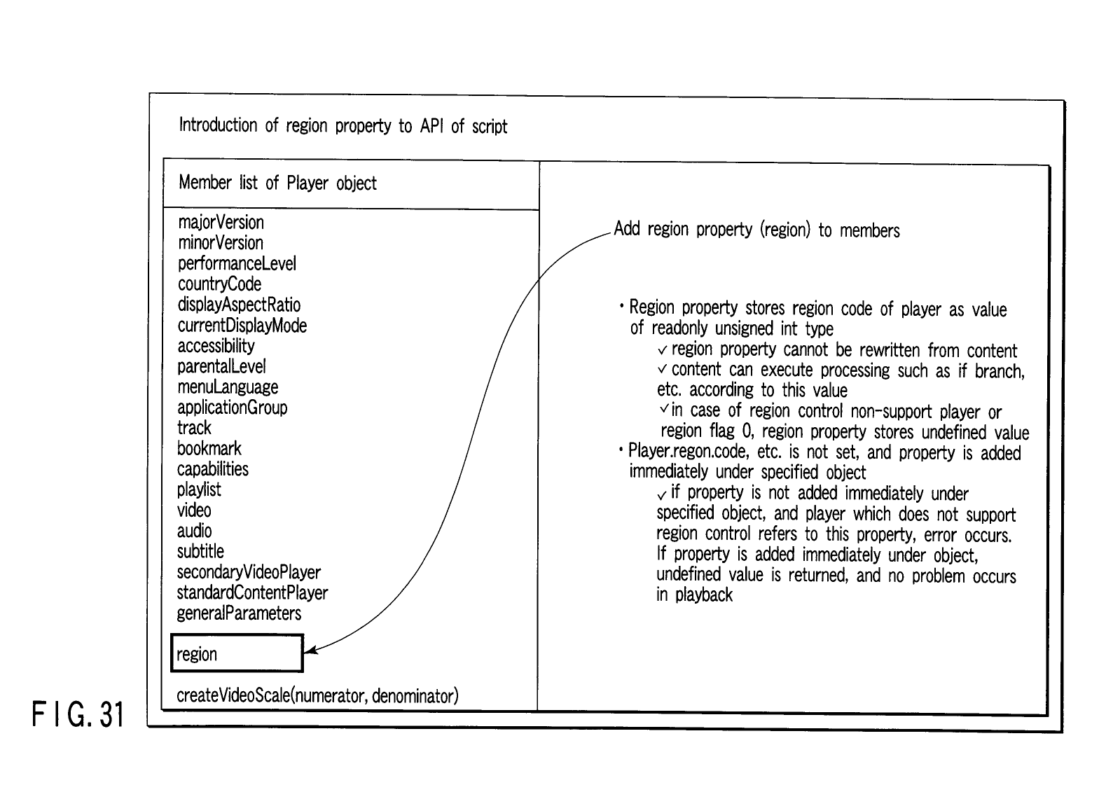

FIG. 31 shows an example of introduction of a region property to an API of a script.

A region property “region” used to implement region control is introduced to the API group shown in FIG. 18. That is, FIG. 31 shows an addition example of “region” as a member property of a Player object of the Player API.

The region property stores the region code of the player as a value of readonly unsigned int type (1 to 8). The content side cannot rewrite this value, and in case of a player which does not support region control and the region flag “0” of the DISCID.DAT, the region property stores an “undefined” value.

Based on the substance of the region property, the region property is introduced as the member of the Player object. However, if the region property is added as members of other objects, the function of the region property remains the same, and can be used in region control.

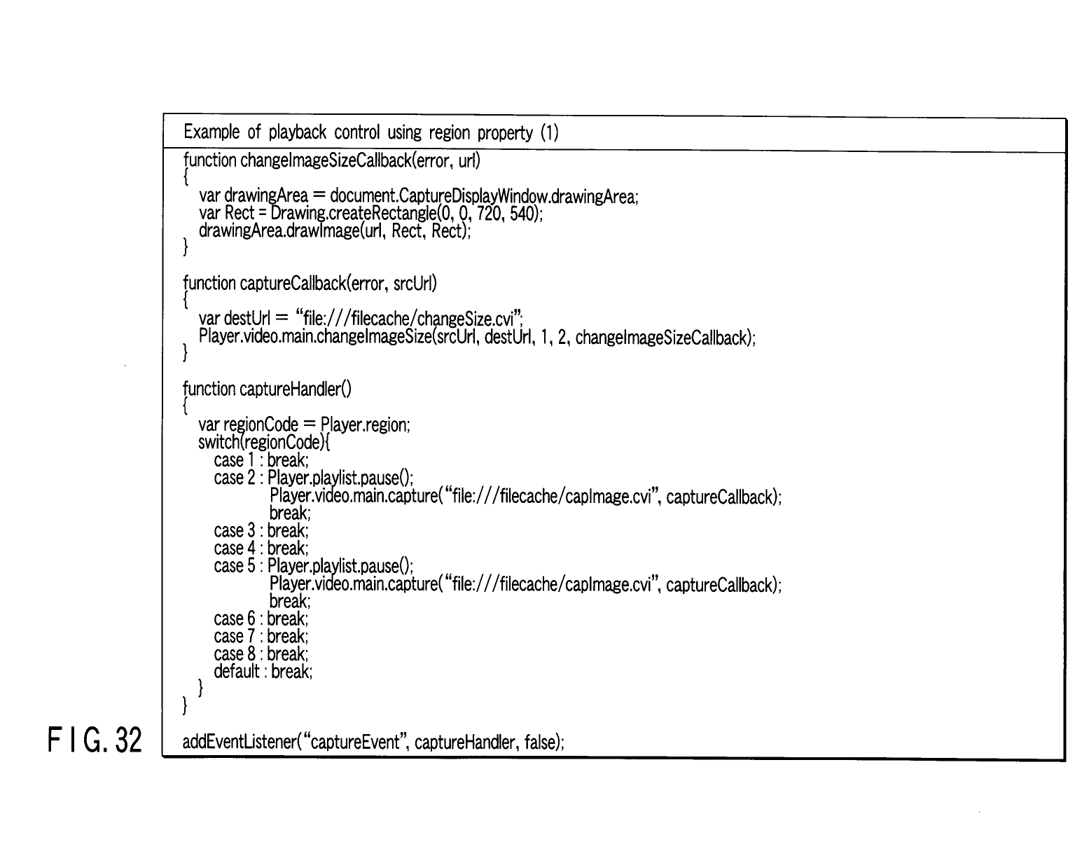

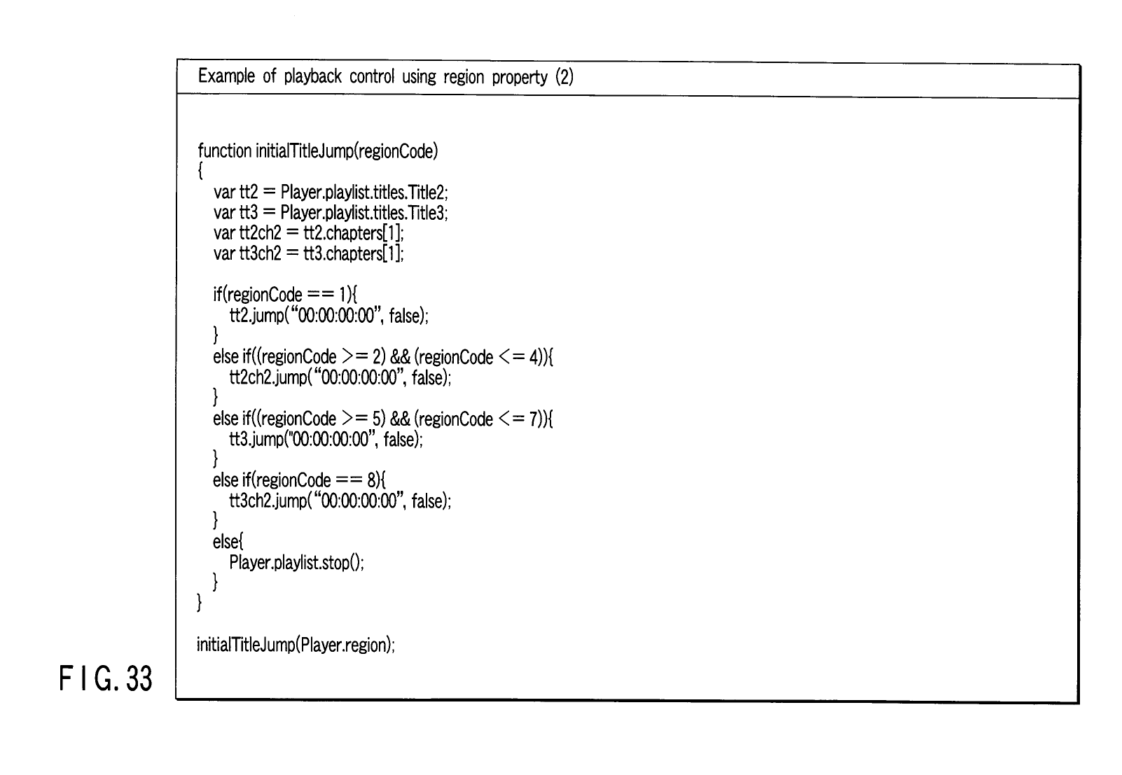

FIGS. 32 and 33 show an example of playback control using the region property.

FIG. 32 introduces branch processing using the region property to the video capture part (to capture one frame of video data as a still image) described in FIG. 19. By a “switch” statement, only when the region property value is “2” or “5” (i.e., only when the region code of the player is “2” or “5”), the player is controlled to execute the capture; when the region property assumes other values, it is controlled not to execute the capture. When a player does not support region control or when the region flag is “0”, since the region property stores “undefined”, it corresponds to “default” of the “switch” statement. In this case, the capture is not executed, either.

FIG. 33 shows an example of introduction of region control to a title jump. According to an “if” statement, if the value of the region property is “1”, the playback is controlled to jump to Title2 (a title with that name). If the value is one of “2” to “4”, the playback is controlled to jump to the second chapter of Title2. If the value is one of “5” to “7”, the playback is controlled to jump to Title3. If the value is “8”, the playback is controlled to jump to the second chapter of Title3. Otherwise (including the case of a player which does not support region control or the region flag “0”), the playback stops. In this way, the playback can branch. For example, when such script is embedded in an application of a title to be played back first (a title for playback branch processing without any video data and the like), contents to be played back can be classified according to the region codes of players.

As described above, the region property can be used in various applications such as branch processing on the title level, that on the function level, i.e., video capture, and the like.

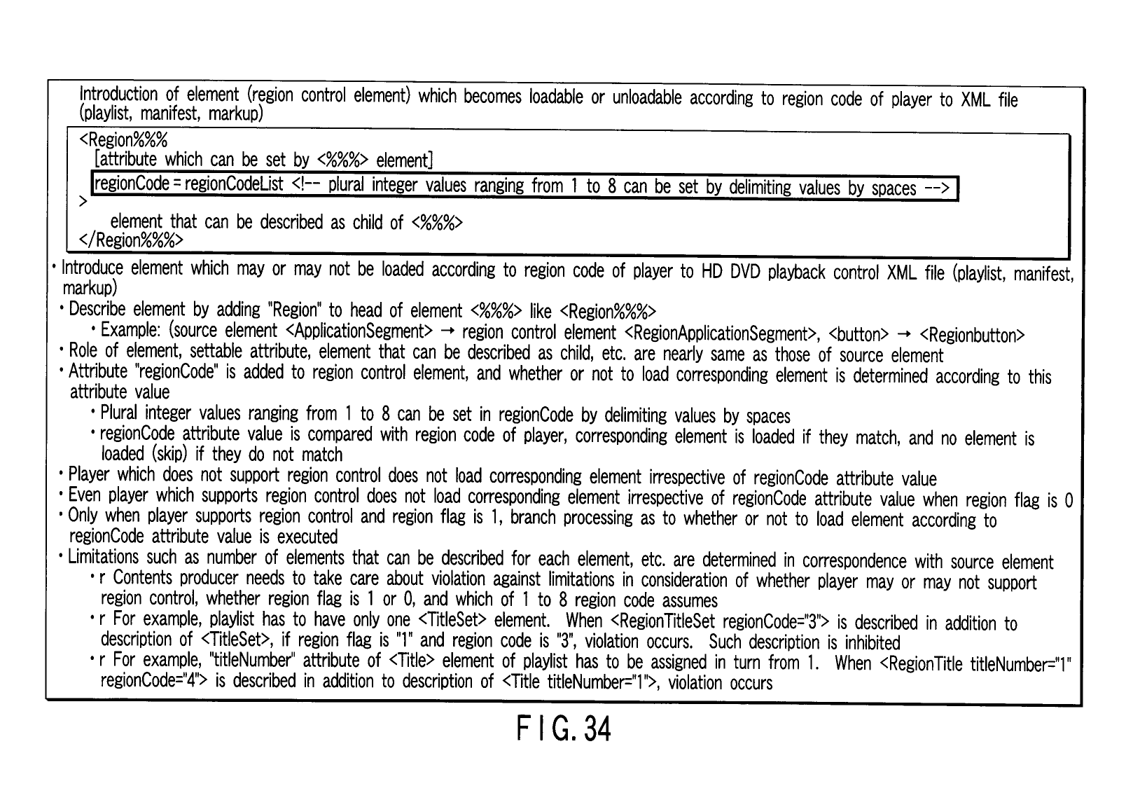

FIGS. 34 to 44 show an example of introduction of an element (region control element) which becomes loadable or unloadable according to the region code of a player to an XML file (playlist, manifest, markup).

An element (region control element), which can be controlled to be loaded or not to be loaded according to the region code of a player, is introduced to each playback control XML file (playlist, manifest, markup) of the HD DVD shown in FIGS. 9 to 17B (FIG. 34). Elements such as <Title>, <ApplicationSegment>, and the like can be described in a playlist. Also, elements such as <Script>, <Resource>, and the like can be described in a manifest. Furthermore, elements such as <button>, <set>, and the like can be described in a markup. The region control element is described by adding “Region” to the head of the name of such element; for example, <RegionTitle> for <Title> and <Regionbutton> for <button>. All of the roles of the elements, settable attributes, describable child elements, and the like conform to the source elements (<Title> in case of <RegionTitle>).

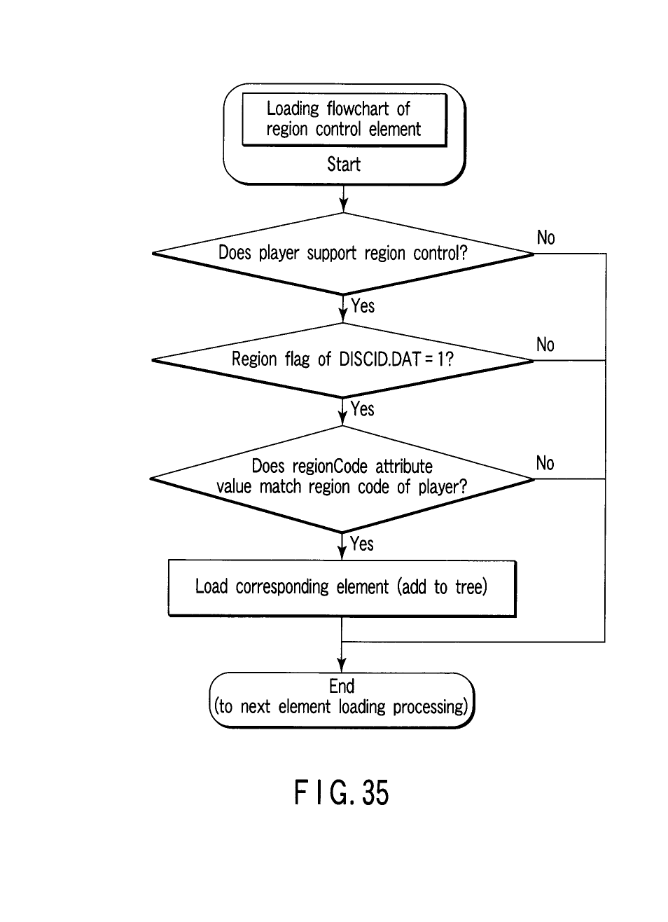

Note that the region control element can be set with an attribute “regionCode” in addition to those of the source element. In the “regionCode” attribute, a plurality of integer values ranging from 1 to 8 can be set by delimiting them by spaces (for example: “3 7 8”). FIG. 35 is a loading flowchart of the region control element.

A player, which does not support region control, does not load that element irrespective of the “regionCode” attribute value.

A player, which supports region control and plays back a content with the region flag “0”, does not load that element irrespective of the “regionCode” attribute value.

A player, which supports region control and plays back a content with the region flag “1”, compares the “regionCode” attribute value with its region code, and loads an element whose “regionCode” attribute value matches the region code or does not load the element if any “regionCode” attribute value does not match the region code (for example: when regionCode=“1 2 3 4”, if the region code of a player is 1, 2, 3, or 4, the player loads that element; if the region code is 5, 6, 7, or 8, the player does not load the element).

When the region control element is loaded, since it is handled as one of source elements, the contents producer need care about the limitations on the number of elements and the like. For example, a playlist has to have only one <TitleSet> element. When <RegionTitleSet regionCode=“3”> is described in addition to the description of <TitleSet>, if the region flag is “1” and the region code is “3”, the number of <TitleSet> elements is two, resulting in a violation. Hence, such description is inhibited. However, this embodiment is not always limited to this inhibition rule, and this inhibition rule is merely one scheme upon management. A “titleNumber” attribute of a <Title> element of a playlist has to be assigned in turn from 1. When <RegionTitle titleNumber=“1” regionCode=“4”> is described in addition to the description of <Title titleNumber=“1”>, if a player with the region code “4” plays back a content with the region code “1”, titleNumber=“1” appears twice, resulting in a violation. Hence, such description is inhibited. However, this embodiment is not always limited to this inhibition rule, and this inhibition rule is merely one scheme upon management.

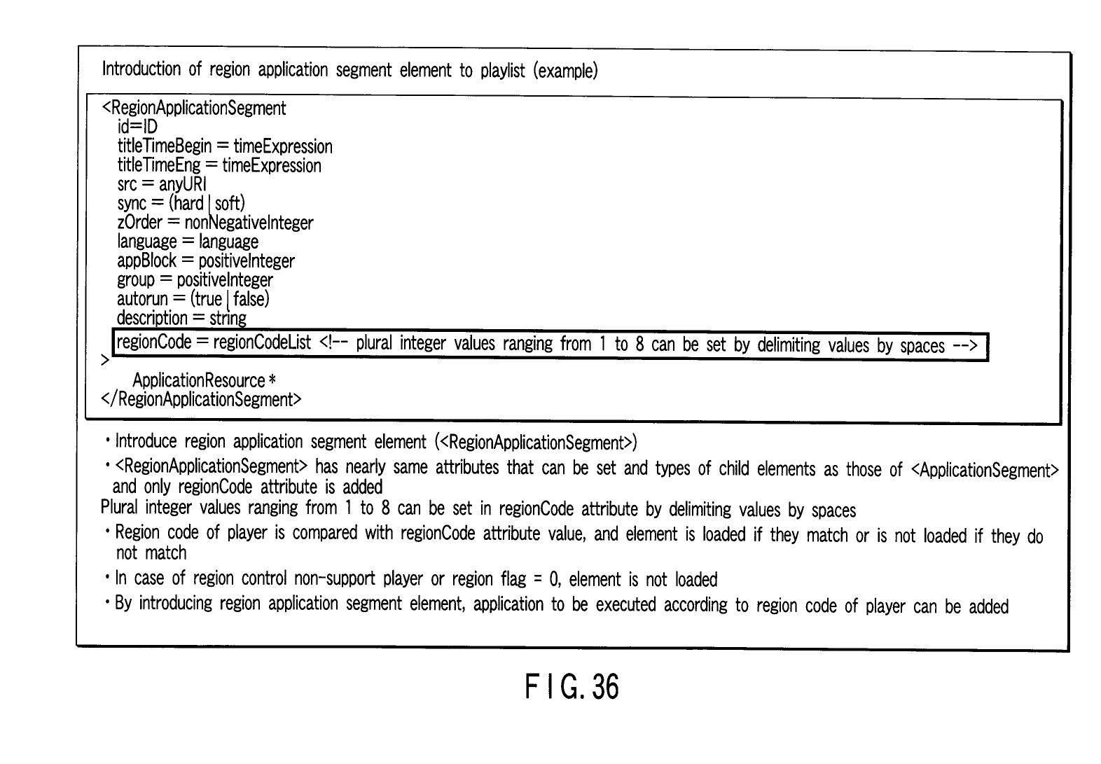

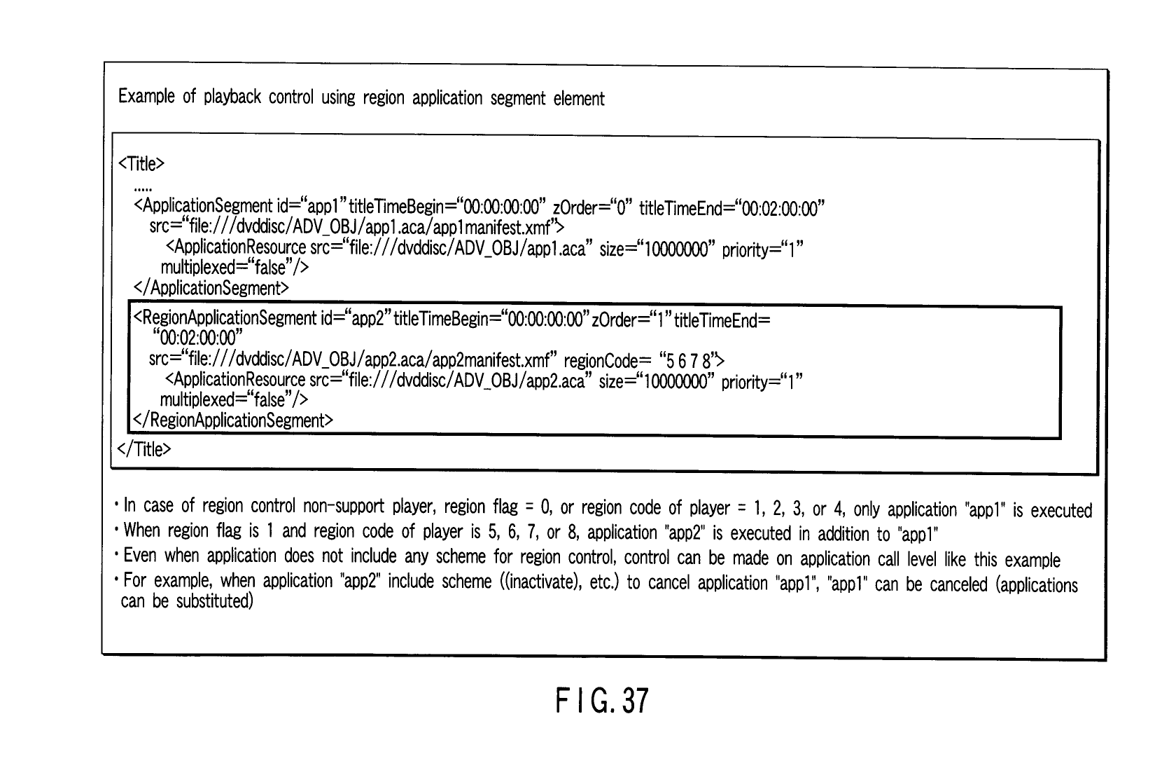

FIGS. 36 and 37 show an example of introduction of a region application segment element to a playlist.

FIG. 36 shows an example of a region application segment element (<RegionApplicationSegment>). <RegionApplicationSegment> can describe the same attributes and child elements as those of the <ApplicationSegment> element, and can also set a “regionCode” attribute. The region application segment element can add an advanced application to be launched when a player has a specific region code.

FIG. 37 shows an example of playback control using the region application segment element. An <ApplicationSegment> element with an ID “app1” and an <RegionApplicationSegment> element with an ID “app2” are set in the same time zone. When a player does not support region control, the region flag is “0”, or the region code of a player is “1”, “2”, “3”, or “4”, only an application “app1” is executed. However, when the region code is “1” and the region code of a player is “5”, “6”, “7”, or “8”, an application “app2” is also executed in addition to app1. Even when an application itself does not include a region control scheme, the control can be made on the application call level like in this example. For example, app2 prepares for a special button which is not included in app1, and that button can be used in only a player with the region code “5”, “6”, “7”, or “8”. When the application “app2” includes a scheme for canceling execution of the application “app1”, substitution of the applications can also be implemented.

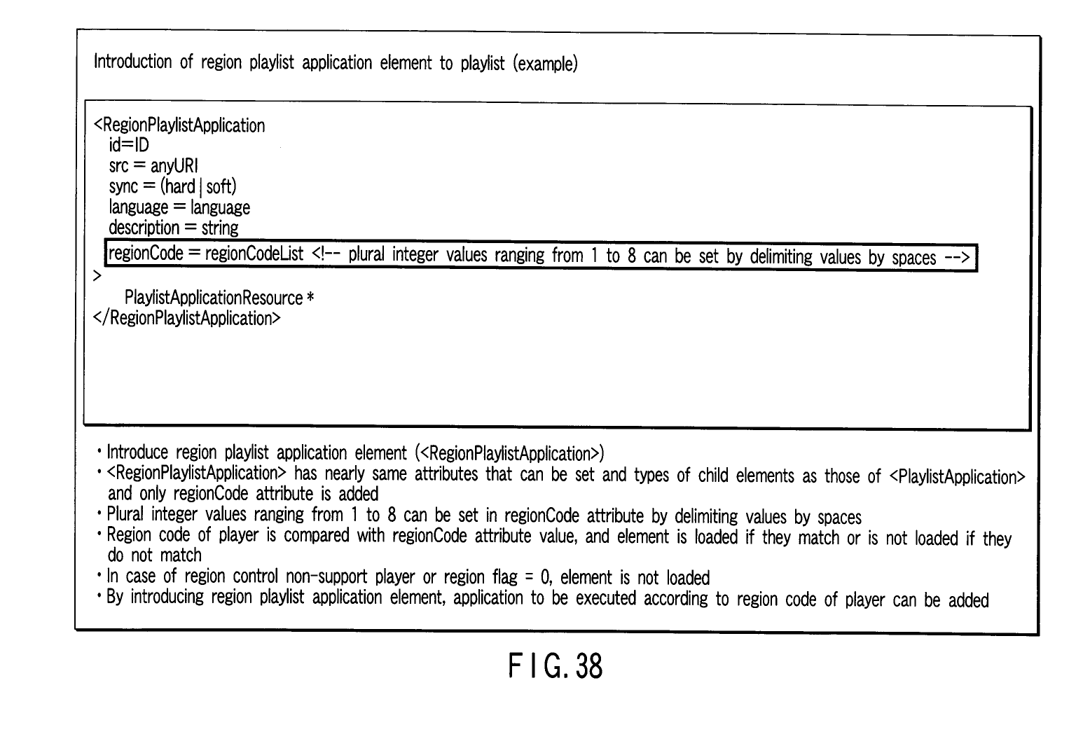

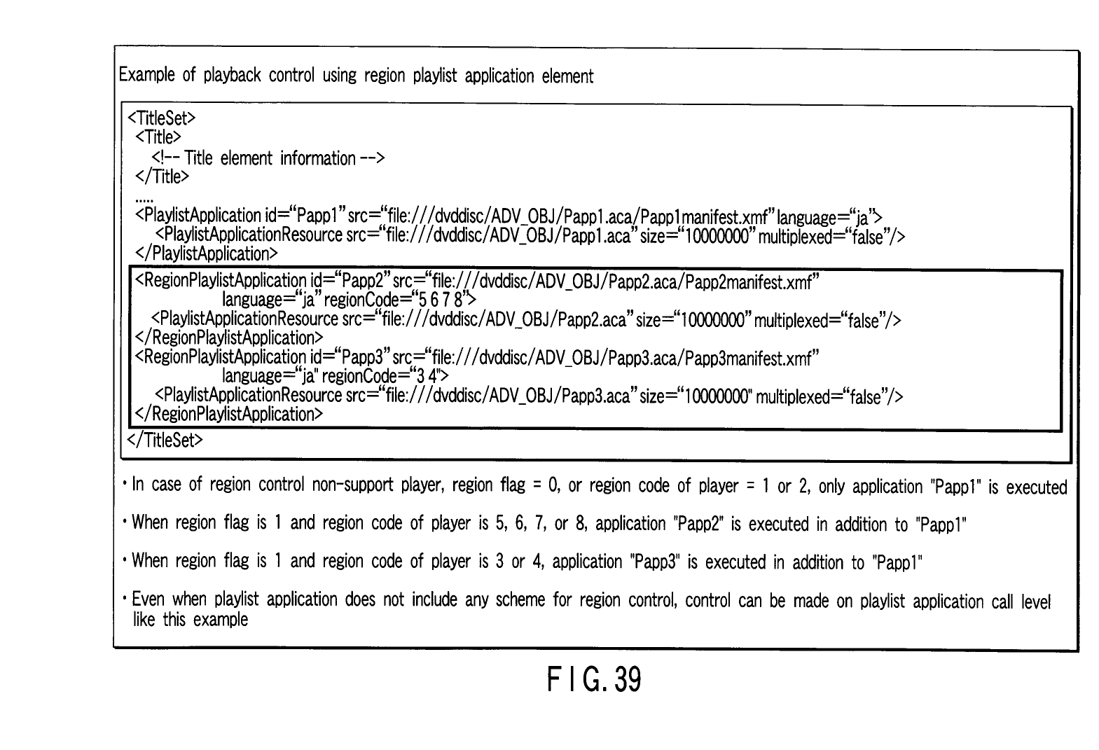

FIGS. 38 and 39 show an example of introduction of a region playlist application element to a playlist.

FIG. 38 shows an example of a region playlist application element (<RegionPlaylistApplication>). <RegionPlaylistApplication> can also be used to add or replace an application based only on the region code as in <RegionApplicationSegment>.

FIG. 39 shows an example of playback control using the region playlist application element. In this example, two <RegionPlaylistApplication> elements with IDs “Papp2” and “Papp3” are described in addition to a <PlaylistApplication> element with an ID “Papp1”. When a player does not support region control, the region flag is “0”, or the region code of a player is “1” or “2”, only a playlist application “Papp1” is executed. When the region flag is “1” and the region code of a player is “5”, “6”, “7”, or “8”, a playlist application “Papp2” is also executed in addition to “Papp1”. When the region flag is “1” and the region code of a player is “3” or “4”, a playlist application “Papp3” is also executed in addition to “Papp1”. Using the region playlist application element, even when the playlist application does not include any scheme for region control, the playback control can be implemented on the playlist application call level.

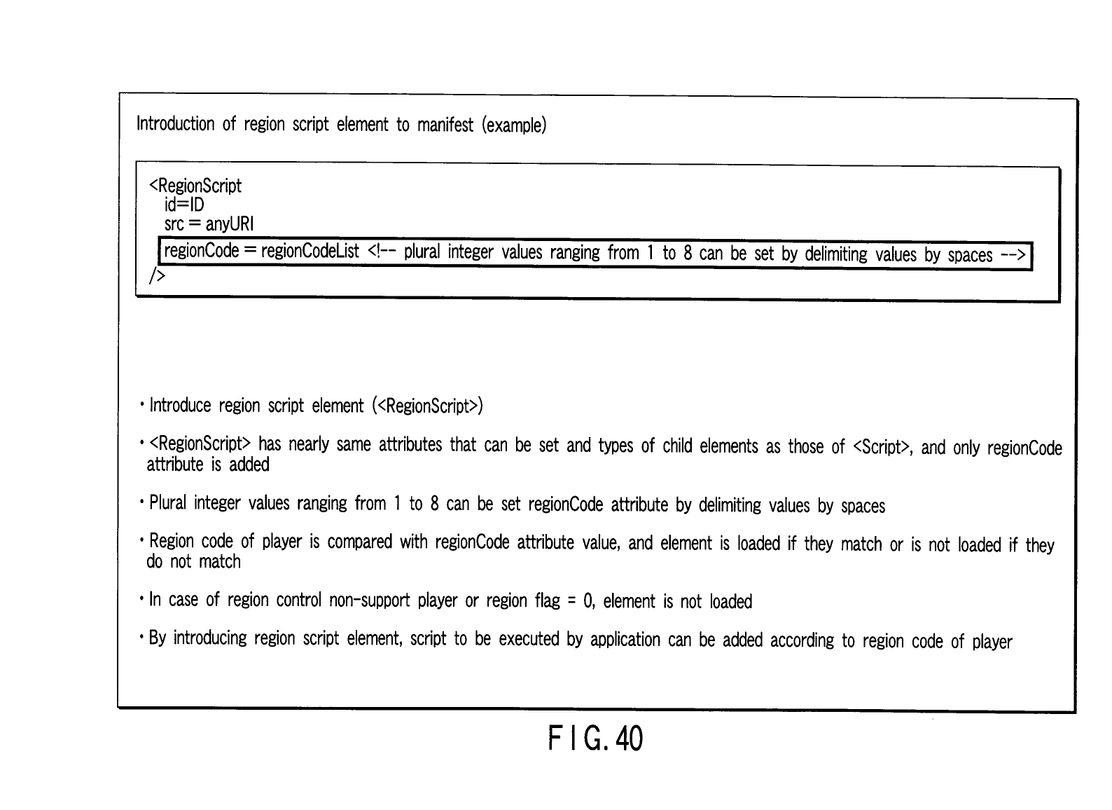

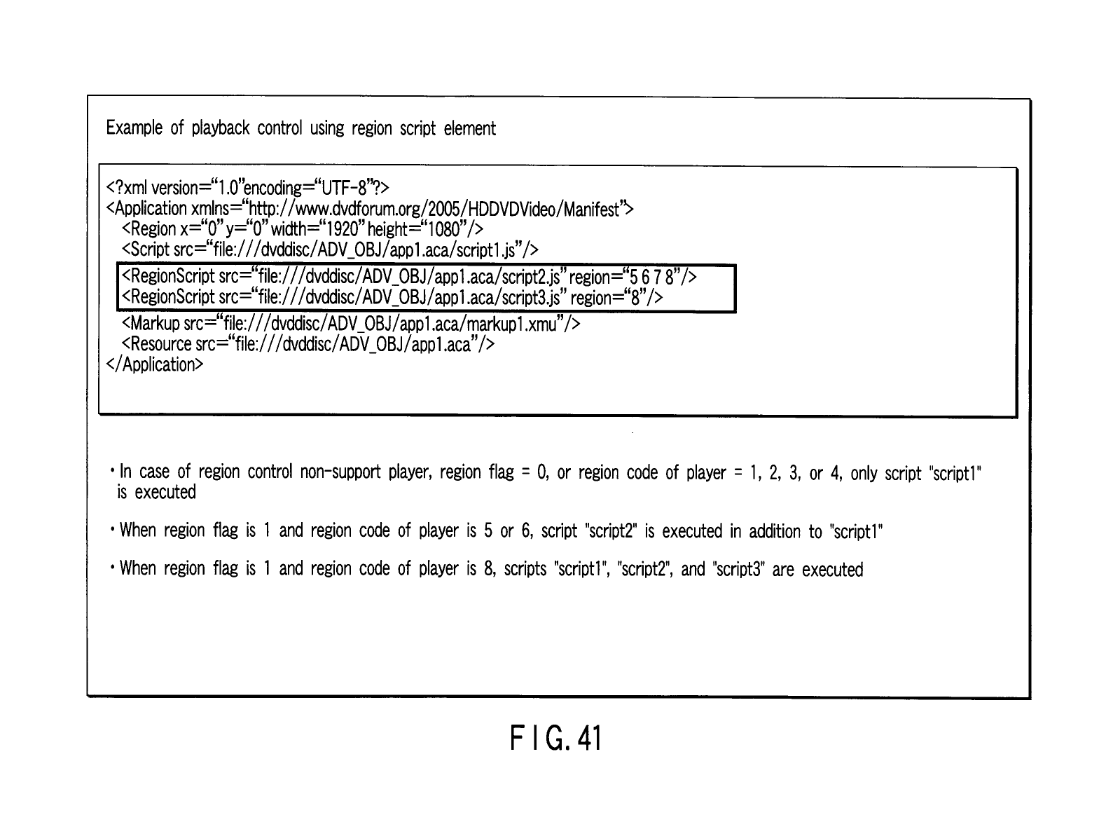

FIGS. 40 and 41 show an example of introduction of a region script element to a manifest. FIG. 40 shows an example of a region script element (<RegionScript>). <RegionScript> is a region control element of a <Script> element of a manifest, and can be used to, e.g., add a script to be executed by an application based only on the region code.

FIG. 41 shows an example of playback control using the region script element. In this example, <RegionScript> elements which respectively refer to script2.js and script3.js are described in addition to <Script> which refers to a file “script1.js”. When a player does not support region control, the region flag is “0”, or the region code of a player is “1”, “2”, “3”, or “4”, only script1.js is executed. When the region flag is “1” and the region code of a player is “5”, “6”, or “7”, a script “script2.js” is also executed in addition to script1.js. When the region flag is “1” and the region code of a player is “8”, script1.js, script2.js, and script3.js are executed. Using the region script element, even when the script does not include any scheme for region control, the playback control can be implemented on the script call level.

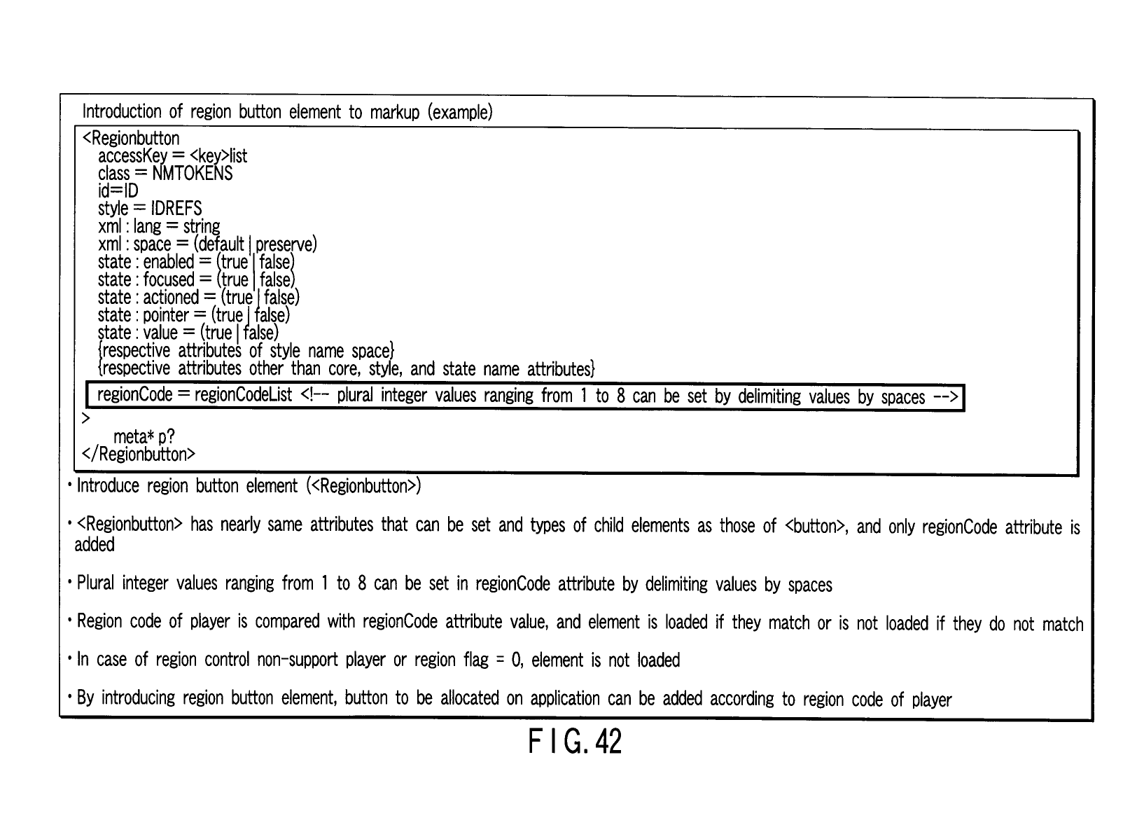

FIGS. 42 to 44 show an example of introduction of a region button element and region cue element to a markup.

FIG. 42 shows an example of a region button element (<Regionbutton>). <Regionbutton> is a region control element of a <button> element of a markup, and can be used to, e.g., add a menu button allocated on a window based only on the region code.

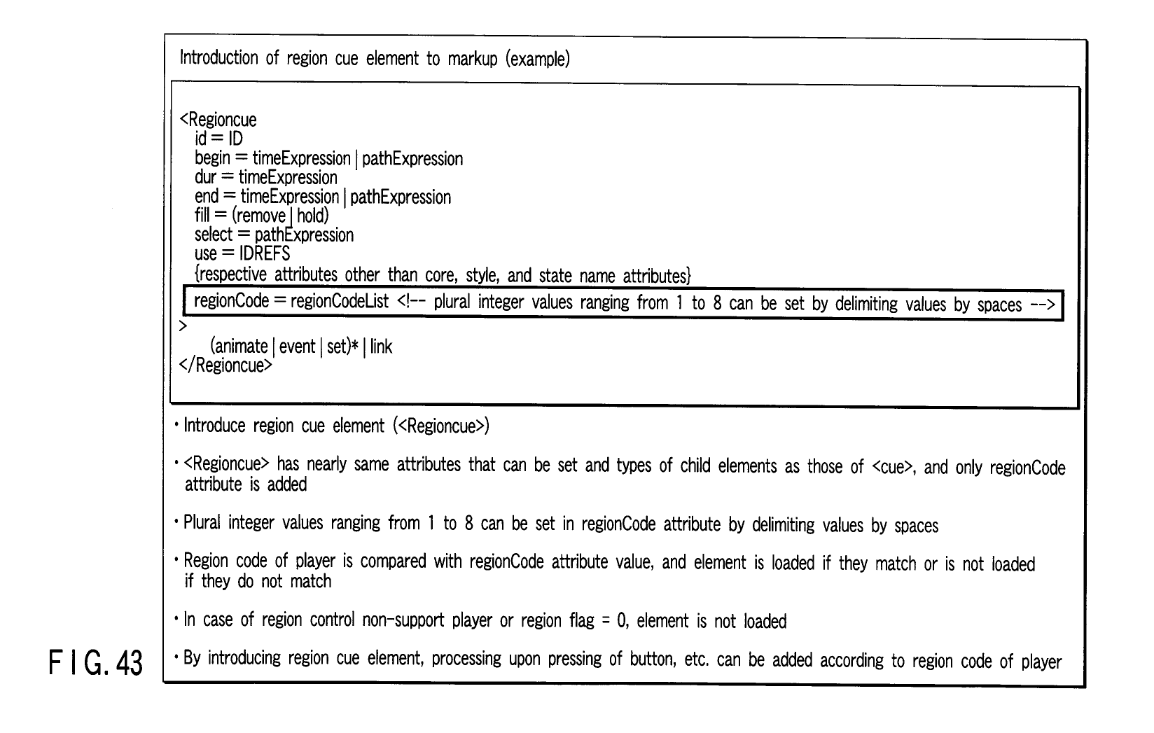

FIG. 43 shows an example of a region cue element (<Regioncue>). <Regioncue> is a region control element of a <button> element of a markup, and can be used to, e.g., add processing upon pressing of a menu button based only on the region code.

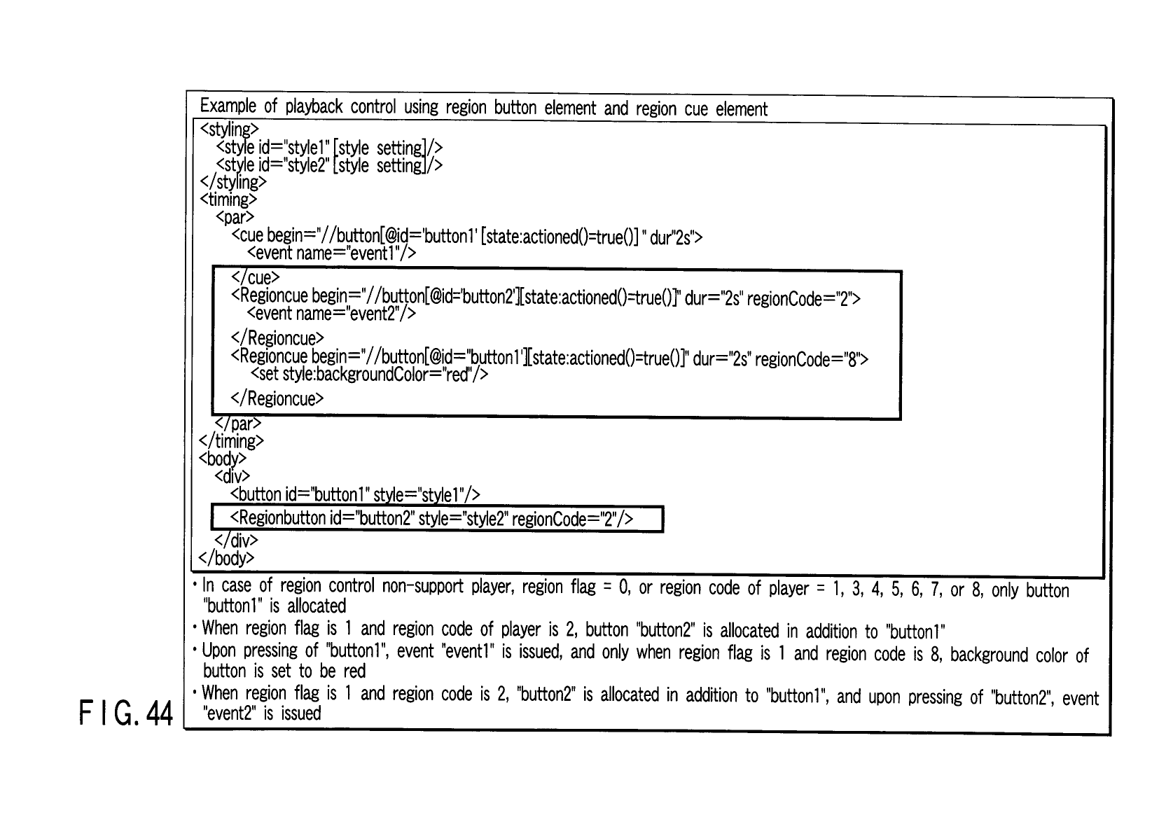

FIG. 44 shows an example of playback control using the region button element and region cue element. In this example, <Regionbutton> with an ID “button2” is described in addition to <button> with an ID “button1”. Also, in a field that describes processing upon pressing of a button or the like, two <Regioncue> elements are described in addition to <cue>. When a player does not support region control, the region flag is “0”, or the region code of a player is “1”, “3”, “4”, “5”, “6”, “7”, and “8”, only a button “button1” is allocated on the window. Upon pressing “button1”, the start condition of <cue> is met, and an event “event1” is issued. When the region flag is “1” and the region code of a player is “2”, a button “button2” is also allocated on the window in addition to “button1”. Upon pressing “button1”, since the start condition of <cue> and the second start condition of <Regioncue> are satisfied, “event1” is issued, and a red background color is set. Upon pressing of “button2”, since the first start condition of “Regioncue” is satisfied, an event “event2” is issued. In this way, using the region button and region cue elements, a menu button can be added, and behaviors upon pressing of the button can be added in a player with a specific region code. By adding, e.g., an event to be issued upon pressing of the button, even when the script does not include any scheme for region control, the playback control of a script based on the region code can be indirectly executed by assuring a function of handling that event.

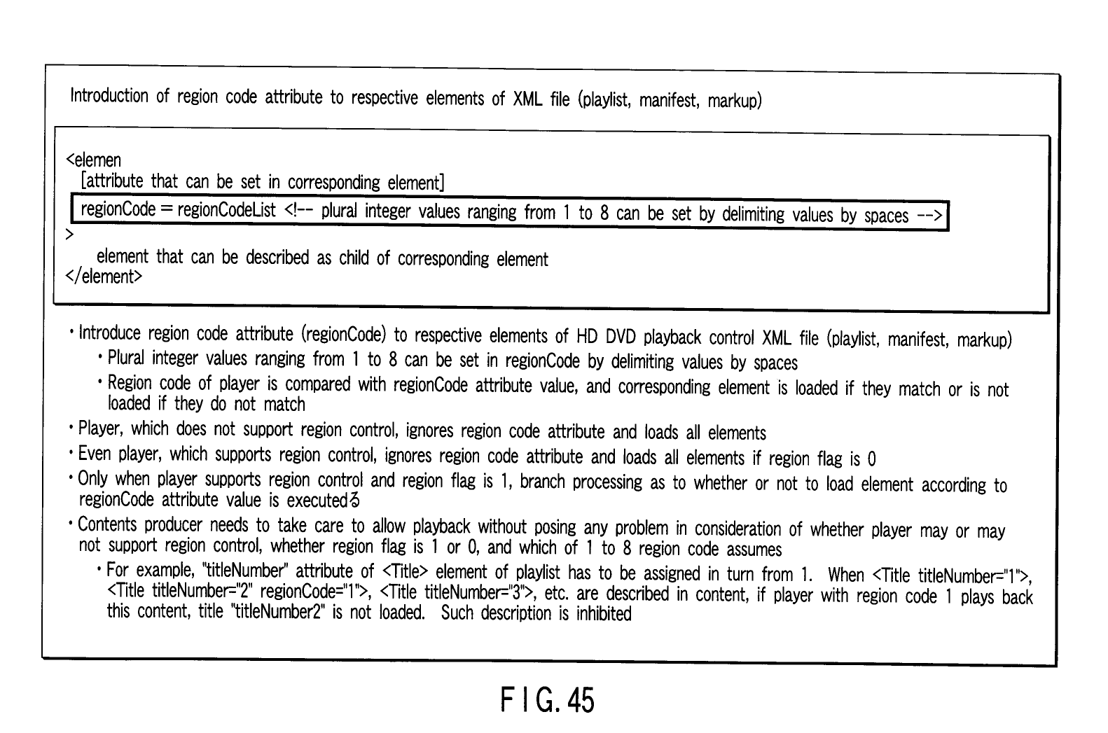

FIGS. 45 to 49 show an example of introduction of a region code attribute to respective elements of XML files (playlist, manifest, markup).

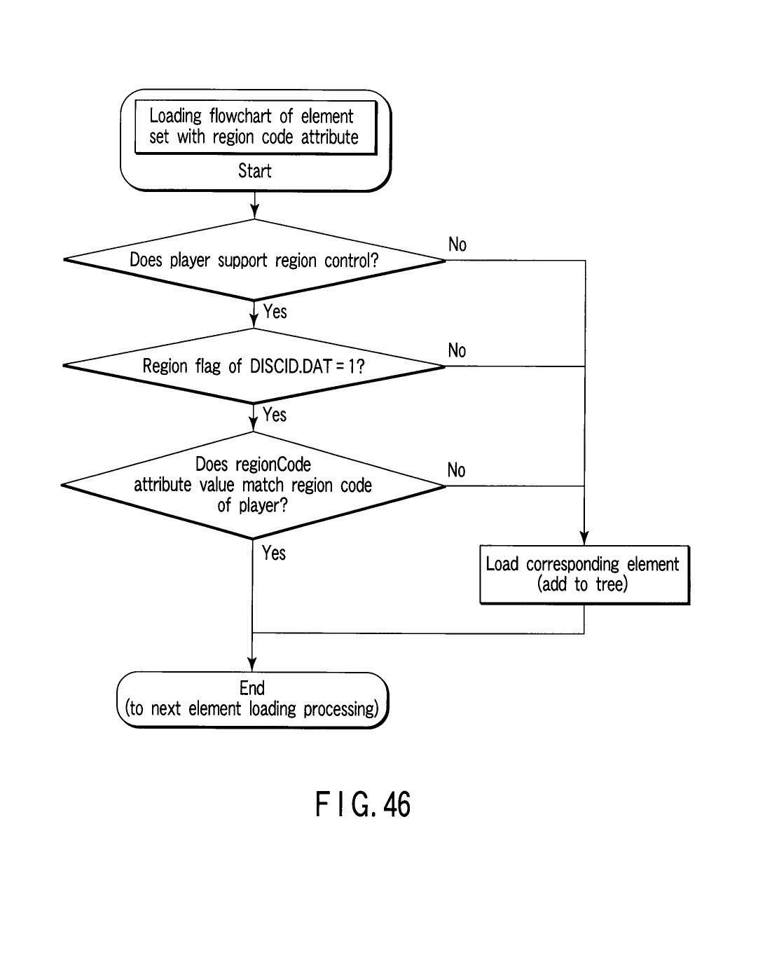

As shown in FIG. 45, a region code attribute (regionCode) is introduced to respective elements of playback control XML files (playlist, manifest, markup) of the HD DVD. As regionCode, a plurality of integer values ranging from 1 to 8 can be set by delimiting them by spaces. The region code attribute can be used to impose limitations (e.g., elements set with the region code attribute are not loaded) when a player with a specific region code plays back a content. FIG. 46 is a loading flowchart of an element set with the region code attribute.

When a player does not support region control, it ignores the region code attribute.

Even when a player supports the region control, if the region flag is “0”, the region code attribute is ignored.

Only when a player supports a region code, and the region flag is “1”, the player compares the region code attribute value with its region code. If the region code attribute value set in elements matches the region code, the player does not load these elements; otherwise, the it loads these elements.

However, the contents producer has to consider that such elements are not loaded depending on the region code. For example, a “titleNumber” attribute of a <Title> element of a playlist has to be assigned in turn from 1. If the contents producer describes <Title titleNumber=“1”>, <Title titleNumber=“2” regionCode=“1”>, <Title titleNumber=“3”>, and the like in a content, if he or she plays back that content using a player with the region code “1”, a title “titleNumber2” is not loaded. Hence, such description is inhibited. However, this embodiment is not always limited to this inhibition rule, and this inhibition rule is merely one scheme upon management.

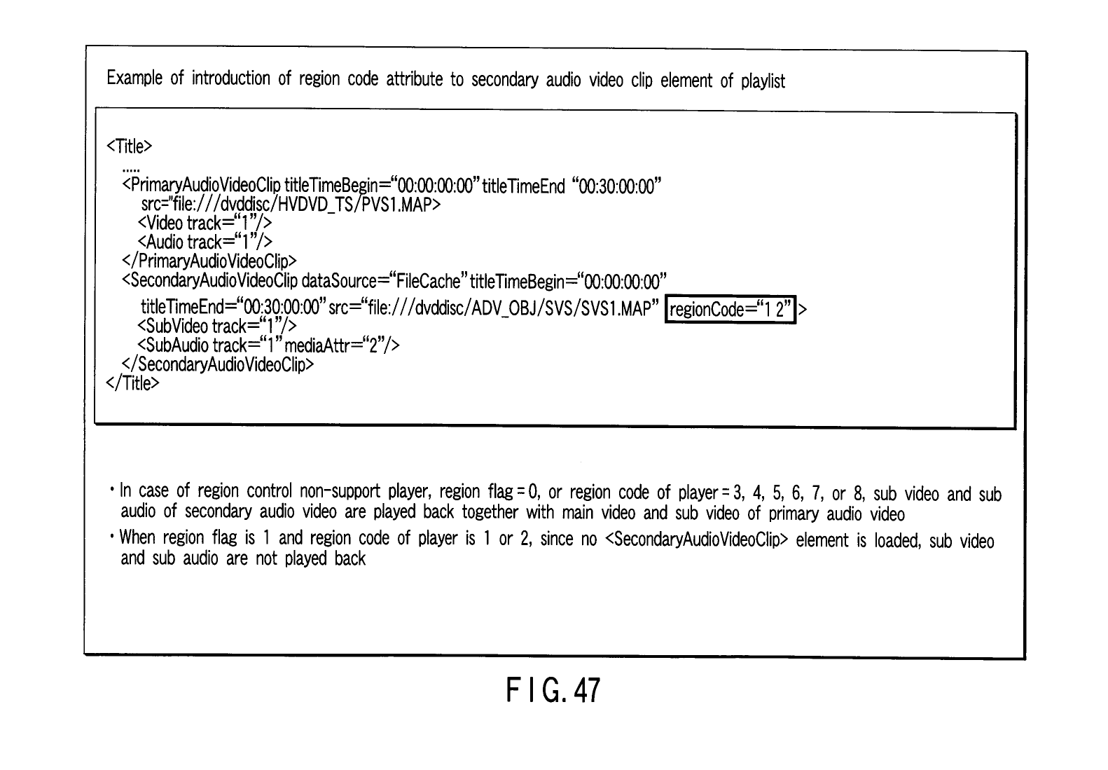

FIG. 47 shows an example of introduction of a region code attribute to a secondary audio video clip element of a playlist. That is, FIG. 47 shows an example in which the region code attribute is introduced to a secondary audio video clip element (<SecondaryAudioVideoClip>) and is used in playback control.

In the description of this example, a sub video and sub audio of <SecondaryAudioVideoClip> are simultaneously played back in addition to a main video and main audio of a primary audio video clip (<PrimaryAudioVideoClip>). However, since <SecondaryAudioVideoClip> is set with regionCode=“1 2”, when the region flag is “1” and the region code of a player is “1” or “2”, <SecondaryAudioVideoClip> is not loaded and the sub video and sub audio are not played back. In this way, by introducing the region code attribute to the secondary audio video clip element, playback of the sub video and sub audio can be limited.

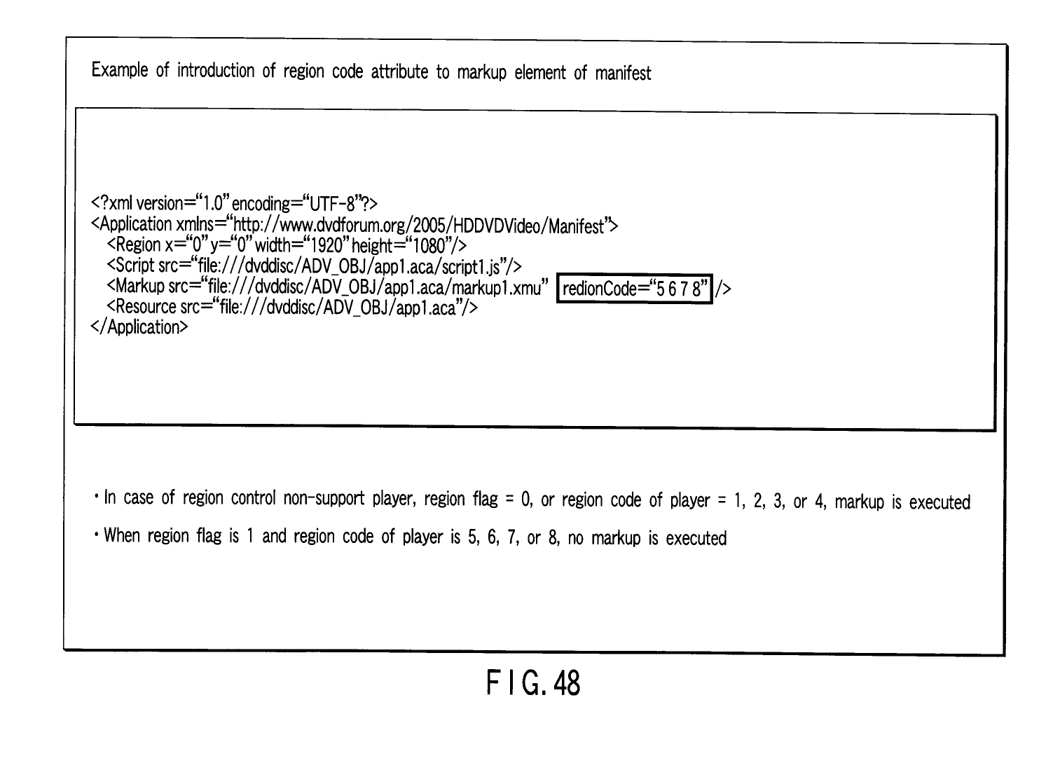

FIG. 48 shows an example of introduction of the region code attribute to a markup element of a manifest. That is, as shown in FIG. 48, the region code attribute is introduced to a markup element (<Markup>) of a manifest and is used in playback control.

In this example, a script “script1.js” and a markup “markup1.xmu” are executed as applications. However, since <Markup> is set with regionCode=“5 6 7 8”, when the region flag is “1” and the region code of a player is “5”, “6”, “7”, or “8”, the <Markup> element is not loaded, and that markup is not executed. In this way, by introducing the region code attribute to the markup element, a limitation can be imposed when, for example, a button set by the markup is not to be played back by a player with a specific region code.

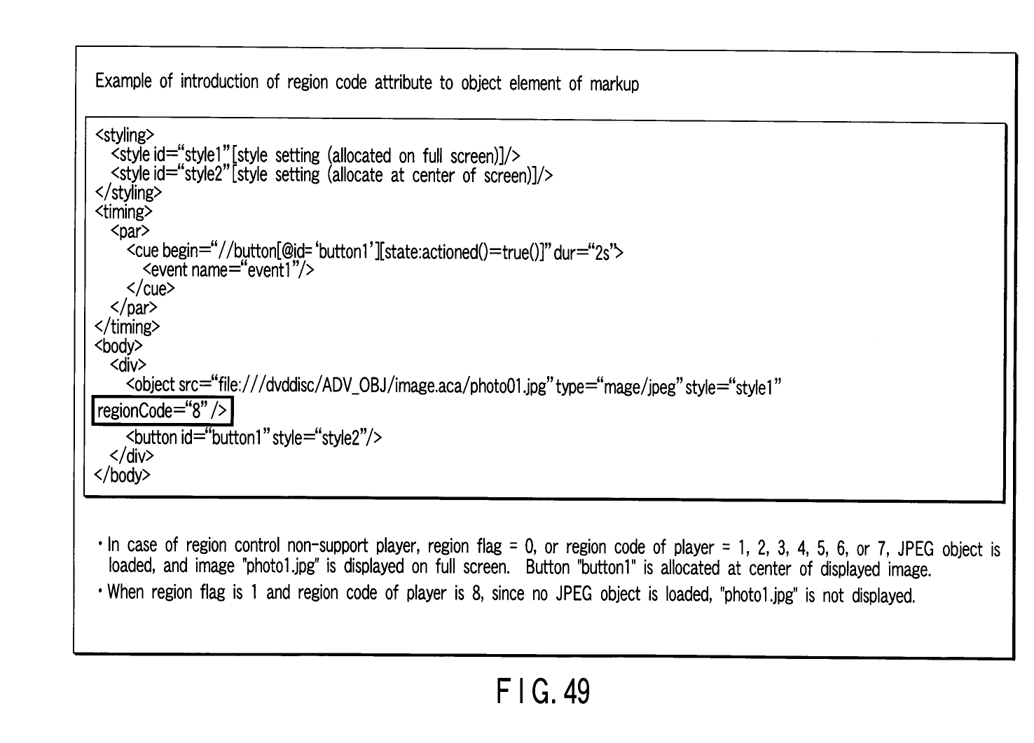

FIG. 49 shows an example of introduction of the region code attribute to an object element of a markup. That is, as shown in FIG. 49, the region code attribute is introduced to an object element (<object>) of a markup and is used in playback control.

In this example, a button with an ID “button1” is allocated at the center of a window to have a still image “photo01.jpg” pasted on the full window as a background. However, since <object> is set with regionCode=“8”, when the region flag is “1” and the region code of a player is “8”, the still image object is not loaded, and “photo01.jpg” is not displayed. In this way, by introducing the region code attribute to the object element, a limitation can be imposed so that a player with a specific region code is inhibited from displaying an image.

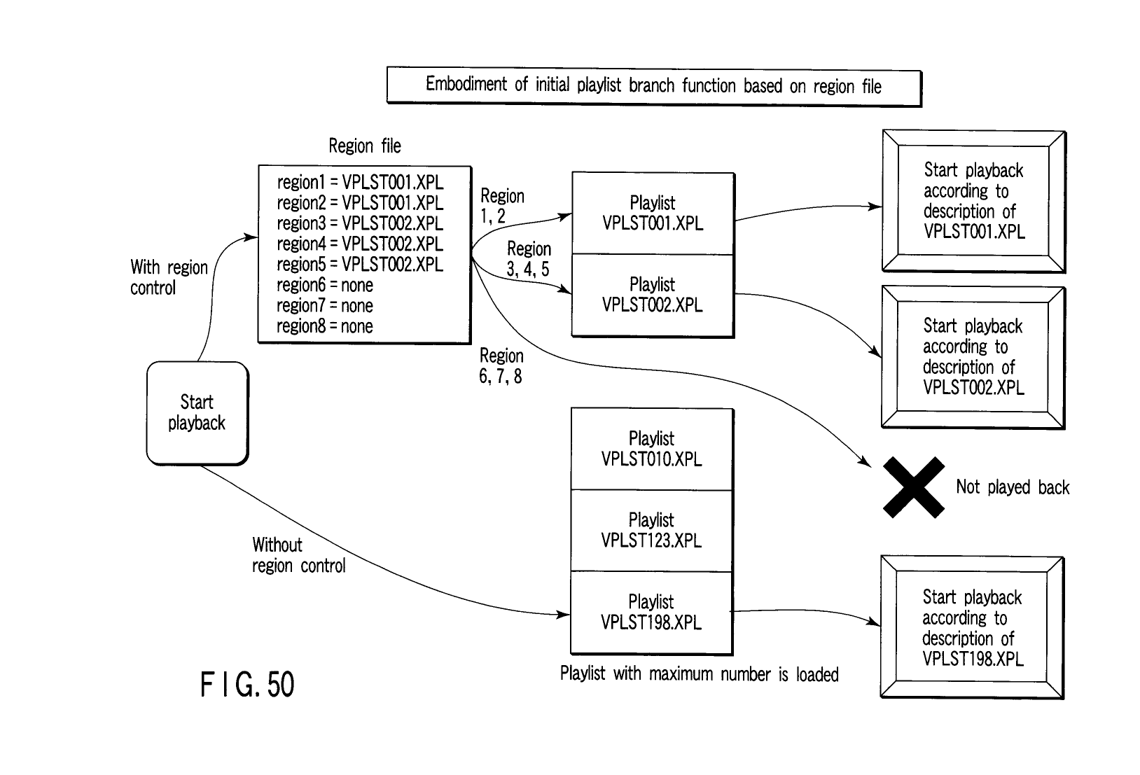

FIG. 50 shows an example of an initial playlist branch function based on a region file.

Assume that five playlists VPLST001.XPL, VPLST002.XPL, VPLST010.XPL, VPLST123.XPL, and VPLST198.XPL are present on a disc or persistent storage. When a player supports region control and the region flag is “1”, the region file is loaded, and VPLST001.XPL is loaded as an initial playlist for region “1” or “2” or VPLST002.XPL for region “3”, “4”, or “5”, according to the description of the region file. In case of region “6”, “7”, or “8”, since “none” is described in the region file, playback is not executed. On the other hand, when a player does not support region control or when the region flag is “0”, since a playlist with a maximum number of these playlists is loaded as an initial playlist, VPLST198.XPL is loaded in this embodiment. After the initial playlist is determined, playback according to that playlist then starts.

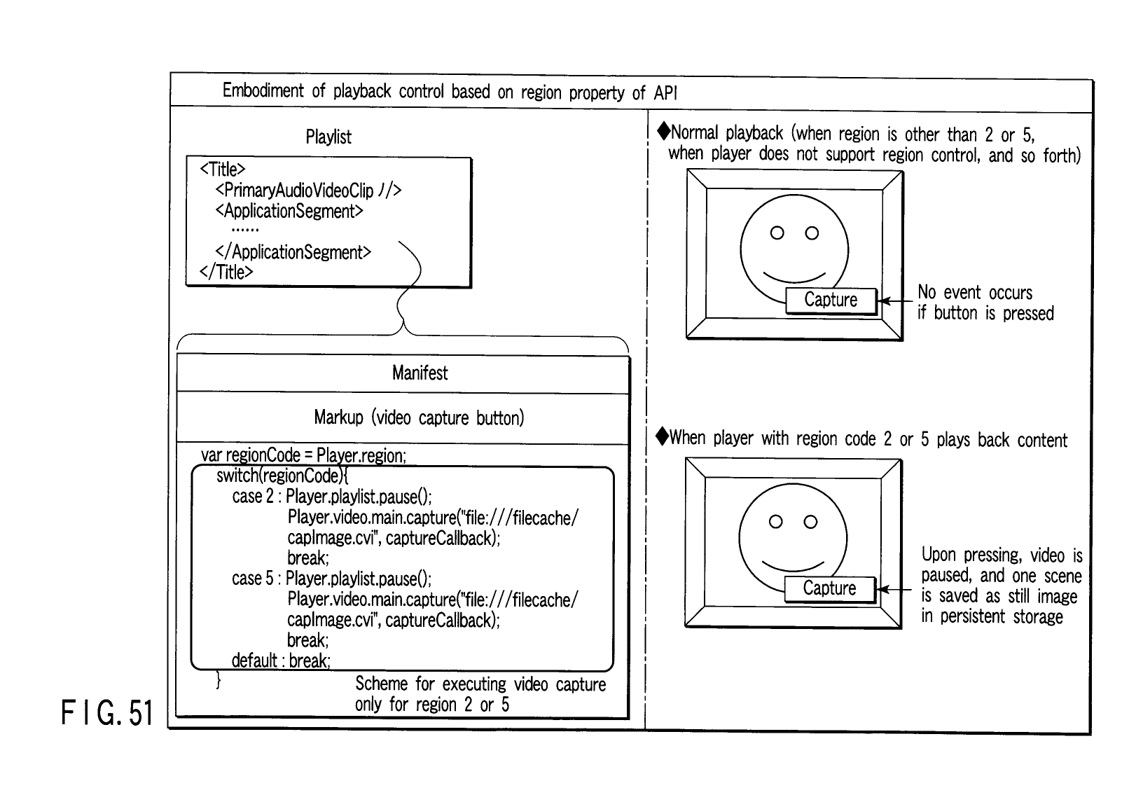

FIG. 51 shows an example of playback control using a region property of an API.

When a markup includes a description for setting a video capture button, and a script includes a description for enabling that button (to execute video capture) only when the region code of a player is “2” or “5”, no event is issued in normal playback (when the region is other than “2” or “5”, when a player does not support region control, or the like) even when the user presses the capture button. When a player with the region code “2” or “5” plays back that content, if the user presses the capture button, playback is paused and one scene is saved in the persistent storage as a still image.

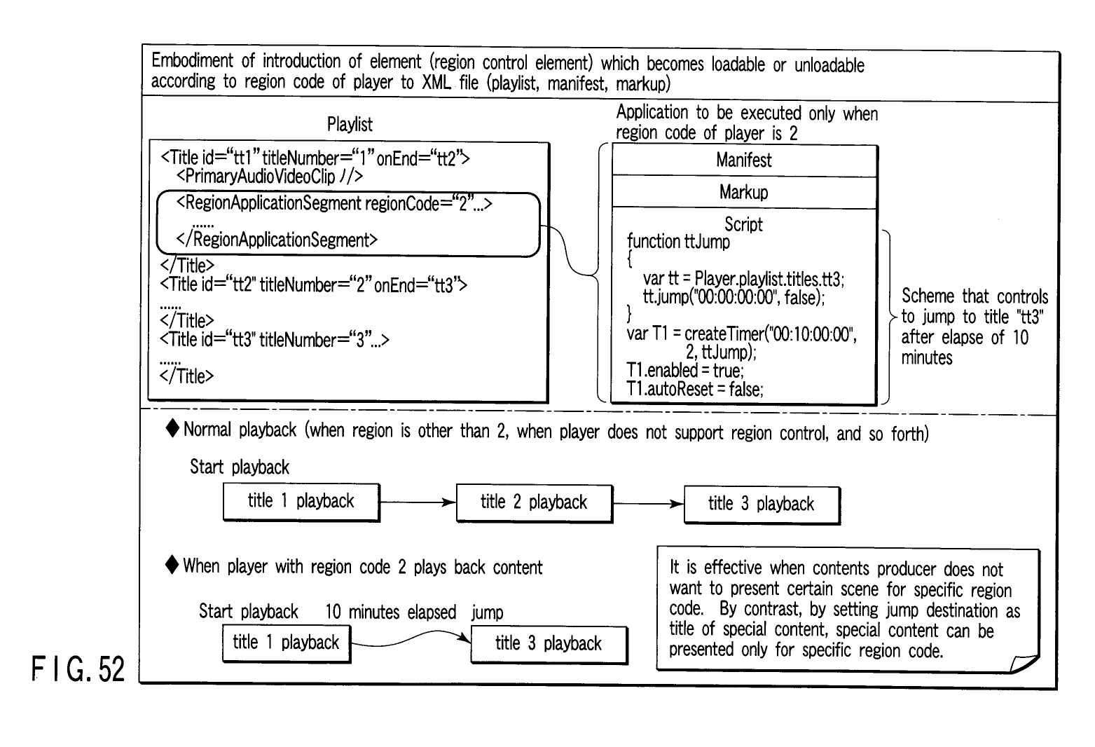

FIGS. 52 to 55 show an example of introduction of an element (region control element), which becomes loadable or unloadable in accordance with the region code of a player, to XML files (playlist, manifest, markup).

FIG. 52 shows an example when a <RegionApplicationSegment> element is introduced to a playlist. A <RegionApplicationSegment> element is set with regionCode=“2”, and that application includes a scheme that controls to jump to a title “tt3” after an elapse of 10 minutes. In normal playback (when the region is other than “2”, when a player does not support region control, or the like), playback progresses, from its beginning, like title 1 playback→title 2 playback→title 3 playback. By contrast, when a player with the region code “2” plays back this content, since a title jump to “tt3”, which is set by a timer of a script, is made after title 1 is played back for 10 minutes, title 3 playback starts.

This setting is effective when the contents producer does not want to present a certain scene for a specific region code. By contrast, since a jump destination is set as a title of a special content, the special content can be presented only for a specific region code.

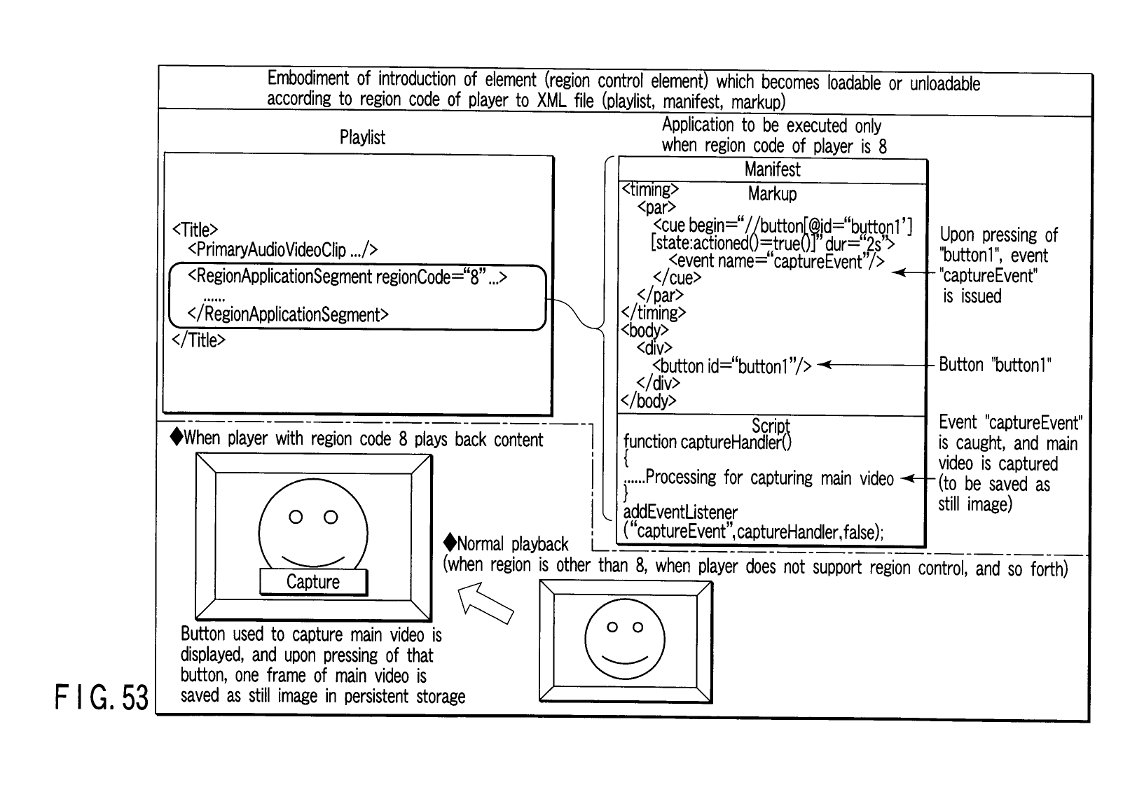

FIG. 53 shows an example of introduction of the <RegionApplicationSegment> element to a playlist. The <RegionApplicationSegment> element is set with regionCode=“8”. This application includes a description for allocating a button “button1” to a markup and a description for issuing an event “captureEvent” upon pressing of the button “button1”. A script includes a scheme that catches the “captureEvent” event to capture a main video. In this case, in normal playback (when the region is other than “8”, when a player does not support region control, or the like), normal video playback is done. Only when a player with the region code “8” plays back this content, the capture button (“button1” of a markup) appears, and when the user presses that button, one scene of a video can be saved in the persistent storage as a still image.

In this manner, in case of only a specific region code, a button or the like appears, and a special function can be used.

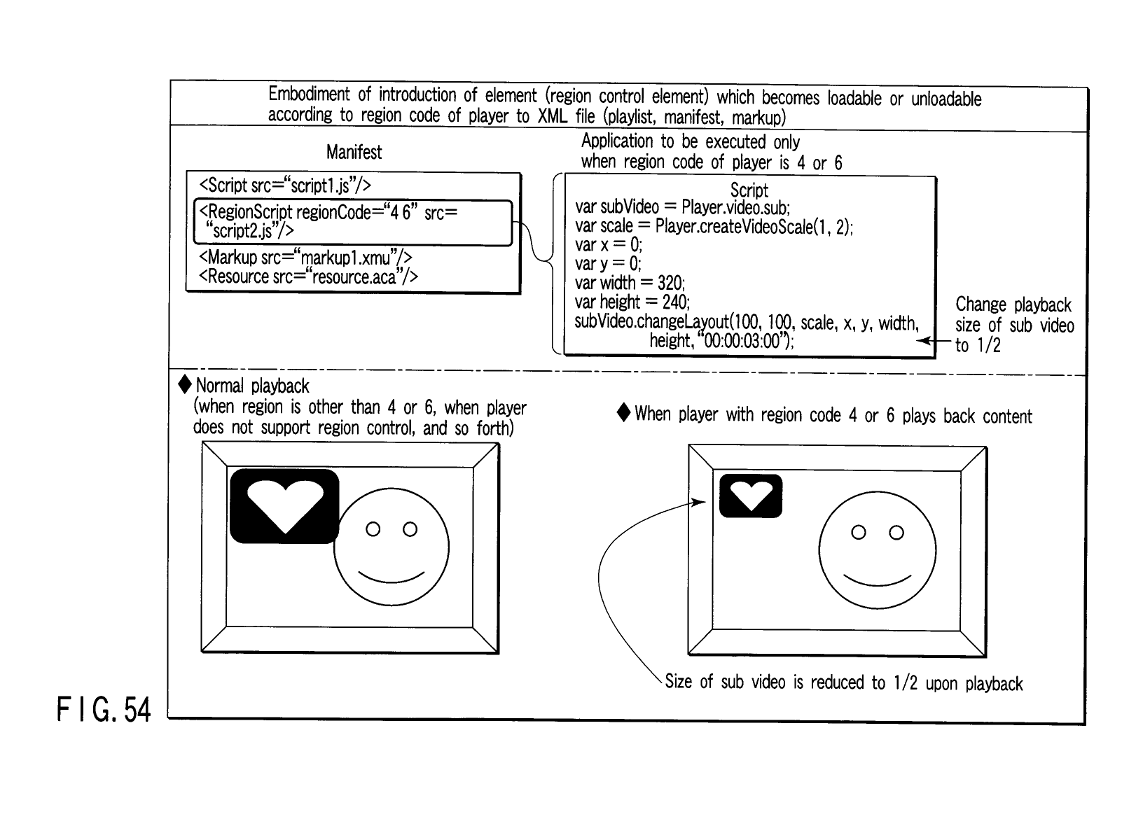

FIG. 54 shows an example when <RegionScript> is introduced to a manifest. <RegionScript> is set with regionCode=“4 6”. This script includes a scheme for changing the playback size of a sub video to ½. At this time, the playback size of the sub video in normal playback (when the region is other than “4” or “6”, when a player does not support region control, or the like) is reduced to ½ upon playback when a player with the region code “4” or “6” plays back that content.

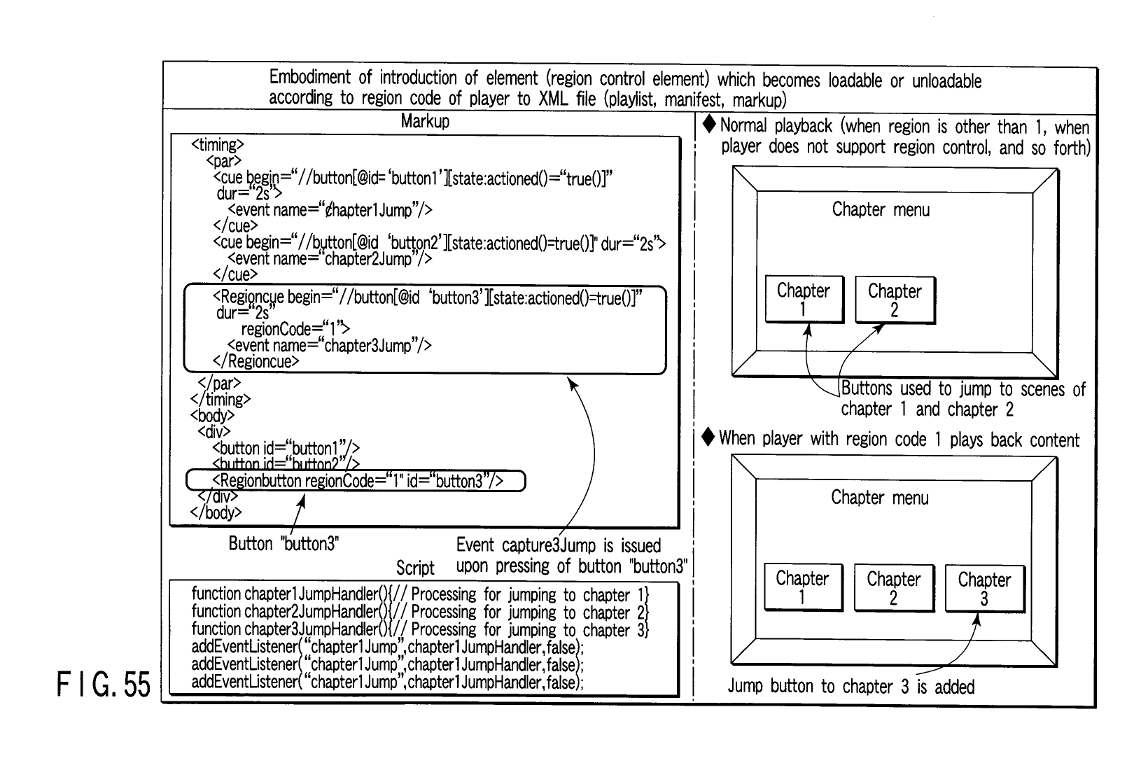

FIG. 55 shows an example of introduction of <Regionbutton> and <Regioncue> to a markup. In case of normal playback (when the region is other than “1”, when a player does not support region control, or the like), two buttons used to jump to chapter 1 and chapter 2 are displayed. When a player with the region code “1” plays back this content, a jump button to chapter 3 is also displayed. In this manner, by introducing <Regionbutton> and <Regioncue> to the markup for a menu window used to select a scene whose playback is to start, only when the user plays back that content using a player with a specific region code, he or she can view a special chapter (scene).

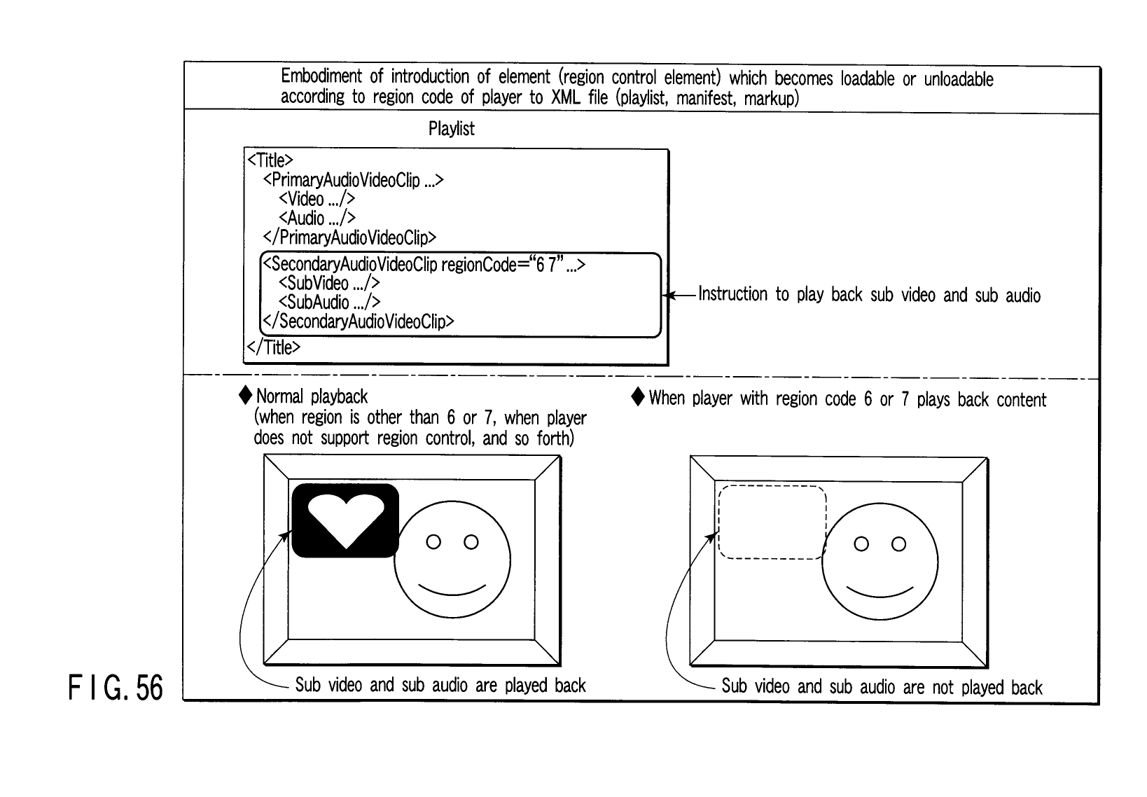

FIGS. 56 to 58 show an example of introduction of the region code attribute to respective elements of XML files (playlist, manifest, markup).

FIG. 56 shows an example when the regionCode attribute is introduced to <SecondaryAudioVideoClip> of a playlist. For example, regionCode=“6 7” is set. At this time, in normal playback (when the region is other than “6” or “7”, when a player does not support region control, or the like), a sub video and sub audio are played back in addition to a main video and main audio. When a player with the region code “6” or “7” plays back this content, since <SecondaryAudioVideoClip> is not loaded, the sub video and sub audio are not played back (only the main video and main audio are played back). When the substance of the sub video and sub audio is incompatible with the moral of a specific region or when the sub video and sub audio are not to be played back in terms of rights of the content, a scheme that imposes such limitation is effective.

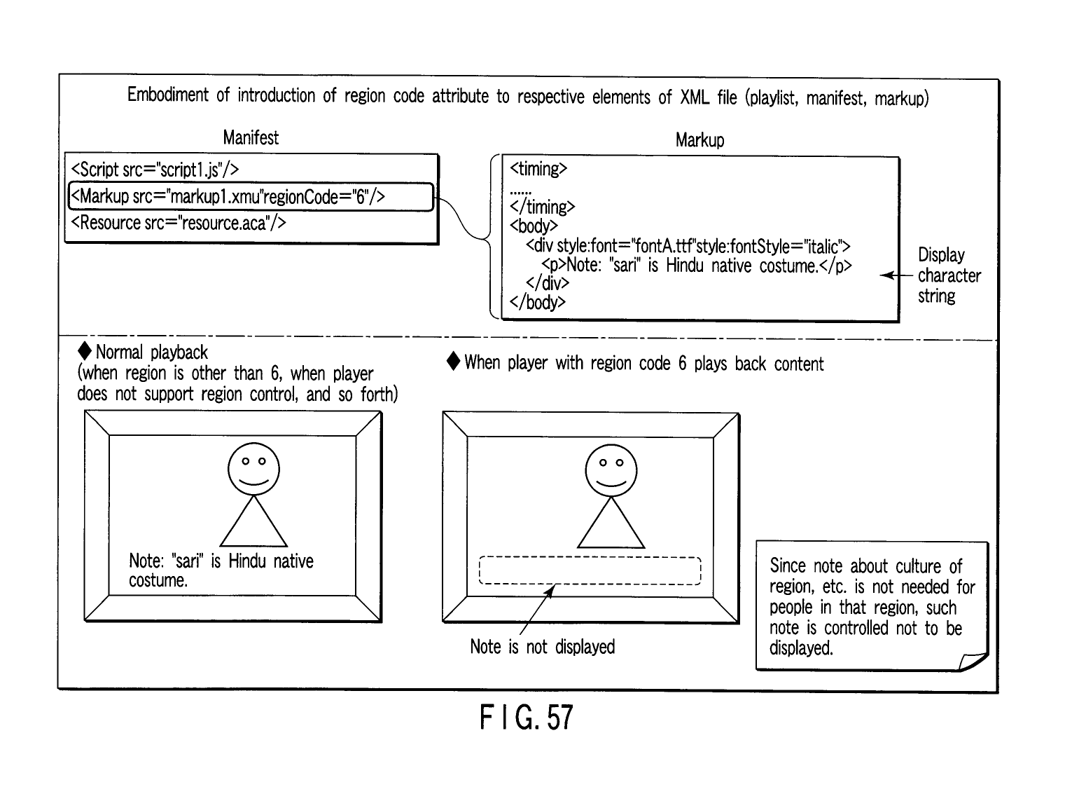

FIG. 57 shows an example when the regionCode attribute is introduced to a <Markup> element of a manifest. regionCode=“6” is set, and the markup includes a scheme for displaying a character string [note: “sari” is Hindu native costume.] on a window. At this time, in normal playback (when the region is other than “6”, when a player does not support region control, or the like), a telop [note: “sari” is Hindu native costume.] is displayed. However, upon playback using a player with the region code “6”, this telop is not displayed. In this way, since a comment about the culture of a certain region is not needed for people in that region, such comment is not displayed for only a specific region.

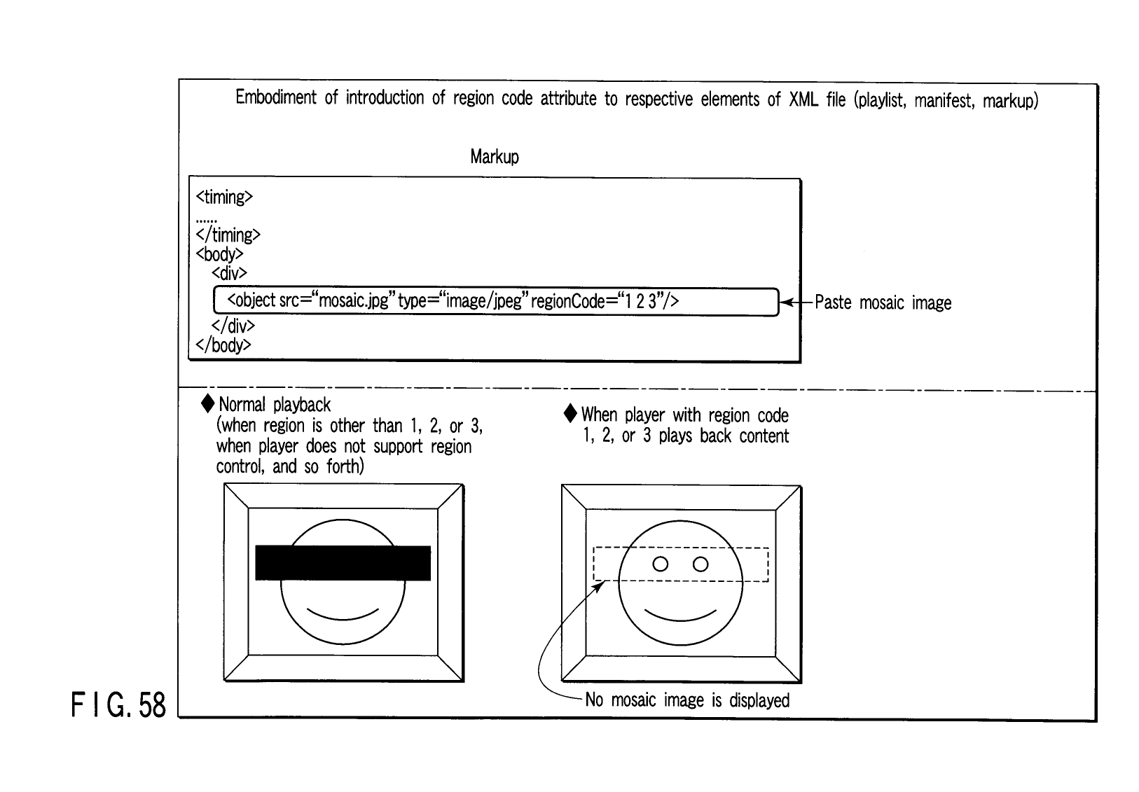

FIG. 58 shows an example when regionCode=“1 2 3” is set for an <object> element of a markup. This object includes a description for displaying a mosaic image “mosaic.jpg”. At this time, in normal playback (when the region is other than “1”, “2”, or “3”, when a player does not support region control, or the like), an image like a mosaic is displayed on a part of a video. When a player with the region code “1”, “2”, or “3” plays back this content, no mosaic image is displayed. In this way, the region code attribute is effective for a case wherein a mosaic need not be displayed in a specific region.

As described above, by introducing the playback control function based on a region code to the HD DVD, more advanced playback control can be implemented in place of the two-branch control, i.e., “to play back” and “not to play back”. The invention also assures compatibility with a player which does not support playback control based on a region code. A player which does not support region control can play back a content including a scheme for region control without posing any problem (of course, when the contents producer wants to inhibit playback using a player which does not support region control, he or she can produce such content). In addition, by introducing a flag used to enable or disable the region control, two types of contents with and without region control can be easily produced.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modification as would fall within the scope and spirit of the inventions.

What is claimed is:

1. An information storage medium comprising:
a first area which stores playback control information used to control playback of contents; and
a second area which stores a region flag indicating whether to enable or disable playback control based on a region code held in a playback apparatus.

2. The medium according to claim 1, which further comprises a third area which stores a region file that associates the region code with position information indicating a storage position of initial playback control information to be loaded first in response to acquisition of the region code.

3. The medium according to claim 1, wherein a script included in the playback control information includes a region property which associates the region code with a property that is enabled in response to acquisition of the region code.

4. The medium according to claim 1, wherein an XML included in the playback control information includes the region code and an element used to control playback in response to acquisition of the region code.

5. The medium according to claim 1, wherein an XML included in the playback control information includes the region code and an attribute used to control playback in response to acquisition of the region code.

6. An information playback apparatus comprising:
a storage unit configured to store a region code;
a read unit configured to read data from an information storage medium comprising a first area which stores playback control information used to control playback of contents, and a second area which stores a region flag indicating whether to enable or disable playback control based on the region code; and
a playback unit configured to play back information based on the region code stored in the storage unit in response to reading of the region flag which enables the playback control based on the region code.

7. The apparatus according to claim 6, wherein the information storage medium further comprises a third area which stores a region file that associates the region code with position information indicating a storage position of initial playback control information to be loaded first in response to acquisition of the region code, and
the playback unit plays back information based on the region file.

8. The apparatus according to claim 6, wherein a script included in the playback control information includes a region property which associates the region code with a property that is enabled in response to acquisition of the region code, and
the playback unit plays back information based on the region property.

9. The apparatus according to claim 6, wherein an XML included in the playback control information includes the region code and an element used to control playback in response to acquisition of the region code, and
the playback unit plays back information based on the element.

10. The apparatus according to claim 6, wherein an XML included in the playback control information includes the region code and an attribute used to control playback in response to acquisition of the region code, and
the playback unit plays back information based on the attribute.

11. An information playback method comprising:
reading data from an information storage medium comprising a first area which stores playback control information used to control playback of contents, and a second area which stores a region flag indicating whether to enable or disable playback control based on a region code; and
playing back information based on the region code stored in an information playback apparatus in response to reading of the region flag which enables the playback control based on the region code.

12. The method according to claim 11, wherein the information storage medium further comprises a third area which stores a region file that associates the region code with position information indicating a storage position of initial playback control information to be loaded first in response to acquisition of the region code, and
the information playback method plays back information based on the region file.

13. The method according to claim 11, in which a script included in the playback control information includes a region property which associates the region code with a property that is enabled in response to acquisition of the region code, and
which further comprises playing back information based on the region property.

14. The method according to claim 11, in which an XML included in the playback control information includes the region code and an element used to control playback in response to acquisition of the region code, and
which further comprises playing back information based on the element.

15. The method according to claim 11, in which an XML included in the playback control information includes the region code and an attribute used to control playback in response to acquisition of the region code, and
which further comprises playing back information based on the attribute.
